(19) United States
(12) Patent Application Publication
(10) Pub. No.: US 2026/0182541 A1
(43) Pub. Date: Jul. 2, 2026

(54) DEVICES, SYSTEMS, AND METHODS FOR SMART CAT SCRATCHER CONTROL AND ANALYTICS

(71) Applicant: Busy Kitty, LLC, Chicago, IL (US)

(72) Inventors: Andrea Wandrey, Chicago, IL (US); William G.M. Fischer, Berlin (DE); Michael Sprauve, San Jose, CA (US)

(73) Assignee: Busy Kitty, LLC, Chicago, IL (US)

(21) Appl. No.: 19/552,570

(22) Filed: Feb. 27, 2026

Related U.S. Application Data
(63) Continuation-in-part of application No. 18/807,182, filed on Aug. 16, 2024.

(51) Int. Cl. A01K 15/02

(52) U.S. Cl. CPC A01K 15/021; A01K 15/0201; A01K 15/024

(57) ABSTRACT

A smart cat scratcher system including advanced interaction detection, behavioral analysis, and adaptive reward control to provide an intelligent feline enrichment and training platform. The system includes a scratching surface, one or more sensors configured to detect an interaction by a cat and capture characteristics of the interaction, a reward dispenser, and a controller configured to determine whether the interaction meets a reward condition and to automatically dispense a reward in response. The one or more sensors may include accelerometers, capacitive sensors, load cells, vibration sensors, optical sensors, acoustic sensors, and cameras, enabling detection of parameters such as intensity, duration, frequency, direction, and spatial distribution. The controller may implement a multi-level automated reward protocol with configurable reinforcement modes, and the system may be modular, networked, and coupled to a companion application.

### CROSS-REFERENCE TO RELATED APPLICATIONS

The present application is a Continuation-in-Part of U.S. patent application Ser. No. 18/807,182, filed on Aug. 16, 2024, the entirety of which is herein incorporated by reference for all purposes.

### TECHNICAL FIELD

The present disclosure relates generally to pet training and enrichment devices, and more particularly to devices, systems, and methods for a controlling and managing a smart cat scratcher.

### BACKGROUND

Cats are among the most beloved companion animals worldwide, with millions of households welcoming them as members of the family. Their independent nature, playful personalities, and affectionate companionship make them ideal pets for many people. One of the most deeply ingrained natural behaviors of cats is scratching, which serves several important functions, including territorial marking, muscle stretching, stress relief, and maintenance of claw health.

However, when left untrained, cats will instinctively scratch any available surface, from furniture and carpets to curtains and doors. This behavior can lead to significant household damage, as their sharp claws easily tear through a wide range of materials. In frustration, some owners resort to shouting or even physical punishment, while others resort to declawing procedures, all of which can harm a cat's physical and emotional wellbeing. Sadly, the destructive potential of untrained scratching behavior is also one of the reasons cats are surrendered to shelters or not adopted in the first place.

Traditional scratching posts and surfaces have long been used to redirect this instinctual behavior to more appropriate objects. These products come in numerous shapes, sizes, and materials. While these devices offer an outlet for scratching behavior, they do not, on their own, teach a cat where it should scratch. As a result, their success depends heavily on the owner's ability to consistently guide the cat's behavior through training.

The most effective and humane approach to training cats is positive reinforcement, in which desired behavior, such as scratching the correct object, is immediately rewarded. While this approach is well supported by animal behavior research and widely endorsed by animal welfare organizations, consistent training is often difficult to achieve in practice. Owners may lack the time, knowledge, or patience required to deliver rewards reliably and promptly. Timing is especially critical because if a reward is not delivered within a few seconds of the scratching event, the cat may fail to associate the treat with the correct behavior.

In many cases, training fails simply because the owner is not present when the scratching occurs or cannot respond quickly enough to provide the treat. Even when owners do participate consistently, cats may learn to associate rewards with the owner's presence, reducing the effectiveness of the training when the owner is absent. Over time, the effort required to observe, respond, and dispense treats manually can become burdensome, leading to inconsistent training and continued destructive scratching behavior.

### BRIEF SUMMARY

The present disclosure achieves technical advantages as systems, devices, and methods for configuring, managing, operating, controlling, and/or using a smart cat scratcher.

In particular embodiments, a smart cat scratcher may be configured with functionality for detecting an interaction between a cat and the smart cat scratcher, determining characteristics of the interaction, and determining whether to dispense a treat in response to the interaction. In embodiments, the functionality for detecting an interaction by a cat with the smart cat scratcher may include one or more sensor modalities configured to capture data associated with the physical, mechanical, electrical, or acoustic effects of a scratching event. In embodiments, the sensor modalities may include, without limitation, one or more accelerometers configured to detect oscillatory motion or displacement of a scratching surface; one or more capacitive touch sensors configured to detect changes in capacitance caused by the approach or contact of a paw; one or more load cells configured to measure force vectors applied to the scratching surface; one or more vibration sensors configured to detect vibrational energy produced by scratching activity; one or more optical sensors configured to detect interruption of light beams or fields by a cat's paw; one or more acoustic sensors configured to capture characteristic sound signatures associated with scratching behavior; and one or more cameras configured to capture image or video data for subsequent interaction analysis. In embodiments, the smart cat scratcher may employ a single sensing technique or a combination of two or more techniques in a multimodal sensing configuration.

In embodiments, functionality for determining one or more characteristics of the detected interaction may include analyzing sensor data to quantify and interpret aspects of the scratching behavior. In embodiments, the one or more characteristics may include, without limitation, an intensity or magnitude of the interaction (e.g., peak force or acceleration), a duration of the interaction (e.g., total contact time), a velocity or acceleration profile (e.g., rate of paw movement or scratching speed), a frequency or pattern of interaction (e.g., rhythmic or repetitive motion), a spatial distribution of force (e.g., location or area of contact on the scratching surface), a directional vector of the interaction (e.g., upward, downward, lateral, or rotational motion), an environmental characteristics of the interaction (e.g., sound of the interaction), and/or cat-related characteristics of the interaction (e.g., body posture of cat during the interaction, the mood of the cat, etc.). In some embodiments, advanced data-processing techniques, including artificial intelligence or machine-learning inference models, may be employed by the system controller to classify detected interactions, differentiate scratching behavior from non-scratching events, recognize behavioral trends over time, etc.

In embodiments, functionality for determining whether to dispense a reward in response to a detected interaction may include evaluating the one or more determined characteristics of the interaction against one or more dispensing conditions defined by user configuration settings and/or an automated reward protocol. In some embodiments, all detected interactions may result in a reward, while in other embodiments, only interactions classified as rewardable interactions (e.g., a scratching motion meeting a defined force or duration threshold and occurring on the scratching surface) may trigger reward dispensing. In embodiments, rewardable interactions may be rewarded on a continuous basis (e.g., every qualifying interaction) or intermittently in a fixed ratio (e.g., predictably every third qualifying interaction) or intermittently in a variable ratio (e.g., unpredictably every third qualifying interaction on average), and/or according to a structured multi-level automated reward protocol. In embodiments, the automated reward protocol may include a plurality of configuration levels, such as a first level configured to reward every interaction (i.e. continuous reinforcement), a second level configured to reward interactions intermittently according to a fixed or variable ratio or a fixed or variable time interval, and a third level configured to reward only those interactions that exceed one or more rewardable thresholds. Additional levels may be implemented in which the reward behavior may be dynamically adjusted based on parameters (e.g., behavioral parameter, non-behavioral parameters, engagement frequency, or training progress) and the controller may transition between configuration levels automatically based on changes in the cat's detected interaction patterns over time. In embodiments, reward dispensing may further be limited by parameters such as a maximum number of treats per day or per session.

In some embodiments, the smart cat scratcher system may be implemented as a modular or distributed system comprising multiple interconnected units configured to share interaction data and coordinate reinforcement strategies. In embodiments, the system may communicate with a companion application configured to present behavioral analytics, manage training parameters, set reward conditions, and provide notifications to a user. Through the combination of advanced sensing modalities, robust interaction characterization, flexible reward-dispensing logic, and adaptive training protocols, the disclosed smart cat scratcher system provides a technically improved platform for automated feline enrichment, behavioral reinforcement, and long-term engagement management.

Embodiments of the present disclosure provide numerous technical advantages over conventional feline enrichment devices and scratching posts, which are typically limited to passive structures or simple mechanical reward mechanisms incapable of adaptive or context-aware operation. For example, embodiments disclosed herein leverage multi-modal sensor architectures, including accelerometers, capacitive sensors, load cells, vibration sensors, optical emitters and receivers, acoustic transducers, and imaging systems, to capture high-resolution data characterizing scratching interactions with far greater precision than previously possible. The ability to quantify parameters such as intensity, duration, spatial distribution, directional vectors, velocity, and rhythmic patterns enables the system to distinguish between incidental contact and behaviorally meaningful scratching, improving detection accuracy and reducing false positives. Further, by integrating artificial intelligence and machine learning inference capabilities into the interaction analysis pipeline, the system of embodiments can adaptively classify behaviors and adjust reward conditions dynamically over time, resulting in a more effective and responsive behavioral training process.

In addition, embodiments of the automated reward protocol described herein enable a level of behavioral conditioning granularity that conventional systems cannot achieve. By providing multiple configuration levels (e.g., including continuous and intermittent schedules, fixed or randomized variable, and threshold-based reinforcement), and by enabling dynamic transitions between these levels based on observed behavioral changes, the disclosed system supports progressive training strategies tailored to an individual cat's learning curve. These capabilities improve the efficiency of positive-reinforcement training and reduce treat dependency over time, representing a technical advancement over fixed-schedule or purely manual reward systems.

The disclosed modular system architecture and networked deployment options of embodiments further provide significant functional and practical improvements. Modular scratching units can share behavioral data and coordinate reinforcement schedules, enabling multi-zone installations and adaptive training across an entire environment rather than at a single point of interaction. Additionally, the integration of user-facing software applications and companion interfaces allows for real-time analytics, remote configuration, behavioral tracking, and personalized training protocols, extending the functionality of the smart cat scratcher beyond the physical device itself. Collectively, these technical innovations provide a more intelligent, adaptive, and effective solution for feline behavioral training and environmental enrichment than conventional scratching posts or automated feeders, improving engagement outcomes for cats and convenience and control for their owners.

Indeed, the smart cat scratcher of embodiments represents a novel and practical solution to the problem of inappropriate cat scratching behavior. By integrating sensor technology, reward dispensing mechanisms, and adaptive and automated reward protocols, the smart cat scratcher provides an effective and user-friendly tool for training cats and promoting healthier scratching habits.

In various embodiments, the smart cat scratcher of embodiments may comprise one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine learning (ML) models, artificial intelligence (AI) models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a smart cat scratcher system. It is a further object of the disclosure to provide a method of automated positive reinforcement of a cat.

In one particular embodiment, a smart cat scratcher system is provided. The smart cat scratcher system includes a scratching surface, one or more sensors configured to detect an interaction by a cat with the scratching surface and to generate data indicative of one or more characteristics of the interaction, a reward dispenser configured to dispense one or more rewards, and a controller communicatively coupled to the one or more sensors and the reward dispenser. In embodiments, the controller is configured to determine, based on the one or more characteristics of the interaction, whether the interaction meets a reward condition, and to automatically transmit, in response to determining that the interaction meets the reward condition, a control signal to the reward dispenser to cause dispensing of the one or more rewards.

In another embodiment, a method of automated positive reinforcement of a cat, is provided. The method includes detecting, via one or more sensors of a smart cat scratcher, a scratching interaction by the cat, determining one or more characteristics of the scratching interaction, classifying the scratching interaction as rewardable or non-rewardable based on the one or more characteristics, determining a current configuration level of an automated reward protocol, and dispensing, via a reward dispenser, a reward in response to the scratching interaction when the scratching interaction satisfies a reward condition defined by the current configuration level of the automated reward protocol.

In another embodiment, a system for automated positive reinforcement of a cat is provided. The system includes at least one processor and a memory operably coupled to the at least one processor and storing processor-readable code that, when executed by the at least one processor, is configured to perform operations. The operations include detecting, via one or more sensors of a smart cat scratcher, a scratching interaction by the cat, determining one or more characteristics of the scratching interaction, classifying the scratching interaction as rewardable or non-rewardable based on the one or more characteristics, determining a current configuration level of an automated reward protocol, and dispensing, via a reward dispenser, a reward in response to the scratching interaction when the scratching interaction satisfies a reward condition defined by the current configuration level of the automated reward protocol.

In still another embodiment, a computer-based tool for automated positive reinforcement of a cat is provided. The computer-based tool includes non-transitory computer readable media having stored thereon computer code which, when executed by a processor, causes a computing device to perform operations. The operations include detecting, via one or more sensors of a smart cat scratcher, a scratching interaction by the cat, determining one or more characteristics of the scratching interaction, classifying the scratching interaction as rewardable or non-rewardable based on the one or more characteristics, determining a current configuration level of an automated reward protocol, and dispensing, via a reward dispenser, a reward in response to the scratching interaction when the scratching interaction satisfies a reward condition defined by the current configuration level of the automated reward protocol

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an exemplary smart cat scratcher configured with capabilities and functionality for automatically dispensing rewards in response to an interaction by a cat in accordance with embodiments of the present disclosure.

FIG. 2 is a block diagram illustrating a functional example of a scratcher controller configured with capabilities and functionality for managing the functionality of the smart cat scratcher for automatically dispensing rewards in response to an interaction by a cat in accordance with embodiments of the present disclosure.

FIGS. 3A and 3B illustrate one exemplary embodiment of a smart cat scratcher implemented in accordance with the present disclosure.

FIGS. 4A and 4B illustrate one exemplary embodiment of a smart cat scratcher configured with a load-cell-based interaction detection system in accordance with embodiments of the present disclosure.

FIG. 5 illustrates an exemplary embodiment of a smart cat scratcher configured with an accelerometer-based interaction detection system in accordance with embodiments of the present disclosure.

FIG. 6 illustrates an exemplary embodiment of a smart cat scratcher configured with a capacitive-touch-based interaction detection system in accordance with embodiments of the present disclosure.

FIG. 7 illustrates an exemplary embodiment of a smart cat scratcher configured with an emitter/receiver-based interaction detection system in accordance with embodiments of the present disclosure.

FIG. 8 illustrates an exemplary embodiment of a smart cat scratcher configured with a light-array-based interaction detection system in accordance with embodiments of the present disclosure.

FIG. 9 illustrates an exemplary embodiment of a smart cat scratcher configured with an AI/ML-based interaction detection system in accordance with embodiments of the present disclosure.

FIG. 10 illustrates an exemplary embodiment of a smart cat scratcher configured with a sound-based interaction detection system in accordance with embodiments of the present disclosure.

FIG. 11 illustrates an exemplary embodiment of a smart cat scratcher configured with a vibration-based interaction detection system in accordance with embodiments of the present disclosure.

FIGS. 12A-12C illustrate various exemplary embodiments of a modular smart cat scratcher system in accordance with embodiments of the present disclosure.

FIG. 13 illustrates another exemplary embodiment of a smart cat scratcher in accordance with embodiments of the present disclosure.

FIGS. 14A-14D show various views of exemplary interface windows of a connected app illustrating the functionalities and settings available to the user for managing and accessing the functionality of the smart cat scratcher in accordance with embodiments of the present disclosure.

FIG. 14E shows an exemplary interface of the connected application configured to enable a user to configure advanced interaction detection parameters and reward-related sensitivity settings for a selected cat profile in accordance with embodiments of the present disclosure.

FIG. 15 illustrates a specific example of a reward protocol implemented by the scratcher controller in accordance with embodiments of the present disclosure.

FIG. 16A illustrates an exemplary process for implementing a reward criteria determination step of a reward protocol implemented by the scratcher controller in accordance with embodiments of the present disclosure.

FIG. 16B illustrates an exemplary process for implementing a reward schedule determination step of a reward protocol implemented by the scratcher controller in accordance with embodiments of the present disclosure.

FIG. 16C illustrates an exemplary process for implementing steps for determining a type of reward and an intensity of a reward to be dispensed of a reward protocol implemented by the scratcher controller in accordance with embodiments of the present disclosure.

FIG. 16D illustrates examples of non-behavior related characteristics to be used in a reward protocol implemented by the scratcher controller in accordance with embodiments of the present disclosure.

FIG. 17 illustrates a specific example implementation of a reward protocol implemented by the scratcher controller in accordance with embodiments of the present disclosure.

FIG. 18 shows an example of a graph illustrating the implementation of a reward protocol implemented by the scratcher controller in accordance with embodiments of the present disclosure.

FIG. 19 illustrates a specific example of an automated reward protocol implemented by the scratcher controller in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to a smart cat scratcher device and system, and/or methods of configuring, managing, operating, controlling, and/or using a smart cat scratcher that includes functionality for detecting an interaction between a cat and the smart cat scratcher, determining characteristics of the interaction, and determining whether to dispense a treat in response to the interaction. In embodiments, the functionality for detecting an interaction by a cat with the smart cat scratcher may include one or more sensor modalities configured to capture data associated with the physical, mechanical, electrical, or acoustic effects of a scratching event. In embodiments, the sensor modalities may include, without limitation, one or more accelerometers configured to detect oscillatory motion or displacement of a scratching surface; one or more capacitive touch sensors configured to detect changes in capacitance caused by the approach or contact of a paw; one or more load cells configured to measure force vectors applied to the scratching surface; one or more vibration sensors configured to detect vibrational energy produced by scratching activity; one or more optical sensors configured to detect interruption of light beams or fields by a cat's paw; one or more acoustic sensors configured to capture characteristic sound signatures associated with scratching behavior; and one or more cameras configured to capture image or video data for subsequent interaction analysis. In embodiments, the smart cat scratcher may employ a single sensing technique or a combination of two or more techniques in a multimodal sensing configuration.

In embodiments, functionality for determining one or more characteristics of the detected interaction may include analyzing sensor data to quantify and interpret aspects of the scratching behavior. In embodiments, the one or more characteristics may include, without limitation, an intensity or magnitude of the interaction (e.g., peak force or acceleration), a duration of the interaction (e.g., total contact time), a velocity or acceleration profile (e.g., rate of paw movement or scratching speed), a frequency or pattern of interaction (e.g., rhythmic or repetitive motion), a spatial distribution of force (e.g., location or area of contact on the scratching surface), and/or a directional vector of the interaction (e.g., upward, downward, lateral, or rotational motion). In some embodiments, advanced data-processing techniques, including artificial intelligence or machine-learning inference models, may be employed by the system controller to classify detected interactions, differentiate scratching behavior from non-scratching events, recognize behavioral trends over time, etc.

In embodiments, functionality for determining whether to dispense a reward in response to a detected interaction may include evaluating the one or more determined characteristics of the interaction against one or more dispensing conditions defined by user configuration settings and/or an automated reward protocol. In some embodiments, all detected interactions by a cat may result in a reward, while in other embodiments, only interactions classified as rewardable interactions (e.g., a scratching motion meeting a defined force, pattern, or duration threshold and occurring on the scratching surface) may trigger reward dispensing. In embodiments, rewardable interactions may be rewarded on a continuous basis (e.g., every qualifying interaction), intermittently in a fixed ratio (e.g., predictably every third qualifying interaction) or intermittently in a variable ratio (e.g., unpredictably every third qualifying interaction on average), and/or according to a structured multi-level automated reward protocol. In embodiments, the automated reward protocol may include a plurality of configuration levels, such as a first level configured to reward every interaction, a second level configured to reward interactions intermittently according to a defined or randomized ratio and/or interval, and a third level configured to reward only those interactions that exceed one or more rewardable thresholds. Additional levels may be implemented in which the reward behavior may be dynamically adjusted based on parameters (e.g., behavioral parameter, non-behavioral parameters, engagement frequency, or training progress) and the controller may transition between configuration levels automatically based on changes in the cat's detected interaction patterns over time. In embodiments, reward dispensing may further be limited by parameters such as a maximum number of treats per day or per session.

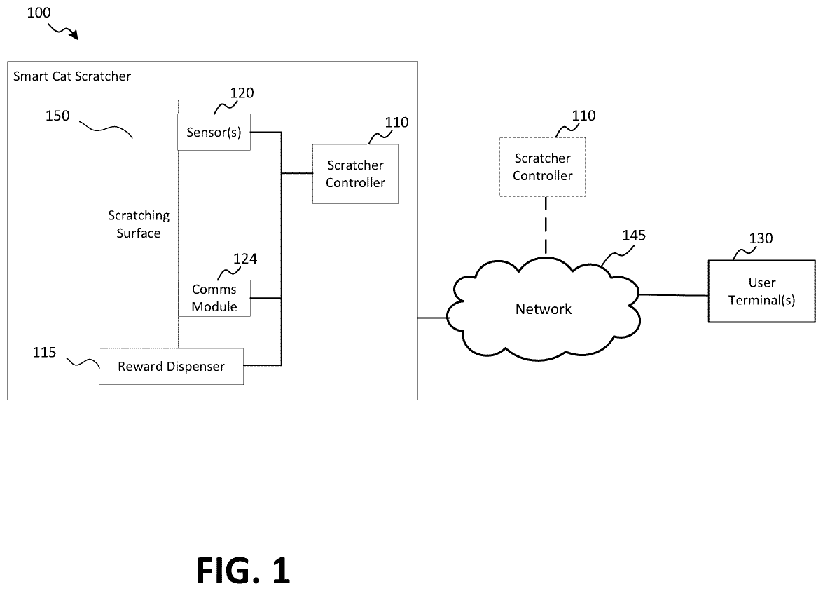

FIG. 1 shows an exemplary smart cat scratcher 100 configured with capabilities and functionality for automatically dispensing rewards in response to an interaction by a cat in accordance with embodiments of the present disclosure. As shown in the particular embodiment illustrated in FIG. 1, smart cat scratcher 100 may include scratching surface 150, reward dispenser 115, one or more sensors 120, communications module 124, and scratcher controller 110. In embodiments, these components of smart cat scratcher 100, and their individual components, may cooperatively operate to provide functionality for controlled dispensing of rewards in response to scratching activity as described in various embodiments of the present disclosure.

It is noted that in some embodiments, the smart cat scratcher 100 may be provided as a system including network 145, and user terminal 130. In these cases, the smart cat scratcher 100 may additionally include network 145 and user terminal 130. In some embodiments, the scratcher controller 110 may be part of the smart cat scratcher 100, such as may be an on-board component of the smart cat scratcher 100. In additional or alternative embodiments, the scratcher controller 110 may be provided as a separate component to the smart cat scratcher 100. In these cases, for example, the scratcher controller 110 may be provided as a server that is separate to the smart cat scratcher 100 and provides the functionality of the scratcher controller 110 as described herein.

It is also noted that various components of smart cat scratcher 100 are illustrated as single and separate components. However, it will be appreciated that each of the various illustrated components may be implemented as a single component, may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of smart cat scratcher 100 described herein is provided for purposes of illustration, rather than by way of limitation and that functionalities described as being provided by different functional blocks may be combined into a single component or may be provided via computing resources disposed in a cloud-based environment accessible over a network, such as network 145.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate a user interacting with the smart cat scratcher 100, e.g., via network 145, to execute and leverage the features provided by the cooperative operations of smart cat scratcher 100. In embodiments, the GUI may be provided as part of an application that may enable the user to configure and/or control various parameters of the smart cat scratcher 100. Through the GUI of the application, the user may personalize settings related to the operation of the smart cat scratcher, create and manage profiles for different cats, set preferences that align with their training goals and household routines, control application and/or configuration of a reward protocol, etc. The application may also facilitate the configuration of training programs, allowing for the adjustment of reward schedules, reward types, dispensing frequencies, etc. In embodiments, the user may receive reports, notifications, alerts, etc. via the GUI of the application in accordance with embodiments of the present disclosure. In embodiments, the user terminal 130 may be configured to communicate with other components of smart cat scratcher 100.

In embodiments, network 145 may facilitate communications between the various components of the system including the smart cat scratcher 100. Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

In embodiments, the scratching surface 150 may be configured to engage cats in their natural scratching behavior. In some embodiments, the scratching surface 150 is configured to withstand the scratching of cat claws and may provide a durable and satisfying experience for the cat as they engage with the scratching surface 150. The scratching surface 150 may be configured to be scratched by cats, while offering resistance that mimics natural materials cats might encounter in the wild, such as tree bark or rough terrain.

In embodiments, the scratching surface 150 may be configured to be removable from the smart cat scratcher 100 and/or interchangeable, and/or flexibly attachable to walls or furniture. This functionality may enable users to easily remove and replace the scratching surface 150 as it wears down or as preferences change, and to flexibly place the surface around the home in areas where reinforcement of appropriate scratching is required the most. This functionality may not only enhance the longevity of the smart cat scratcher but may also provide flexibility for the user and variety to the cat. In some embodiments, replacing the scratching surface 150 may include sliding the scratching surface to be replaced out of the scratching surface holder and sliding in a new scratching surface. In some embodiments, a replaceable scratching surface 150 may facilitate a subscription-based model for vendors, offering users the convenience of receiving periodic replacements. This “subscribe and save” option ensures that cats consistently have a fresh and effective surface for scratching, while providing a recurring revenue stream and enhanced customer engagement for vendors.

In some embodiments, the scratching surface 150 may be composed of multiple sections, which may be individually replaced or rearranged. This modular configuration may allow for a customizable scratching experience and can cater to the varied scratching preferences of different cats. For instance, some cats may prefer a larger, uninterrupted surface to stretch and scratch, while others may enjoy a segmented arrangement that offers different textures or angles. The modular configuration's compact size may also offer advantages in shipping and storing.

In embodiments, the material used to make the scratching surface 150 may vary to suit the preferences of both cats and their owners. Common materials that may be used for the scratching surface 150 may include sisal rope, known for its durability and texture that cats find appealing; corrugated cardboard, which provides a softer scratching experience and is often preferred by indoor cats; carpet, which can offer a familiar texture found in many homes, etc. For example, other materials that may be used for the scratching surface 150 may include wood, fabric, felt, leather, hemp rope, bamboo, wicker, natural bark or tree branches, any combination thereof, and/or other materials. Different materials may provide distinct scratching experiences and may be selected based on the cat's individual behavior and the owner's aesthetic preferences.

In embodiments, reward dispenser 115 may be configured to dispense one or more rewards. In some embodiments, the rewards dispensed by the reward dispenser 115 may include food-based rewards, interactive rewards, a communications session, etc. For example, food-based rewards may include, but are not limited to, traditional treats, regular cat food (e.g., kibble), catnip, silver vine, other food-based treats, and/or any combination thereof. In embodiments, interactive rewards may include interactive play, grooming, petting, etc., and the communication session may include communication between the smart cat scratcher 100 and a user to allow the cat to “talk” to the user. In any case, the rewards dispensed by the smart cat scratcher 100 via the reward dispenser 115 may be in response to an interaction between the cat and the smart cat scratcher 100 in accordance with embodiments described herein.

The communications module 124 may be configured to facilitate data exchange between the cat scratcher device 100 and one or more user terminal(s) 130, such as a smartphone, tablet, or computer, via a network 145. The communications module 124 may include various components or features for transmitting and receiving data, such as a wireless transceiver, a wired connection interface, or other suitable communication components. The communications module 124 may enable remote monitoring and control of the cat scratcher device 100, allowing a user to adjust settings, view data, or receive notifications related to the cat's interaction with the cat scratcher device 100.

In embodiments, the communications module 124 may facilitate two-way communication between the user and the smart cat scratcher device 100. This feature allows the user to interact with their cat in real-time, providing a sense of presence and engagement even when they are not physically together. Through the user terminal 130, an owner may initiate a call to the smart cat scratcher 100, activating the microphone and speaker system to communicate directly with their cat. This may be particularly comforting for the cat when the owner is away from home, as it can hear the owner's voice and receive reassurance. Conversely, the owner may listen in to the sounds around the smart cat scratcher, including the cat's vocalizations, which may be a valuable tool for monitoring the cat's well-being and environment.

In embodiments, the communications module 124 may be configured to enable communications via network 145, such as with other components of a system including the smart cat scratcher device 100, as well as external components. In a particular embodiment, the communications module 124 may be configured to enable communications protocol such as Bluetooth, WIFI, and other communications protocols that enable the smart cat scratcher device 100 to communicate.

The one or more sensors 120 may be configured to detect an interaction by a cat with the smart cat scratcher 100 and/or to collect, capture, and/or measure data associated with one or more characteristics related to the interaction by the cat with the smart cat scratcher 100. For example, in embodiments, the detecting of an interaction between a cat and the smart cat scratcher 100 may include detecting the presence, proximity, approach, and/or activity of a cat as the cat engages with the smart cat scratcher 100. In embodiments, the interaction detected by the one or more sensors 120 may include, without limitation, the cat approaching the smart cat scratcher 100, the cat coming into contact with or otherwise interacting with any portion or component of the smart cat scratcher 100 (e.g., in any manner, degree, and/or duration), and/or the cat directly contacting, manipulating, scratching, and/or otherwise engaging with the scratching surface 150 itself. In embodiments, the detection of the interaction may occur regardless of whether the interaction is incidental, exploratory, playful, investigative, and/or intentional, and/or regardless of whether the interaction is a full scratching event or a partial engagement with the smart cat scratcher 100.

In embodiments, detecting the one or more characteristics associated with an interaction between a cat and the smart cat scratcher 100 may include detecting one or more characteristics related to the nature and/or quality of the interaction. In embodiments, the one or more sensors 120 may be configured to detect, capture, and/or measure a range of characteristics associated with such interaction, whether the interaction comprises a full scratching event, a partial scratching activity, a paw touch, a proximity-based engagement, an incidental contact, and/or another form of physical or non-physical interaction with the smart cat scratcher 100. In embodiments, characteristics related to the quality of the interaction may include, without limitation, the intensity of the contact or scratching activity (e.g., ranging from light touches, brushes, and/or exploratory taps to more vigorous, high-force scratching events), the pressure applied by the cat's paw(s) or claws upon the scratching surface 150 (based on which the smart cat scratcher 100 may determine insights into the cat's behavioral tendencies, preferences, welfare, and/or physical condition), and/or the length and/or duration of the interaction (based on which the smart cat scratcher 100 may determine information indicative of the cat's engagement level, interest, and/or satisfaction with the smart cat scratcher 100). In embodiments, characteristics related to the quality of the interaction may also include the depth, sharpness, and/or penetration characteristics of the contact or scratch, based on which the smart cat scratcher 100 may determine information about claw condition, scratching intent (e.g., marking territory versus stretching), and/or behavioral state.

In embodiments, the one or more sensors 120 may be configured to detect, capture, and/or infer the rhythm, cadence, frequency, pattern of the interaction, and/or the cats mood, which may vary widely from cat to cat and may evolve over time as the cat's comfort level, training progress, and/or learned behavior changes. In embodiments, the cat's body posture, gait, or stance during interaction may be detected or inferred using the one or more sensors 120 and may be used by the smart cat scratcher 100 as a characteristic of the interaction. For example, whether the cat is confident or hesitant in interacting with the scratcher, reaching upward and extending its spine to scratch, crouching low to paw at the base, or engaging in a quick exploratory tap may be used by the smart cat scratcher 100 to determine behavioral context relevant to the determination of how the smart cat scratcher 100 is to respond (e.g., whether to dispense a reward or not, or how to adjust the reward protocol to maximize engagement).

In embodiments, the speed, acceleration, and/or velocity profile at which the cat approaches the smart cat scratcher 100 (e.g., walking slowly, running, leaping toward the device, etc.) may be captured by the one or more sensors 120 and may be analyzed as a characteristic of the interaction. In embodiments, the detected one or more characteristics associated with the interaction may be used individually or in combination to inform downstream decisions, such as whether the interaction qualifies as a “rewardable” event under the smart cat scratcher 100 configuration and/or a particular automated reward protocol level, and/or whether the interaction is sufficient to trigger the next stage of a training program.

In embodiments, the one or more characteristics associated with the interaction may include visual characteristics such as the confirmation that it's a cat interacting with the device and not for example a dog, and visual characteristics of the interaction, spatial and directional characteristics, such as the vector, orientation, and/or angle of the interaction (e.g., vertical, horizontal, diagonal, rotational, or multi-directional), the distribution of force across the scratching surface 150, and/or the size, shape, and/or location of the region of contact. In embodiments, this spatial data may enable the smart cat scratcher 100 to distinguish between different forms of engagement (e.g., differentiating between a casual brush-by, a brief exploratory paw tap, and an intentional scratching session). In embodiments, data related to the spatial footprint and directional vector of the interaction may be captured using one or more specific sensing modalities, as discussed in more detail herein, including but not limited to load-cell-based detection, accelerometer-based detection, capacitive touch sensing, optical emitter-receiver arrays, vibration sensors, acoustic sensors, AI/ML-based vision analysis, etc. In embodiments, the collected data from the one or more sensors 120 may be processed by the scratcher controller 110, optionally in combination with configuration data from the user application, to determine whether the interaction meets one or more thresholds or criteria associated with a reward event under a given reward protocol configuration. For example, the scratcher controller 110 may be configured to interpret the detected characteristics to decide whether the interaction qualifies as a rewardable event under a continuous reinforcement scheme (e.g., every interaction), an intermittent reinforcement scheme (e.g., every second or third qualifying interaction), and/or a threshold-based reinforcement scheme (e.g., interactions above a certain intensity or duration). In embodiments, the multi-parameter data set generated from the detected one or more characteristics may enable the smart cat scratcher 100 to provide adaptive and context-aware responses, which may operate to ensure that the cat's behavior is reinforced appropriately while supporting advanced training objectives, gamified reward strategies, long-term behavioral conditioning, and/or the well-being of the cat.

In embodiments, the scratcher controller 110 may be configured to manage and control the functionality and operation of the smart cat scratcher 100, including the detection, classification, and analysis of interactions between a cat and the smart cat scratcher 100, as well as the controlled dispensing of rewards and initiation of other interactive events in response to such interactions. In embodiments, the scratcher controller 110 may operate as the central decision-making component of the smart cat scratcher 100, and may be configured to receive and process data from the one or more sensors 120. In embodiments, the scratcher controller 110 may be configured to analyze the sensor data to determine one or more characteristics of the interaction, such as presence, intensity, duration, location, proximity, vector, velocity, directionality, approach behavior, pattern, sound, and/or engagement type of the interaction. In embodiments, the scratcher controller 110 may be configured to determine, based on the detected one or more characteristics, a response, including whether to dispense a reward from the reward dispenser 115, such as dispensing a food-based reward, activating an interactive engagement feature or game, and/or initiating a communication or triggering remote commands via the communications module 124.

In embodiments, the scratcher controller 110 may be configured to operate in multiple operational modes or states, which may be selected based on the current training level and/or system configuration, and/or dynamically based on observed cat behavior. In embodiments, the various operational modes may include, without limitation, a no-protocol mode, an automated reward protocol mode, a training mode, and a maintenance mode, though additional modes and sub-modes, hybrid modes, and/or user-defined custom modes may also be supported.

In a maintenance mode, the scratcher controller 110 may be configured to preserve, sustain, maintain, and/or reinforce established interaction behaviors in a cat that has already been conditioned to use the smart cat scratcher 100. In this mode, the scratcher controller 110 may implement a less frequent reward schedule, which may include an intermittent or partial reinforcement strategy designed to ensure continued engagement with the smart cat scratcher 100 while avoiding over-reliance on constant rewards. For example, in embodiments, the scratcher controller 110 may adjust the frequency, type, criteria, intensity, and/or quantity of rewards based on real-time data related to the cat's recent interaction history, engagement frequency, and/or behavioral trends. In a training mode, the scratcher controller 110 may be configured to facilitate and guide a cat's behavioral progression from low-engagement, incidental, or undesirable interaction patterns (e.g., scratching furniture or ignoring the scratcher) to consistent and intentional engagement with the smart cat scratcher 100. In embodiments, to accommodate different stages of learning, the scratcher controller 110 may implement a multi-level automated reward protocol comprising a plurality of discrete levels, such as a beginner level, an intermediate or advanced level, and an expert or maintenance level, each defined by distinct reward criteria, reward schedules, reward intensities, and/or reward types. In embodiments, as the cat progresses, the reward criteria may become more selective, requiring interactions to meet defined thresholds (e.g., intensity, duration, directionality, or interaction type) to qualify as rewardable, and/or the reward frequency may be gradually reduced. In embodiments, the progression of the cat through the training levels may also involve adjustments to the type, size, intensity, and/or modality of rewards (e.g., transitioning from frequent, high-value food rewards to more intermittent interactive rewards).

In embodiments, the scratcher controller 110 may operate in a no-protocol mode. In a no-protocol mode, the determination of whether to reward an interaction between the cat and the smart cat scratcher 100 may be based on the configuration of the smart cat scratcher 100, which may be specified by the user through the application or user interface, or may not require any choice by the user at all in order to operate. In embodiments, the configuration may define the criteria or conditions under which a reward is dispensed. For example, the configuration may specify that every scratching interaction with the scratching surface 150 by a cat is rewarded, that every second or third scratching interaction is rewarded, and/or that rewards are dispensed only when certain thresholds are met, such as a minimum interaction duration, a particular interaction intensity, or a specified number of interactions within a defined time period. In some embodiments, the configuration may specify reward limits, such as no more than 10 treats per day, etc. In some embodiments, presets may include a preset of “reward every cat scratching interaction continuously,” entirely relieving the user from any type of choice to be made.

In embodiments, the scratcher controller 110 may be configured to operate according to an automated reward protocol. In embodiments, the automated reward protocol may be configured to manage reward dispensing through a multi-level configuration. For example, in embodiments, a first configuration level of the automated reward protocol may include rewarding every rewardable interaction detected by the one or more sensors 120. In embodiments, a rewardable interaction may include, without limitation, any interaction that meets a rewardable threshold. In embodiments, the rewardable threshold may include a range of interaction levels, from the most basic forms of engagement to more complex, intentional behaviors. At its broadest level, the rewardable threshold may include any detection of presence or proximity by the cat, including instances where the cat merely approaches the smart cat scratcher 100, walks near it, or pauses within a defined proximity zone, even if no physical contact between the cat and the smart cat scratcher 100 occurs. It is noted that such a broad threshold may be useful in early training stages or for cats that are completely unfamiliar with the smart cat scratcher 100, as it reinforces initial curiosity and reduces barriers to engagement.

In embodiments, the rewardable threshold may also include exploratory behaviors that indicate awareness or interest in the smart cat scratcher 100, such as sniffing, nudging, observing, circling, and/or gently touching any portion of the smart cat scratcher 100, even without applying significant force, and even if the interaction is not with the scratching surface 150. In embodiments, the rewardable threshold may include interactions in which the cat makes physical contact with the scratching surface 150 in any manner, regardless of whether the contact constitutes a deliberate scratching motion. These interactions may include paw placement, rubbing, tapping, and/or other incidental or exploratory touches that may not rise to the level of sustained scratching but still indicate a progression in engagement behavior.

In embodiments, the rewardable threshold may include more targeted and deliberate interactions, such as active manipulation of the scratching surface 150 or intentional scratching behaviors. These interactions may include, without limitation, dragging or raking the claws across the scratching surface 150, applying downward pressure consistent with scratching, repeating scratching motions over a defined time interval, and/or exhibiting recognizable scratching patterns as detected by the one or more sensors 120.

In some embodiments, the rewardable threshold may be configured to require that one or more measurable characteristics of the interaction meet or exceed defined criteria, such as a minimum intensity level, a minimum contact duration, a minimum frequency of motion, or a specific contact location on the scratching surface 150. In this way, the determination of whether an interaction is rewardable may be finely tuned to align with specific training goals. For example, in a basic configuration, any form of approach or contact may be sufficient to constitute a rewardable interaction, whereas in a more advanced configuration, only interactions involving sustained scratching at a defined force or duration may qualify as rewardable interactions.

In embodiments, a second configuration level of the automated reward protocol may include intermittently rewarding every rewardable interaction. In these embodiments, even if an interaction qualifies as rewardable, the scratcher controller 110 may be configured to dispense rewards intermittently, for example at a fixed ratio of every two, three, four, or other specified number of interactions. In some embodiments, the intermittent reward schedule may be implemented in a variable ratio, such as a random amount of interactions within a range of two to five interactions, and/or solving for an average amount of interactions such as five interactions, where the reward may be given after two interactions, five interactions, etc. in delivering against a defined average number. In some embodiments, the intermittent reward schedule may be specified via configuration, such as by the user or automatically (e.g., using an AI or ML model). The use of intermittent reinforcement in a variable ratio may provide a gamified experience similar to that of a slot machine, which may encourage continued engagement and sustained behavioral interest from the cat.

In embodiments, a third configuration level of the automated reward protocol may include intermittently rewarding rewardable interactions based on one or more configuration parameters. For example, the intermittent reward schedule may be dynamically adjusted based on a daily treat limit set by the user, the cat's individual personality or preferences, the cat's level of training or experience with the smart cat scratcher 100, and/or other behavioral or environmental factors. In some embodiments, the scratcher controller 110 may use configuration data, such as the maximum number of treats allowed within a defined time period, the cat's age, weight, dietary considerations, or owner-defined behavioral objectives, to determine how and when rewards are dispensed. For example, in some embodiments, even if an interaction is determined to be rewardable and within the intermittent reward ratio and/or interval, the reward may not be dispensed if the configuration does not allow dispensing (e.g., maximum limit of treats already reached). On the other hand, if an interaction is determined to be rewardable and within the intermittent reward ratio and/or interval, the reward may be dispensed if the configuration allows dispensing (e.g., maximum limit of treats not yet reached).

It is noted that the automated reward protocol described herein comprising three levels is provided merely as an example of one possible implementation and is not intended to be limiting in any way. In embodiments, the automated reward protocol may include fewer than three levels, more than three levels, or may include levels that are combined, subdivided, and/or restructured in various ways, or may include no levels at all. For example, in some embodiments, two or more levels may be merged into a single composite level, additional intermediate levels may be introduced to provide finer control over reward conditions, or certain levels may be omitted entirely based on the desired training objectives, behavioral conditioning strategy, system configuration, etc. In embodiments, the specific number, order, and nature of the levels may be defined by the user, preconfigured by the manufacturer, dynamically adapted by the scratcher controller 110, and/or determined based on AI/ML analysis of the cat's behavioral patterns.

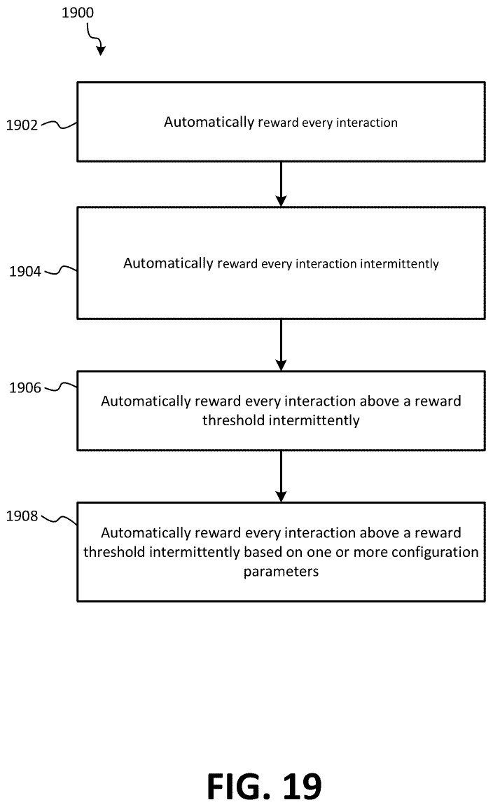

In embodiments, and with additional reference to FIG. 19, which illustrates a specific example of an automated reward protocol 1900 implemented by the scratcher controller 110 in accordance with embodiments of the present disclosure, the automated reward protocol 1900 may include a sequence of levels that progressively refine how rewards are dispensed based on the cat's interactions with the smart cat scratcher 100. As shown in FIG. 19, a first configuration level 1902 may include automatically rewarding every interaction with the scratching surface 150 by the cat. Under this first configuration level of the automated reward protocol 1900, every detected interaction by the cat with the scratching surface 150 may be rewarded regardless of the interaction's intensity, duration, and/or nature, including incidental contact, exploratory touches, and full scratching behavior. In embodiments, the first configuration level of the automated reward protocol 1900 may be configured to facilitate establishing an initial association between interaction and reward in the cat.

In embodiments, a second configuration level 1904 of the automated reward protocol 1900 may include intermittently rewarding interactions with the scratching surface 150. Under this second configuration level 1904, an interaction with the scratching surface 150 is not automatically rewarded every time it occurs. Instead, the scratcher controller 110 is configured to dispense a reward only if the interaction falls within a defined intermittent ratio and/or interval (e.g., every second, third, fourth, fifth, etc., interaction, anywhere between every second to every thirtieth interaction). If an interaction with the scratching surface 150 occurs outside of the intermittent ratio and/or interval, no reward is dispensed. In embodiments, the intermittent ratio and/or interval may be determined by the scratcher controller 110 and/or may be based on configuration specified by the user.

For example, the scratcher controller 110 may be configured such that a reward is dispensed only after every third interaction by the cat with the scratching surface 150. In this embodiment, the first and second interactions with the scratching surface 150 may not result in a reward, but the third interaction with the scratching surface 150 may trigger a reward to be dispensed (e.g., via the reward dispenser 115). After that reward is dispensed, the count may reset, and the next reward may again be provided after the third subsequent interaction with the scratching surface 150.

In some embodiments, the intermittent reward schedule may be executed as a variable ratio and/or may be randomized, such as by rewarding after a randomly determined number of interactions within a defined range (e.g., between two and five interactions, between two and six interactions, between two and ten interactions, etc.), or such as by rewarding a defined average number of interactions (e.g., reward after an average of three interactions, where the reward may unpredictably come after two interactions, five interactions, etc.). It is noted that the ranges and averages provided are not intended to be limiting, and other ranges or averages may be used, such as between any first number of interactions (e.g., between one and ten) to any second number of interactions (e.g., between two and thirty). In embodiments, the second configuration level 1904 of the automated reward protocol 1900 may be configured to help sustain engagement and motivation while reducing treat dependency over time.

In embodiments, a third configuration level 1906 of the automated reward protocol 1900 may include intermittently rewarding interactions with the scratching surface that meets or exceeds a defined rewardable threshold. In embodiments, the rewardable threshold may be based on one or more measurable parameters of the interaction detected by the one or more sensors 120, including, without limitation, a minimum interaction intensity (e.g., light versus strong contact), a minimum interaction duration (e.g., more than two seconds), a specific scratching pattern or frequency, and/or amount of paw strokes, and/or other interaction characteristics indicative of meaningful engagement.

In embodiments, a fourth configuration level 1908 may include intermittently rewarding every interaction that meets one or more rewardable thresholds, as described above, and further managing the reward dispensing behavior based on one or more configuration parameters. These configuration parameters may include, for example, daily or session-based maximum treat limits, time-of-day restrictions, the cat's behavioral history (e.g., as observed by the smart cat scratcher 100 and/or other sources of the history), training stage, personality traits, and/or other owner-specified criteria provided via the associated mobile application.

In embodiments, the scratcher controller 110 may be configured to implement one or more of the configuration levels of the automated reward protocol 1900, and may continuously monitor data from the one or more sensors 120 to determine whether a given interaction satisfies the rewardable criteria associated with the current configuration level of the automated reward protocol 1900. In embodiments, the scratcher controller 110 may manage the timing, frequency, quantity, etc. of rewards in accordance with the active system configuration. In some embodiments different configuration levels of the automated reward protocol 1900 may be configured for different cats, such that a first cat may be rewarded based on a particular configuration level of the automated reward protocol 1900 and a second cat may be rewarded based on a different configuration level of the automated reward protocol 1900.

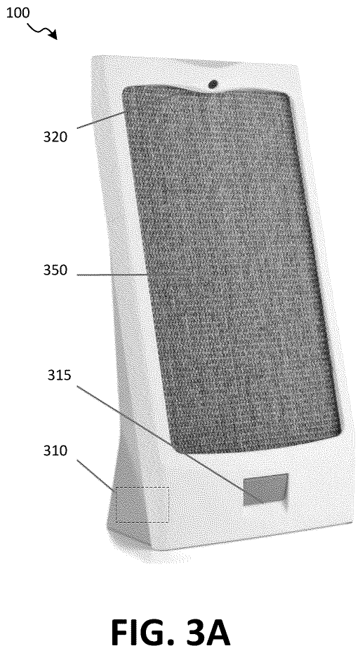

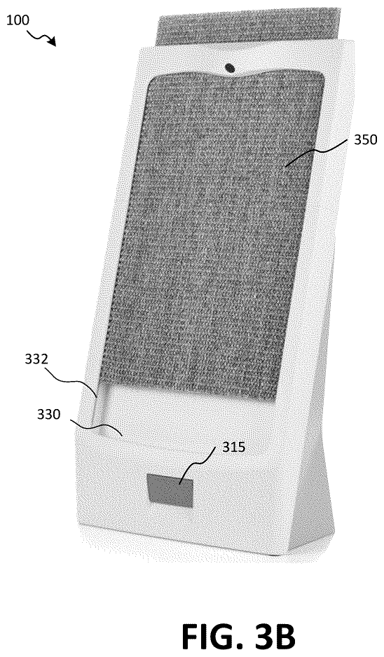

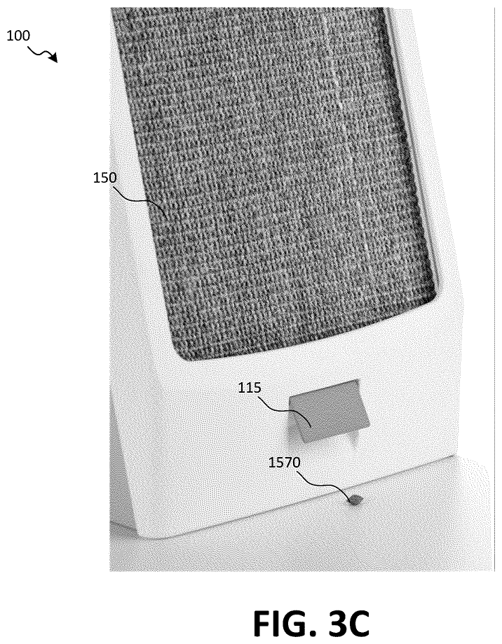

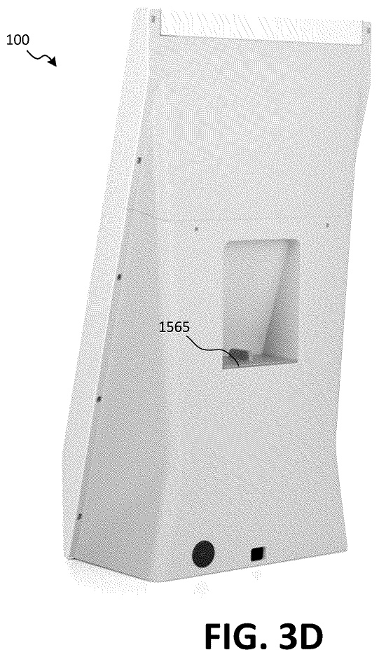

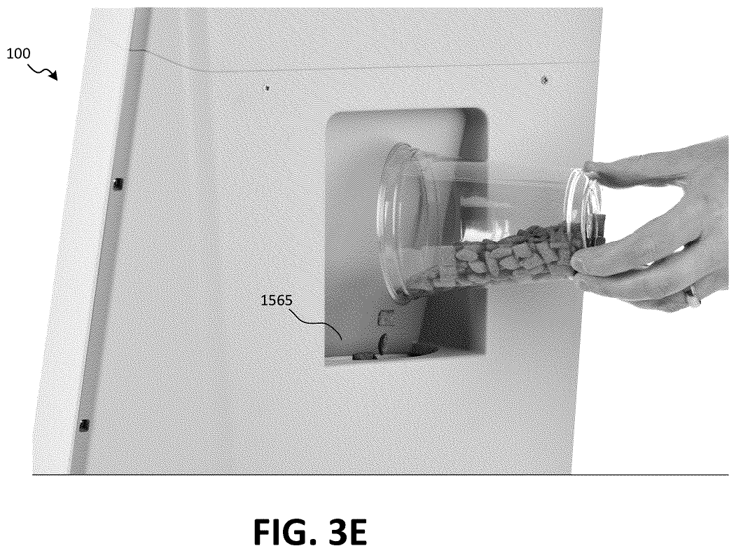

FIGS. 3A and 3B illustrate one exemplary embodiment of a smart cat scratcher 100 implemented in accordance with the present disclosure. FIG. 3A shows a perspective view of the smart cat scratcher 100 illustrating the arrangement of primary components in accordance with the present disclosure. FIG. 3B shows another perspective view of the smart cat scratcher 100 illustrating the arrangement of primary components in accordance with the present disclosure. These figures represent one example form factor of the smart cat scratcher 100 of embodiments, and it should be understood that the example illustrated is not intended to be limiting in any way and that the overall architecture and functional components described herein may be implemented in a variety of physical shapes, orientations, configurations, and/or designs.

In the embodiment illustrated in FIGS. 3A and 3B, the smart cat scratcher 100 includes a scratching surface 350, a camera 320, a reward dispenser 315, and a controller 310. These components operate cooperatively to detect and analyze scratching activity, determine whether the activity satisfies criteria for reward dispensing, and deliver a reward in accordance with an automated reward protocol or configuration setting. Additional operations such as live streaming of video, recording of interaction data, and communication with a companion application may also be enabled by the operations of the smart cat scratcher 100.

As shown in this example, the scratching surface 350 may be mounted on the front face of the main body of the smart cat scratcher 100 and may be oriented vertically, although at an angle, to support a cat's natural scratching posture. The scratching surface 350 may be configured with functionality similar to the functionality of the scratching surface 150 as illustrated in FIG. 1.

In embodiments, the scratching surface 350 may define the primary engagement area of the smart cat scratcher 100 and may be configured to endure repeated claw contact while providing a tactile experience that is satisfying to the cat. One or more sensors may be positioned behind, adjacent to, or within the scratching surface 350 to detect the presence and quality of the scratching activity. In embodiments, the detected data may include the intensity, duration, direction, pattern, location, and/or frequency of the scratching activity.

As shown in FIG. 3B, the scratching surface 350 may be configured to be replaceable. In embodiments, the scratching surface 350 may be configured as a consumable element that may be removed and replaced when worn or when a different texture or aesthetic is desired. In one embodiment, the scratching surface 350 may be removed by sliding the scratching surface 350 out of a slot 330 formed in the housing 332 of the smart cat scratcher. The slot 330 may be configured with guides, tracks, and/or retention features to ensure secure placement of the scratching surface 350 during use while allowing easy removal without tools. In some embodiments, the scratching surface 350 may be attached by snap-fit elements, magnetic couplings, latch mechanisms, etc.

In embodiments, configuring the scratching surface 350 as a replaceable component allows users to maintain the performance and longevity of the smart cat scratcher over time. In embodiments, configuring the scratching surface 350 as a replaceable component may enable customization of the smart cat scratcher 100 according to the preferences of the cat or the owner. In embodiments, replacement scratching surfaces may be fabricated from a variety of materials, including sisal rope, corrugated cardboard, carpet, fabric, felt, wood, or combinations thereof. In embodiments, scratching surfaces may be provided with different textures ranging from soft to coarse, providing options to suit various scratching behaviors. In some embodiments, the scratching surfaces may be produced in different colors, patterns, shapes, and/or decorative skins to integrate with home decor. In some embodiments, the surfaces may include infused scents, pheromones, specialized coatings, and/or embedded patterns to further encourage interaction by the cat.

The camera 320 may be configured with functionality similar to the functionality of the one or more sensors as illustrated in FIG. 1. In embodiments, the camera 320 may be positioned near the top center of the main body of the smart cat scratcher 100 to provide a broad field of view of the scratching surface 350 and surrounding area. In some embodiments, the camera 320 may be positioned behind a transparent protective window or cover to shield it from scratching debris or accidental contact, or have a privacy cover for additional privacy reassurance.

The camera 320 may capture still images or video associated with the cat's interaction with the smart cat scratcher 100. This visual data may be used for live viewing, remote monitoring, remote communications with the cat, and/or archival recording. In some embodiments, the camera 320 may support advanced computer vision functions, such as identifying individual cats, telling apart cats from dogs, humans, etc., analyzing scratching quality based on posture and motion, or distinguishing scratching behavior from other types of interactions. The captured image or video data may be processed by AI and/or ML models to enhance detection accuracy and provide additional behavioral insights. In some embodiments, the camera 320 may operate as a primary or supplementary input source for triggering the reward dispensing process (e.g., may provide functionality of the one or more sensors 120).

The reward dispenser 315 may be configured with functionality similar to the functionality of the reward dispense 115 as illustrated in FIG. 1. In embodiments, the reward dispenser 315 may be integrated into the lower portion of the main body of the smart cat scratcher 100 and may be positioned such that the outlet is easily accessible to the cat immediately after scratching. In embodiments, the reward dispenser 315 may include a dispensing chute, a receptacle, or a door mechanism configured to release rewards into a location accessible to the cat.

In embodiments, the reward dispenser 315 may be configured to store and dispense various types of rewards including food treats, kibble, and/or non-food rewards such as catnip or silver vine. During operation, upon receiving a control signal from the controller 310, the reward dispenser 315 may release a predetermined quantity of the reward. In some embodiments, the dispensing behavior may be configured to support different training strategies, including continuous reward, intermittent reward, randomized reward schedules, variable reward schedules, etc. In embodiments, the reward dispenser 315 may include one or more chambers to accommodate different treat types or sizes, allowing users to tailor the reward type to individual preferences.

In embodiments, food-based rewards dispensed by the smart cat scratcher may include lickable treats. In embodiments, the reward dispenser 315 may include a dedicated lickable-treat interface comprising a small removable and or washable tray, platform, spoon-like surface, or receptacle configured to receive, retain, and present a lickable treat in a form accessible to the cat for licking. In embodiments, the lickable treat may be dispensed by depositing, extruding, or otherwise presenting a portion of the lickable treat onto the tray, after which the tray may be positioned or exposed to allow the cat to lick the treat directly from the tray. In embodiments, the lickable-treat interface may be modular and interchangeable, enabling a user to select and install a particular food or treat attachment corresponding to a desired reward type, including but not limited to kibble, hard treats, wet food, or lickable treats, each of which may be associated with a corresponding dispensing mechanism such as a treat hopper, auger, pump, piston, extrusion mechanism, or other suitable delivery technology. In embodiments, the dispensing technology may be integrated into the smart cat scratcher such that the device is preconfigured to dispense a particular reward type, for example hard treats via a treat hopper, while still optionally supporting additional reward types. In embodiments, the smart cat scratcher may be equipped to dispense more than one food or treat type, either sequentially or selectively, to provide ongoing reward variety and enrichment based on user configuration or automated reward protocol.

The controller 310 may be configured with functionality similar to the functionality of the scratch controller 110 as illustrated in FIG. 1. In embodiments, the controller 310 may be housed within the main body of the smart cat scratcher 100 and may include processing, memory, and/or control circuitry for operating the smart cat scratcher 100 in accordance with embodiments disclosed herein. In embodiments, the controller 310 may receive input data from the sensors and camera 320, may analyze the data to detect an interaction between a cat and the smart cat scratcher 100, may determine one or more characteristics associated with a detected interaction, may determine whether to dispose a reward in response to the detected interaction based on the one or more characteristics and system configuration, and may send a control signal to the reward dispenser 315 to dispense a reward when appropriate.

In embodiments, the controller 310 may transmit control signals to the reward dispenser 315 to initiate dispensing and may coordinate communication with a user terminal or cloud service. In some embodiments, the controller 310 may manage firmware updates, execute diagnostics, and/or store historical data for behavioral analysis. The controller 310 may also implement user-defined settings, such as maximum treat limits, quiet hours, specific training modes, etc.

FIGS. 3C-3E illustrate operational aspects of the smart cat scratcher 100 described with reference to FIGS. 3A and 3B. These figures illustrate operations of the smart cat scratcher 100 during operations, including the dispensing of rewards in response to detected scratching behavior and the refilling of the reward storage compartment. As described previously, the smart cat scratcher 100 may be configured to detect and analyze scratching interactions via one or more sensors and/or a camera 320, and to dispense rewards from the reward dispenser 115 based on predefined criteria and training protocols.

As shown in FIG. 3C, the smart cat scratcher 100 may dispense a treat or other reward from the reward dispenser 115 following a rewardable interaction with the scratching surface 150. In embodiments, the determination of whether a scratching event is rewardable may be based on one or more configurable conditions, including without limitation, the reward schedule (e.g., rewarding every interaction, every second interaction, or according to an intermittent, randomized, and/or variable ratio schedule), the quality of the scratching behavior (e.g., whether the detected scratching meets a minimum intensity threshold, exceeds a duration limit, or matches a specific motion profile), user-defined limitations (e.g., a maximum number of treats allowed per day for a particular cat profile), and/or based on an automated reward protocol. It is noted that in some embodiments, an intermittent schedule may be predictable (e.g., may be fixed, such as every second time) or unpredictable (e.g., may be variable, such as every second time on average).

FIG. 3D shows a rear perspective view of the smart cat scratcher 100 illustrating a refill cover 1565. In embodiments, the refill cover 1565 provides user access to the internal reward container or hopper, which stores the treats or rewards to be dispensed. The refill cover 1565 may be configured to be removable or openable without tools, allowing users to quickly and easily replenish the reward supply.

As shown in FIG. 3E, the reward storage compartment may be refilled by removing or opening the refill cover 1565 and depositing treats directly into the internal container. Once filled, the smart cat scratcher 100 may automatically resume dispensing operations without requiring additional setup steps. In some embodiments, the controller 310 may monitor the treat level within the container and may generate a notification through the connected app or interface when the supply is low, prompting the user to refill before depletion occurs.

In some embodiments, the refill compartment or internal reward storage container of the smart cat scratcher 100 may include one or more volume detection sensors configured to monitor the quantity of treats or rewards remaining within the reservoir. In embodiment, the one or more volume detection sensors may include, without limitation, optical sensors, load cells, capacitive sensors, ultrasonic level detectors, etc., any of which may generate real-time data indicating the fill level of the container. In embodiments, the controller 310 may process this data to estimate remaining capacity and may transmit a notification to the connected app or user interface, and/or may activate a refill indicator (e.g., an indicator, LED, light, etc. on the smart cat scratcher 100, not shown) when the treat level falls below a defined threshold.

These operational features, when combined with the intelligent sensing, analysis, and reward-dispensing capabilities described above, enable the smart cat scratcher 100 to function as a fully automated positive-reinforcement training system. By integrating configurable reward logic, user-friendly refill access, precise dispensing control, and easy operations, the smart cat scratcher 100 ensures consistent training outcomes while simplifying day-to-day operation for the user.

It is noted that although FIGS. 3A-3E illustrate a vertical style implementation of the smart cat scratcher 100, the principles described herein are not limited to this configuration. In some embodiments, the components may be arranged in alternative configurations, and multiple cameras, scratching surfaces, and/or reward dispensers may be provided. In some embodiments, the replaceable scratching surface functionality of the smart cat scratcher 100 may be applied regardless of the overall form factor or smart cat scratcher orientation.

It is also noted that the configuration illustrated in FIGS. 3A-3E provides several technical and functional advantages. For example, the replaceable scratching surface enhances maintainability and extends product lifespan. The modularity of the surface also allows for aesthetic customization and tailored scratching experiences as well as optimized shipping. The integrated camera improves behavioral monitoring and analysis, while the automated reward dispenser ensures immediate reinforcement of desirable behavior. Together, these features create a robust, adaptive training platform that improves the effectiveness of positive reinforcement training while delivering a more engaging and rewarding experience for the cat.

In embodiments, the smart cat scratcher 100 may include one or more physical user-interface elements disposed on an exterior surface of the smart cat scratcher 100 housing and configured to enable basic operational control without requiring use of a companion application. In embodiments, such user-interface elements may include one or more buttons, switches, touch-sensitive regions, or other actuable controls configured to allow a user to perform basic operations including, without limitation, powering the device on or off, selecting a continuous reinforcement mode in which every rewardable interaction results in a reward, selecting an intermittent reinforcement mode in which only some rewardable interactions result in a reward, and resetting or pausing reward dispensing. In embodiments, activation of one or more of these physical controls may cause the scratcher controller to transition between predefined operational modes or reward protocol configurations, enabling users who do not wish to install or use an application to nevertheless leverage core functionality of the smart cat scratcher.

In embodiments, the smart cat scratcher 100 may be configured to implement a loyalty-based reward mechanism in which enhanced rewards are dispensed in response to sustained or repeated engagement over time. In embodiments, the smart cat scratcher 100 may track a number of scratching events or other defined behaviors occurring within a defined time window and may determine that a loyalty condition has been satisfied when the cat meets or exceeds a predefined engagement threshold. In response to determining that the loyalty condition is satisfied, the smart cat scratcher 100 may dispense a reward having an increased reward intensity relative to standard rewards, such as dispensing a larger number of treats, a higher-value reward, or an alternative reward modality.

In embodiments, the smart cat scratcher 100 may be configured to implement a lapsed-engagement reward mechanism to re-engage cats that have not interacted with the smart cat scratcher for a defined period of time. In embodiments, the smart cat scratcher 100 may track temporal gaps between interactions and may determine that a lapse condition has occurred when no qualifying interaction is detected for longer than a predefined duration. Upon detecting a subsequent interaction following such a lapse, the smart cat scratcher 100 may classify the interaction as eligible for a re-activation reward and may dispense an enhanced reward, such as a larger or higher-value reward, relative to standard rewards. In embodiments, the lapsed-engagement reward mechanism may operate automatically and may be used to re-establish positive associations with the smart cat scratcher and encourage return engagement without requiring manual intervention.

In embodiments, a plurality of smart cat scratchers 100 may be communicatively connected to one another to form a networked system. In embodiments, the plurality of smart cat scratchers 100 may be communicatively coupled through one or more wired communication links (e.g., Ethernet, serial, or USB connections), one or more wireless communication links (e.g., Wi-Fi, Bluetooth, Zigbee, or other radio-frequency protocols), or a combination thereof. In embodiments, the communicative coupling between the plurality of smart cat scratchers 100 may allow each smart cat scratcher 100 to share data related to detected interactions, behavioral patterns, reward dispensing activity, operational status, configuration parameters, and/or other relevant operational information. In embodiments, this shared data may enable coordinated decision-making, synchronized reward protocols, distributed behavioral tracking, and/or system-level training strategies that may not be possible with a single standalone device. For example, in one embodiment, if a cat interacts with a first smart cat scratcher 100, data regarding the interaction (e.g., interaction type, intensity, duration, classification, etc.) may be transmitted to a second smart cat scratcher 100 to adjust the reward criteria of the second device, synchronize reward scheduling, and/or dynamically allocate dispensing opportunities across the networked system. In embodiments, the plurality of smart cat scratchers 100 may operate under a centralized control system (e.g., a cloud-based server, a local hub, or one of the scratchers acting as a master device) or under a distributed control architecture in which each smart cat scratcher 100 contributes to and benefits from shared interaction data.

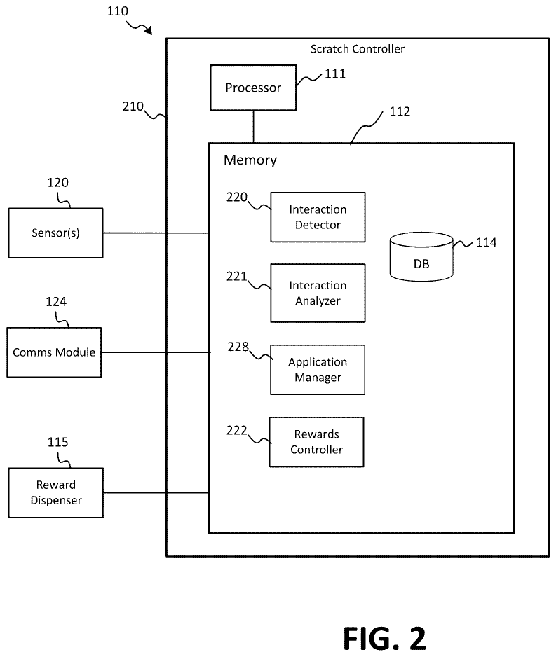

Functionality and operations of the scratcher controller 110 as illustrated in FIG. 1 will now be discussed with respect to FIG. 2. FIG. 2 is a block diagram illustrating a functional example of a scratcher controller 110 configured with capabilities and functionality for managing the functionality of the smart cat scratcher 100 for automatically dispensing rewards in response to an interaction by a cat in accordance with embodiments of the present disclosure. As shown in FIG. 2, the scratcher controller 110 may be implemented in a computing device 210. In embodiments, functionality of the computing device 210 to facilitate operations of the scratcher controller 110 may be provided by the cooperative operation of the various components of the computing device 210, as will be described in more detail below.

It is noted that although FIG. 2 shows the computing device 210 as a single computing device (e.g., a server, a user terminal, etc.), it will be appreciated that the computing device 210 (and the individual functional blocks of the computing device 210) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of the computing device 210 as single and separate blocks, each of the various components of the computing device 210 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of the computing device 210 may actually be part of a different component of the computing device 210, and as such, the description of the particular functionality described for the particular component of the computing device 210 is for illustrative purposes and not limiting in any way.

As shown in FIG. 2, the scratcher controller 110 includes processor 111, memory 112, interaction detector 220, interaction analyzer 221, rewards controller 222, application manager 228, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise a database 114 for storing various information related to operations of the smart cat scratcher 100. For example, database 114 may store configuration information related to operations of the scratcher controller 110. In embodiments, database 114 may store information related to various models used during operations of scratcher controller 110, such as AI and/or ML algorithms used to analyze the captured interaction data to determine the quality of the interaction, and/or the condition of a cat, and/or used to manage the automated reward protocol.

In embodiments, database 114 may store data related to the personalization of the smart cat scratcher device 100. This data may include storing user-specific settings, such as preferences for reward dispensing criteria, schedules, reward types, reward intensities, quiet hours during which no rewards are dispensed, the physical location of each smart cat scratcher within the user's environment, etc. Additionally, database 114 may maintain comprehensive profiles for each cat, including cat identity, age, training level, and dietary considerations like daily treat limits, kibble limits, and calorie limits. Database 114 may also store scratching-related metrics, such as the number and frequency of scratches, which can be used to monitor the cat's engagement with the smart cat scratcher and adjust training protocols accordingly. Furthermore, database 114 may store thresholds that trigger notifications to the user, such as when interaction activity deviates from established patterns, potentially indicating a change in the cat's health or behavior. Video and/or image data captured by the smart cat scratcher 100's camera may also be stored, providing visual records of the cat's interactions with the smart cat scratcher 100 for further analysis or sharing with the user through the connected application.

Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

In embodiments, the interaction detector 220 may be configured to detect the occurrence of an interaction between a cat and the smart cat scratcher 100 based on data received from the one or more sensors 120. The interaction detector 220 may operate as the detection layer within the overall control architecture of the smart cat scratcher 100. In particular, the interaction detector 220 may be configured to receive raw sensor data indicative of one or more forms of interaction with the smart cat scratcher 100, including, without limitation, the presence or proximity of the cat, incidental or exploratory contact with any portion of the device, contact with the scratching surface 150 (e.g., whether or not such contact constitutes a full scratching motion), and/or active scratching activity. In embodiments, the interaction detector 220 determines whether the sensor data from the one or more sensors satisfies a baseline condition for detection (e.g., whether the sensor data indicates that an interaction has occurred).

In embodiments, once the interaction detector 220 determines that an interaction has occurred, the interaction data may be provided to the interaction analyzer 221. The interaction analyzer 221 may be configured to further process and analyze the sensor data to determine one or more characteristics of the detected interaction, such as, without limitation, the interaction's intensity, duration, location, direction, frequency, pattern, and/or any other parameter indicative of the nature or quality of the interaction. In embodiments, the interaction characteristics determined by the interaction analyzer 221 may be provided to a rewards controller 222, which may use this information (e.g., in combination with configuration parameters and operational mode settings such as automated reward protocol configuration) to determine whether a reward is to be dispensed. In embodiments, the rewards controller 222 may be configured to implement a no-protocol mode, in which case the decision to dispense a reward is based on the configuration specified for the smart cat scratcher 100 (e.g., rewarding every interaction or rewarding every other interaction), or an automated reward protocol mode, in which case the decision is based on the configuration level and parameters of the configured reward protocol (e.g., intermittently rewarding an interaction, and/or requiring that the interaction exceeds a threshold of intensity or duration before a reward is dispensed). If the rewards controller 222 determines that a reward is to be dispensed, the rewards controller 222 may generate an automatic control signal to actuate the reward dispenser 115 and cause the physical dispensing of a reward.

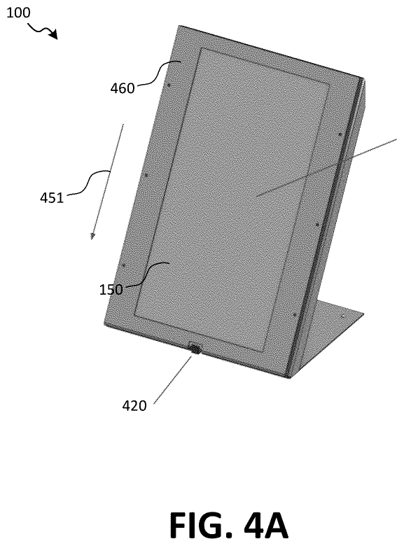

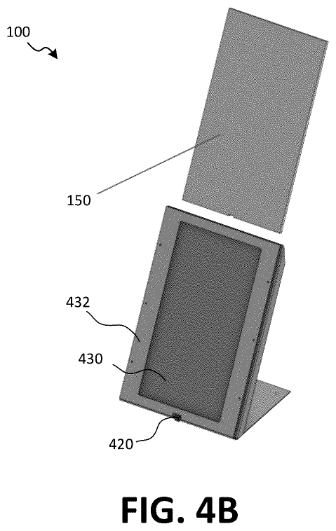

In embodiments, various types of sensors and detection techniques may be used to capture interaction data, which may be used by the interaction detector 220, interaction analyzer 221, and rewards controller 222 to detect an interaction and determine whether to dispense a reward or not in response to the detected interaction. These techniques may vary in complexity, sensitivity, and the types of interaction characteristics that may be detected and/or measured. With reference now to FIGS. 4A-11, various embodiments of sensor configurations and detection techniques are described in greater detail below, illustrating multiple approaches for detecting an interaction, collecting data regarding the interaction, and/or enabling the smart cat scratcher 100 to respond appropriately based on the detected interaction and associated characteristics.

FIGS. 4A through 11 illustrate various exemplary embodiments of sensor systems and detection techniques that may be implemented with the smart cat scratcher 100. In embodiments, the smart cat scratcher 100 may include one or more sensors 120 configured to detect interactions between a cat and the smart cat scratcher 100. In embodiments, the one or more sensors 120 may be configured to detect the occurrence of an interaction and to capture data about the nature and one or more characteristics of the interaction. In embodiments, the one or more characteristics may include, without limitation, the intensity, duration, direction, location, frequency, and/or pattern of the interaction, and may include contextual information such as whether the interaction was exploratory, incidental, deliberate, etc.

FIGS. 4A and 4B illustrate one exemplary embodiment of a smart cat scratcher 100 configured with a load-cell-based interaction detection system in accordance with embodiments of the present disclosure. In embodiments, the scratching surface 150 may be supported by a structural frame 460 that is mechanically coupled to one or more load cells 420. In embodiments, the one or more load cells 420 may include a type of force-sensing device that converts mechanical load or force into an electrical signal proportional to the magnitude and nature of the force. In embodiments, when a cat interacts with the scratching surface 150 (e.g., by leaning, pressing, pawing, pulling, or actively scratching), the resulting mechanical force may be transmitted through the support structure to the one or more load cells 420. In embodiments, the one or more load cells 420 may generate corresponding electrical signals based on the mechanical force, which may be sent to the interaction detector 220. For example, a cat interacting with the scratching surface 150 may scratch the surface in a downward direction 451 with a particular level of force, in which case the particular force in the downward direction 451 may be transmitted to the one or more load cells 420, which may generate a corresponding electrical signal based on the scratch, the electrical signal representing the scratching activity by the cat.

In embodiments, the interaction detector 220 may be configured to analyze this sensor data (e.g., the electrical signal generated by the one or more load cells 420 in response to the interaction by the cat) to determine whether an interaction has occurred. Because load cells are sensitive to a wide range of forces, the interaction detector 220 may detect many types of engagements, from subtle exploratory touches to high-intensity scratching motions. Load cells may also have the ability to successfully differentiate between a cat paw and a dog paw interaction due to the difference in applied force. In embodiments, once an interaction is detected, the captured data may be provided to the interaction analyzer 221, which may process and interpret the electrical signals generated by the one or more load cells 420 to determine one or more characteristics of the interaction, such as total applied force, peak force, rate of force change, and/or duration of the applied load. For example, a light, momentary touch might register as a low-force event, while a more forceful, repetitive scratching action might generate a stronger, periodic signal.

In embodiments, the load-cell-based interaction detection system illustrated in FIGS. 4A and 4B may be configured to measure force vectors in multiple directions, allowing the interaction analyzer 221 to differentiate vertical forces (e.g., downward scratching or pushing) from horizontal forces (e.g., lateral swiping or pulling). In embodiments, the directional information may enable the interaction analyzer 221 to characterize the nature of the interaction and may be used to distinguish between different interaction types for reward-protocol purposes. For example, a vertical scratching motion may be treated differently from a horizontal pawing motion when evaluating whether the interaction meets a rewardable threshold.

In embodiments, the interaction data processed by the interaction analyzer 221 may be provided to the rewards controller 222, which may determine whether a reward should be dispensed based on the configured operational mode of the system. In embodiments, in a no-protocol configuration, the decision may be based solely on user-defined parameters (e.g., rewarding every interaction or every third interaction). In an automated reward-protocol configuration, the decision may be based on the level of the protocol currently active. For example, the rewards controller 222 may compare the measured force against a predefined threshold, evaluate the total applied force over time, and/or assess the rhythmic characteristics of the electrical signal to determine whether the interaction satisfies the reward criteria (e.g., whether the interaction is a rewardable interaction, such as a scratch, or a scratch of sufficient intensity). If the criteria are met, the rewards controller 222 may issue a control signal to the reward dispenser 115 to dispense a reward.

It is noted that the load-cell-based detection technique offers several technical advantages. For example, because load cells generate quantitative force data, load cells allow the smart cat scratcher 100 to distinguish between different intensities and types of interaction with a high degree of precision. Over time, the system may adapt these criteria dynamically (e.g., by increasing the force threshold required for a reward as the cat becomes more skilled or engaged). Additionally, long-term data collected through load-cell sensing may be used to monitor behavioral trends, such as changes in scratching strength or frequency, which may provide insight into the cat's health, and/or behavioral state.

In embodiments, load cell sensors may detect a broad range of engagement beyond scratching. For example, load cells may register a cat leaning against the scratcher, climbing onto it, or landing on it after a jump. The rewards controller 222 may evaluate such events differently based on the reward configuration (e.g., ignoring incidental leaning but rewarding repeated, high-force scratching patterns). In some embodiments, multiple load cells may be distributed at different points beneath the scratching surface 150 to provide spatial resolution of applied forces, enabling the smart cat scratcher to determine where on the surface the interaction occurs. In yet other embodiments, load cells may be combined with other sensor types, such as accelerometers, capacitive touch elements, optical sensors, etc. to create a multimodal detection system with improved precision.

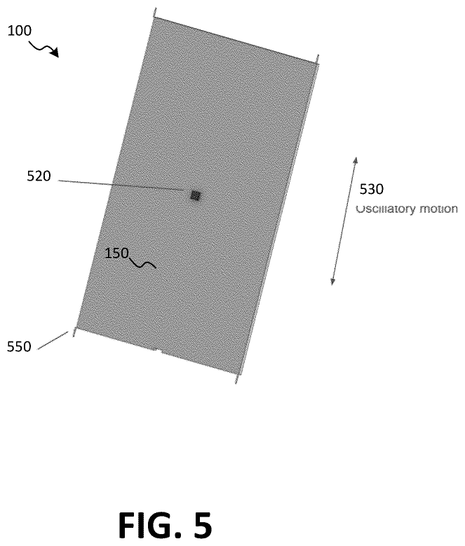

FIG. 5 illustrates an exemplary embodiment of a smart cat scratcher 100 configured with an accelerometer-based interaction detection system in accordance with embodiments of the present disclosure. In embodiments, the accelerometer-based interaction detection system enables the smart cat scratcher 100 to detect and characterize interactions with a cat by measuring motion and mechanical response. For example, in embodiments, the scratching surface 150 may be mounted to a main body of the smart cat scratcher 100 through one or more elastic or semi-rigid support elements 550. In embodiments, the one or more elastic or semi-rigid support elements 550 may include springs, flexible rods, elastomeric components, and/or other compliant structures configured to allow the scratching surface 150 to translate, displace, oscillate, and/or otherwise move slightly in response to contact from a cat. In embodiments, one or more accelerometers 520 may be mechanically coupled to the scratching surface 150 or to structural components supporting the scratching surface 150. In embodiments, the one or more accelerometers 520 may be configured to detect motion, acceleration, vibration, and/or other dynamic response characteristics that occur when a cat interacts with the scratching surface 150.

In embodiments, when a cat interacts with the scratching surface 150, such as by pawing, pushing, pulling, leaning, jumping, and/or scratching, the interaction may induce a motion 530 (e.g., including an oscillatory motion) in the mounted structure. The induced motion 530 may be detected by the one or more accelerometers 520. Because the one or more accelerometers 520 are configured to measure acceleration in multiple axes, the one or more accelerometers 520 may capture a wide range of motion characteristics, including, without limitation, amplitude, frequency, acceleration magnitude, direction, and/or duration of the induced motion 530. The resulting acceleration data may be used by the scratch controller 110 to determine information associated with the interaction. For example, a rapid series of high-amplitude acceleration signals may indicate vigorous, repeated scratching activity, while a single low-amplitude motion may indicate light, exploratory contact. By analyzing the acceleration data, the smart cat scratcher 100 may distinguish between different types of interaction and determine whether a particular event meets the criteria for a rewardable interaction.

In embodiments, the use of the one or more elastic or semi-rigid support elements 550 may enhance the sensitivity and resolution of the detection system. For example, the elasticity of the one or more elastic or semi-rigid support elements 550 may allow the scratching surface 150 to respond dynamically to the interaction, producing characteristic motion patterns that reflect the intensity, style, and/or frequency of the cat's behavior. These oscillations, vibrations, fluctuations, and/or displacements may be captured by the one or more accelerometers 520. The acceleration data captured by the one or more accelerometers 520 may be processed by the interaction detector 220 to determine whether an interaction has occurred. Once an interaction is detected, the acceleration data from the one or more accelerometers 520 may be provided to the interaction analyzer 221, which may determine one or more characteristics of the detected interaction, such as total energy of the interaction event, peak acceleration achieved, frequency components of the motion (which may correspond to rhythmic scratching patterns), and/or directionality of the detected motion.

In embodiments, the interaction analyzer 221 may further analyze the acceleration data in real time to classify the interaction. The interaction analyzer 221 may compare the detected motion profile against one or more predefined thresholds, patterns, and/or criteria to determine whether the interaction qualifies as a rewardable interaction. For example, a threshold level of acceleration magnitude may be required to differentiate a meaningful scratching interaction from a gentle or incidental touch (although in some embodiments, even a gentle or incidental touch may be classified as a rewardable interaction). Additionally, the interaction analyzer 221 may evaluate the duration of oscillation or the number of oscillatory cycles to identify sustained scratching behavior. These measurements may be combined to generate a comprehensive interaction profile, which may be used by the rewards controller 222 to support a more granular decision-making regarding whether a reward is to be dispensed.

In some embodiments, multiple accelerometers 520 may be used in combination to enhance the spatial resolution and detection accuracy of the smart cat scratcher 100. For example, accelerometers positioned at different points on the scratching surface 150 or on the support structure may capture variations in motion across the surface, enabling the smart cat scratcher 100 to estimate the location of the interaction. In embodiments, the use of multiple accelerometers 520 may also improve detection of motion direction and may provide redundancy to ensure reliable operation and accurate interaction detection.

In embodiments, the acceleration data processed by the interaction analyzer 221 may be provided to the rewards controller 222, which may determine whether a reward is to be dispensed based on the operational mode of the system. In a no-protocol configuration, the decision may be based solely on user-defined parameters, such as rewarding every interaction or rewarding every second or third interaction. In an automated reward-protocol configuration, the decision may be based on the currently active protocol level, which may include thresholds based on acceleration magnitude, oscillation duration, frequency of detected motion, and/or other interaction characteristics. If the interaction satisfies the configured criteria, the rewards controller 222 may send a control signal to the reward dispenser 115 to initiate the dispensing of a reward.

The accelerometer-based detection technique provides several technical advantages. Because accelerometers are compact, low-cost, and require minimal power, the one or more accelerometers 520 may be easily integrated into a variety of smart cat scratcher configurations. The sensitivity of the one or more accelerometers 520 to dynamic motion may allow the smart cat scratcher 100 to distinguish between active, behaviorally meaningful interactions and static contact (e.g., when a cat is simply resting against the scratching surface 150). Additionally, the ability of the one or more accelerometers 520 to capture temporal and frequency-domain data may enable the smart cat scratcher 100 to identify characteristic interaction rhythms and behavioral patterns, which may be used to refine reward criteria over time.

In some embodiments, the acceleration data captured by the one or more accelerometers 520 may be used in conjunction with data generated by other sensor modalities, such as the one or more load cells 420, one or more capacitive sensors, one or more optical sensors, etc. to provide a more robust and comprehensive interaction detection system. The combination of motion data with force, position, sound, and/or capacitive contact data may enhance detection accuracy and may enable advanced behavioral analysis, including identification of scratching styles, assessment of engagement level, detection of changes in behavior that may indicate health or environmental issues, etc.

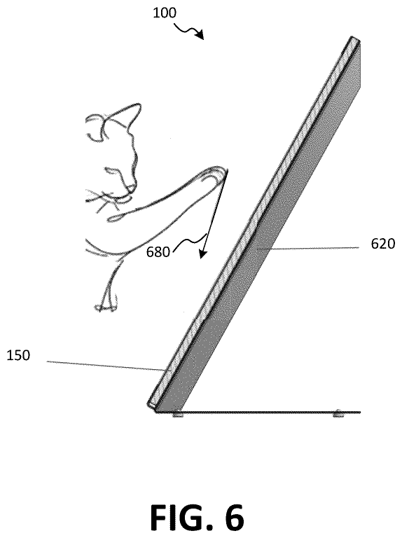

FIG. 6 illustrates an exemplary embodiment of a smart cat scratcher 100 configured with a capacitive-touch-based interaction detection system in accordance with embodiments of the present disclosure. In embodiments, the capacitive-touch-based interaction detection system may enable the smart cat scratcher 100 to detect, identify, and/or characterize interactions by a cat with the scratching surface 150 by measuring changes in capacitance caused by the proximity, presence, interaction, and/or movement of a cat's paw, claw, or body near or on the scratching surface 150.

In embodiments, the smart cat scratcher 100 may include one or more capacitive sensors 620 positioned adjacent to, beneath, within, and/or otherwise integrated into the scratching surface 150. The one or more capacitive sensors 620 may include conductive plates, conductive grids, conductive films, and/or other electrically conductive elements configured to establish an electric field and measure the capacitance associated with that field. In embodiments, when a conductive object, such as a cat's paw or claw, approaches, contacts, and/or hovers near the scratching surface 150, the one or more capacitive sensors 620 may detect a variation in capacitance proportional to the presence, proximity, or motion of the conductive object.

In embodiments, the interaction detector 220 may be configured to receive the capacitance data generated by the one or more capacitive sensors 620 and to determine whether the capacitance variation corresponds to an interaction between the cat and the scratching surface 150. Once an interaction is detected, the interaction data captured by the one or more capacitive sensors 620 may be provided to the interaction analyzer 221, which may process and interpret the capacitance data to determine one or more characteristics of the detected interaction. For example, the interaction analyzer 221 may determine the location of contact on the scratching surface 150, the timing and duration of contact, the trajectory of paw movement across the scratching surface 150 (e.g., vertical, horizontal, or diagonal), the speed of the contact, and/or the size or shape of the paw impression as inferred from the capacitance variation.

In embodiments, capacitive sensing may enable the smart cat scratcher 100 to detect a wide range of interactions, including, without limitation, incidental paw approaches, exploratory hovering movements, light touches, repeated paw taps, sliding paw swipes, and/or sustained scratching motions. The interaction analyzer 221 may analyze the frequency and temporal pattern of capacitance changes to identify rhythmic scratching behavior or repeated interaction sequences, while also evaluating the magnitude of the capacitance change to estimate the intensity, area of contact, or pressure of the paw. This data may be used to distinguish between a brief exploratory touch and a meaningful scratching session, enabling a more accurate reward determination.

In embodiments, the interaction characteristics determined by the interaction analyzer 221 may be provided to the rewards controller 222. The rewards controller 222 may evaluate whether the detected interaction meets the criteria for a rewardable interaction based on the operational mode of the smart cat scratcher 100. For example, in a no-protocol configuration, the decision to dispense a reward may be based on user-specified parameters such as rewarding every interaction, rewarding every second interaction, or rewarding only interactions that occur within designated time periods. In an automated reward-protocol configuration, the rewards controller 222 may compare the capacitance data against one or more predefined thresholds (e.g., minimum contact area, minimum contact duration, and/or minimum capacitance change magnitude) and/or evaluate specific interaction patterns to determine whether the interaction qualifies as rewardable.

In embodiments, the capacitive sensing technique of embodiments provides several advantages. For example, the one or more capacitive sensors 620 may be capable of detecting proximity prior to physical contact, and as such, the smart cat scratcher 100 may capture pre-contact behaviors such as hovering, sniffing, and/or investigative approaches, which may provide valuable behavioral data. Capacitive sensors are durable, thin, flexible, and contain no moving parts, making the capacitive sensors highly reliable and suitable for integration into various scratching surface materials and modular smart cat scratcher configurations (e.g., standalone scratching posts, wall-mounted designs, and/or multi-surface playground structures).

In embodiments, multiple capacitive sensors 620 may be arranged in a grid, array, or distributed configuration across the scratching surface 150. This arrangement may enable high-resolution mapping of paw contact and trajectory, allowing the smart cat scratcher 100 to identify scratching gestures unique to individual cats and to capture more sophisticated interaction characteristics. In some embodiments, the capacitance data may be combined with sensor data generated by other modalities (e.g., the one or more load cells 420, the one or more accelerometers 520, and/or optical or acoustic sensors) to provide multi-modal interaction detection that improves accuracy, redundancy, and/or robustness.

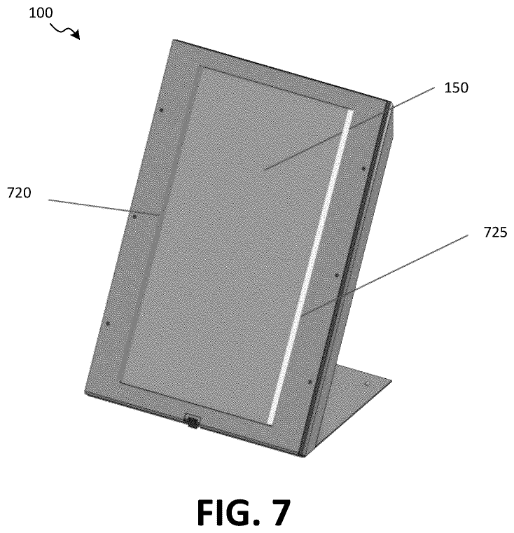

FIG. 7 illustrates an exemplary embodiment of a smart cat scratcher 100 configured with an emitter/receiver-based interaction detection system in accordance with embodiments of the present disclosure. In embodiments, the emitter/receiver-based interaction detection system may enable the smart cat scratcher 100 to detect, identify, and/or characterize interactions between a cat and the scratching surface 150 by measuring interruptions to one or more light beams or light fields generated across a sensing region. The emitter/receiver-based approach may provide a sensitive, non-contact method for detecting a wide range of interactions, including scratching, swiping, pawing, exploratory movement, and/or hovering, and may allow for detection of interaction characteristics such as presence, position, speed, direction, frequency, and/or duration.

In embodiments, the smart cat scratcher 100 may include one or more emitter arrays 725 positioned adjacent to the scratching surface 150 and configured to emit one or more light beams (e.g., infrared light, visible light, and/or other electromagnetic radiation) across a defined sensing plane. In embodiments, one or more receiver arrays 720 may be positioned on the opposite side of the scratching surface 150, configured to receive the one or more light beams emitted by the one or more emitter arrays 725. The one or more emitter arrays 725 and the one or more receiver arrays 720 may be arranged so that the emitted light beams form a continuous sensing field across, in front of, or proximate to the scratching surface 150. When a cat approaches or interacts with the scratching surface 150, a paw, claw, leg, or body part may enter the sensing field and may interrupt one or more light beams. The resulting interruption may cause a measurable change in the light received by the one or more receiver arrays 720.

In embodiments, the interaction detector 220 may be configured to receive and process the signal data generated by the one or more receiver arrays 720. When an interruption is detected, the interaction detector 220 may determine that an interaction has occurred. The interaction data associated with the detected interruption (e.g., beam number interrupted, duration of interruption, sequence of interruptions, etc.) may be provided to the interaction analyzer 221. The interaction analyzer 221 may analyze the interruption data to determine one or more characteristics of the detected interaction. For example, the interaction analyzer 221 may determine the timing and frequency of beam interruptions (which may indicate how often the cat is interacting with the scratching surface 150), the duration of each interruption (which may indicate how long the paw remains within the sensing field), and/or the order in which different beams are interrupted (which may indicate the direction of paw motion, such as upward, downward, lateral, or diagonal).

In embodiments, the spacing between successive beam interruptions may also be analyzed by the interaction analyzer 221 to determine the velocity or acceleration of the paw movement. For example, if interruptions occur rapidly across adjacent beams, the interaction analyzer 221 may determine that the cat's paw is moving quickly across the scratching surface 150, indicating a vigorous scratching motion. Conversely, slow or isolated interruptions may indicate exploratory or incidental interactions. Additionally, repeated and rhythmic interruption patterns may be indicative of sustained scratching behavior or deliberate engagement with the scratching surface 150.

In embodiments, the interaction characteristics determined by the interaction analyzer 221 may be provided to the rewards controller 222, which may evaluate whether the detected interaction satisfies one or more criteria for a rewardable interaction. In a no-protocol configuration, the decision to dispense a reward may be based solely on user-defined parameters, such as rewarding every interaction or rewarding only interactions that exceed a certain duration. In an automated reward-protocol configuration, the rewards controller 222 may compare the detected interaction characteristics (e.g., interruption duration, velocity, frequency, and/or direction) against one or more predefined thresholds to determine whether a rewardable interaction has occurred. If the criteria are satisfied, the rewards controller 222 may generate a control signal to the reward dispenser 115 to initiate the dispensing of a reward.

In embodiments, the emitter/receiver-based interaction detection technique may provide several technical advantages. Because the emitter/receiver-based interaction detection technique relies on non-contact optical sensing, the scratching surface 150 and the one or more sensors 120 may not be subjected to mechanical wear, improving durability and reducing maintenance. Additionally, because the one or more emitter arrays 725 and the one or more receiver arrays 720 may detect the presence of a paw before physical contact occurs, the smart cat scratcher 100 may capture pre-contact behaviors such as approach movements, swipes, and/or exploratory gestures. Furthermore, the absence of physical sensing elements on the scratching surface 150 may allow for greater design flexibility and broader material selection.

In some embodiments, one or more of the emitter arrays 725 and the receiver arrays 720 may be arranged as linear arrays along one or more edges of the scratching surface 150 to detect vertical or horizontal interactions. In other embodiments, the one or more emitter arrays 725 and the one or more receiver arrays 720 may be arranged in a grid or crosshatch configuration to form a two-dimensional sensing plane capable of detecting precise paw positions, mapping motion trajectories, and/or identifying specific interaction patterns. In some embodiments, the emitter/receiver-based sensing data may be used in combination with data generated by other sensing modalities (e.g., the one or more load cells 420, the one or more accelerometers 520, or the one or more capacitive sensors 620) to produce a more comprehensive interaction profile and improve detection accuracy.

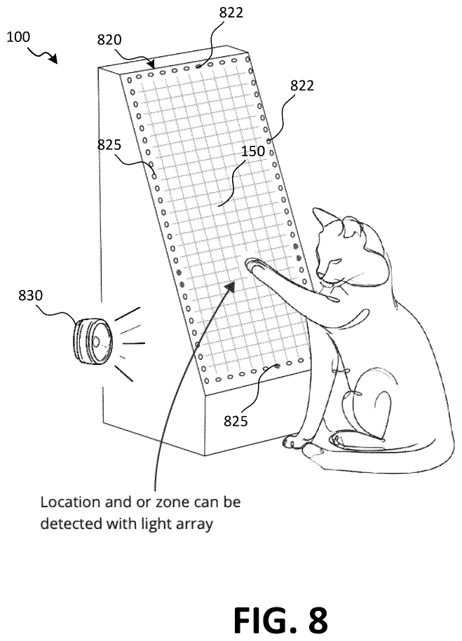

FIG. 8 illustrates an exemplary embodiment of a smart cat scratcher 100 configured with a light-array-based interaction detection system in accordance with embodiments of the present disclosure. In embodiments, the light-array-based interaction detection system may enable the smart cat scratcher 100 to detect, identify, and/or characterize interactions between a cat and the scratching surface 150 by measuring interruptions, reflections, and/or scattering of light beams projected across a defined sensing region. In embodiments, the one or more light beams may be generated by a light array sensor 820, which may include one or more transmitters 822 and one or more receivers 825, where each beam may be defined by a transmitter/receiver pair. It is noted that although the embodiment shown in FIG. 8 illustrates the one or more transmitters 822 disposed along an upper edge of the scratching surface 150 and the one or more receivers 825 disposed along a lower edge of the scratching surface 150, in embodiments, the positions of the one or more transmitters 822 and the one or more receivers 825 may be reversed, or positioned laterally along opposite vertical edges of the scratching surface 150, or otherwise configured to form a desired sensing field.

In embodiments, the one or more transmitters 822 of the light array sensor 820 may be configured to emit one or more beams of light (e.g., infrared, visible, ultraviolet, and/or other electromagnetic radiation) across the scratching surface 150 toward the one or more receivers 825. The one or more transmitters 822 and the one or more receivers 825 may be arranged to form a grid, matrix, or crosshatch pattern of intersecting beams, defining a two-dimensional sensing plane in front of or adjacent to the scratching surface 150. When a cat approaches, paws, swipes, scratches, and/or otherwise interacts with the scratching surface 150, the cat's paw or body may interrupt, reflect, scatter, and/or attenuate one or more beams within the sensing plane. These changes in the received light signals may be detected by the one or more receivers 825 and communicated to the interaction detector 220 for further processing.

In embodiments, the interaction detector 220 may be configured to determine whether an interaction has occurred based on the detection of one or more interruptions or alterations in the received light signals. Once an interaction is detected, the interaction data (e.g., which beams were interrupted, how long they were interrupted, in what sequence, and how frequently) may be provided to the interaction analyzer 221. The interaction analyzer 221 may analyze this data to determine one or more characteristics of the detected interaction, including, without limitation, the presence, location, trajectory, speed, and/or direction of the paw movement. For example, the interaction analyzer 221 may use the order and timing of beam interruptions to determine whether the cat's paw is moving upward, downward, or laterally. By analyzing which specific beams or beam clusters are interrupted, the interaction analyzer 221 may determine the location of the interaction on the scratching surface 150.

In embodiments, the interaction analyzer 221 may analyze additional interaction parameters derived from the light array data. For example, the spacing between successive beam interruptions may be used to calculate the velocity or acceleration of the paw movement. The density or concentration of interruptions within a particular area may be used to assess the intensity or focus of the scratching behavior. The duration of continuous beam interruptions may be used to estimate how long the cat's paw remains within the sensing region, which may correspond to the duration of the scratching interaction. Individually or in combination, these metrics may provide an interaction profile that may be used for training decisions and/or reward determinations.

In embodiments, the interaction characteristics determined by the interaction analyzer 221 may be provided to the rewards controller 222. The rewards controller 222 may evaluate whether the interaction satisfies one or more criteria for a rewardable interaction based on the operational mode of the smart cat scratcher 100. In a no-protocol configuration, the decision to dispense a reward may be based solely on user-defined criteria, such as rewarding every interaction or rewarding only interactions that occur for a minimum duration. In an automated reward-protocol configuration, the rewards controller 222 may compare the detected interaction characteristics (e.g., location, duration, frequency, velocity, and/or intensity) against one or more predefined thresholds to determine whether the interaction is rewardable. If the criteria are met, the rewards controller 222 may transmit a control signal to the reward dispenser 115 to initiate the dispensing of a reward.

In embodiments, the light-array-based interaction detection technique may provide several advantages. For example, the sensing plane is formed by light beams rather than physical sensors. As such, the scratching surface 150 may be constructed from a wide variety of materials without affecting sensing performance. The non-contact nature of the sensing system may reduce wear on components and extend the operational lifetime of the smart cat scratcher 100. Additionally, because the light array sensor 820 may detect beam interruptions before physical contact occurs, the system may capture pre-contact behaviors, such as paw approaches, exploratory gestures, and/or swiping motions, that might not generate sufficient force to trigger mechanical sensors.

In embodiments, the light array sensor 820 may be used in combination with other sensor modalities, such as the one or more load cells 420, the one or more accelerometers 520, the one or more capacitive sensors 620, etc. to improve detection accuracy and provide richer behavioral context. For example, data regarding paw location and trajectory captured by the light array sensor 820 may be combined with force data captured by the one or more load cells 420 or vibration data captured by the one or more accelerometers 520 to create a more complete representation of the cat's interaction. Multi-modal sensing may enhance detection reliability and reduce false positives, as well as support more complex and adaptive reward protocols based on multiple interaction parameters.

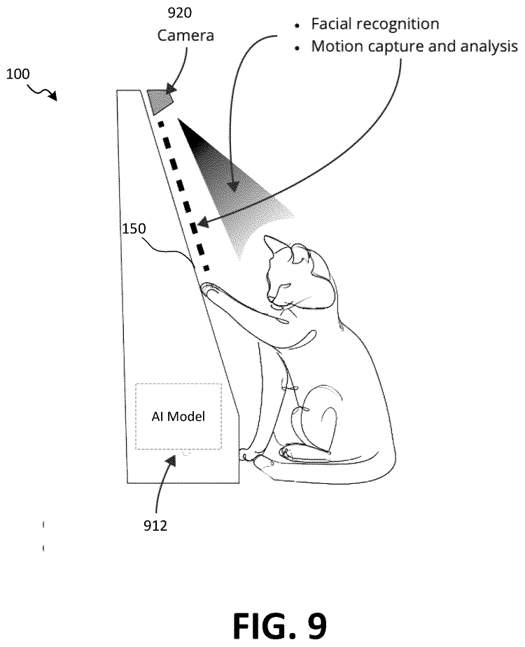

FIG. 9 illustrates an exemplary embodiment of a smart cat scratcher 100 configured with an AI/ML-based interaction detection system in accordance with embodiments of the present disclosure. In embodiments, the AI/ML-based interaction detection system may enable the smart cat scratcher 100 to detect, identify, classify, and/or characterize cat interactions by analyzing image, video, and/or motion data captured by one or more cameras 920. In embodiments, the one or more cameras 920 may be mechanically coupled to a housing or structural component of the smart cat scratcher 100 and oriented such that the one or more cameras 920 capture a field of view encompassing the scratching surface 150 and surrounding interaction zone. The one or more cameras 920 may be configured to capture still images, continuous video, depth information, and/or motion vectors associated with interaction events occurring within the field of view.

In embodiments, image and/or video data captured by the one or more cameras 920 may be transmitted to an AI/ML inference engine 912 that may be implemented in the scratch controller 110 of the smart cat scratcher 100. In embodiments, the AI/ML inference engine 912 may be configured to execute one or more trained AI or ML models. The AI or ML models may include, without limitation, object-detection networks, pose-estimation networks, behavioral-recognition models, and/or convolutional neural networks (CNNs) configured to identify and classify cat-related activity. The one or more AI or ML models may be trained to detect the presence of a cat, recognize one or more individual cats based on biometric features (e.g., fur patterns, body shape, or facial structure), and/or identify specific behaviors, including, without limitation, scratching, pawing, swiping, tapping, leaning, exploratory behavior, and/or preparatory posturing. In embodiments, the use of AI/ML-based classification may allow the smart cat scratcher 100 to distinguish between different types of interactions and filter out non-relevant events, such as human contact, falling objects, environmental motion, etc.

In embodiments, the one or more AI or ML models implemented by the scratch controller 110 (e.g., via the AI/ML inference engine 912) may perform one or more detection and analysis operations that are integrated with, and/or complementary to, the functional components of the controller, including the interaction detector 220, the interaction analyzer 221, and/or the rewards controller 222. For example, the one or more AI or ML models may process captured image or video data to detect the presence of a cat within the field of view, identify the cat based on biometric features (e.g., fur patterns, size, facial structure, or body shape), and determine whether the detected motion corresponds to an interaction with the scratching surface 150. In embodiments, the outputs of the one or more AI or ML models may be used by the interaction detector 220 to determine whether an interaction event has occurred. In some embodiments, the interaction detector 220 may rely primarily on the classification output of the AI/ML model to make a detection determination, whereas in other embodiments, the interaction detector 220 may use AI/ML-generated detection results as one input among several sensing modalities.

In embodiments, once the interaction detector 220 determines that an interaction has occurred, the one or more AI or ML models may analyze the image and/or motion data to extract detailed information about the interaction. These analyses may include, without limitation, identifying the type of interaction (e.g., scratching, pawing, swiping, tapping, leaning, or exploratory motion), determining the direction and trajectory of the paw movement, measuring the duration of the interaction, classifying the intensity or energy of the movement, and/or inferring the behavioral context (e.g., playful scratching versus territorial marking). The results of these analyses may be provided to, or directly implemented by, the interaction analyzer 221. In some embodiments, the interaction analyzer 221 may be implemented in whole or in part by the AI/ML inference engine 912 via the one or more AI or ML models, which may perform feature extraction, motion analysis, and/or behavioral classification. In other embodiments, the AI/ML inference engine 912 and the interaction analyzer 221 may operate cooperatively, with the AI/ML inference engine 912 providing preliminary classification and feature data that are further processed by the interaction analyzer 221 according to predefined criteria and thresholds.

In embodiments, the behavioral classification data generated by the one or more AI or ML models of the AI/ML inference engine 912 and/or the interaction analyzer 221 may be used by the rewards controller 222 to determine whether a reward is to be dispensed. For example, in a no-protocol configuration, the rewards controller 222 may automatically trigger a reward when the one or more AI or ML models classify an interaction as scratching with a probability or confidence level that meets or exceeds a configured threshold. In an automated reward-protocol configuration, the rewards controller 222 may apply additional logic based on AI/ML-derived interaction characteristics, such as requiring that a minimum number of scratching strokes occur, that scratching persist for a minimum duration, or that a particular scratching direction or trajectory be detected. In some embodiments, the rewards controller 222 may rely directly on the decision output of the AI/ML inference engine 912. In other embodiments, the rewards controller 222 may integrate data generated by the AI/ML inference engine 912 with additional sensor inputs (e.g., from the one or more sensors 120, etc.) to make a final reward determination. If the configured criteria are met, the rewards controller 222 may transmit a control signal to the reward dispenser 115 to initiate the dispensing of a reward.

In embodiments, the integration of AI/ML functionality into the scratcher controller 110 may enable advanced interaction detection and behavioral analysis capabilities beyond those achievable with conventional sensing techniques. For example, the one or more AI or ML models of the AI/ML inference engine 912 may detect approach behaviors or pre-scratching gestures before physical contact occurs, may identify subtle changes in scratching style over time, and/or may recognize individual cats in a multi-cat environment and adjust reward protocols on a per-cat basis. The ability of the one or more AI or ML models of the AI/ML inference engine 912 to classify complex behaviors based on visual cues may significantly reduce false positives and improve detection reliability, even under variable environmental conditions (e.g., lighting changes, background motion, partial occlusions, etc.).

In embodiments, the AI/ML-based interaction detection system may operate in conjunction with other sensing modalities described herein, such as the one or more load cells 420, the one or more accelerometers 520, the one or more capacitive sensors 620, the optical emitter-receiver arrays 725/720, the acoustic sensor 1020, the vibration sensor 1120, etc. By correlating AI/ML-derived behavioral classifications with quantitative sensor data (e.g., force, vibration, capacitance, sound, interruption data, etc.), the scratch controller 110 may generate a multi-dimensional interaction profile that provides a more accurate representation of scratching behavior.

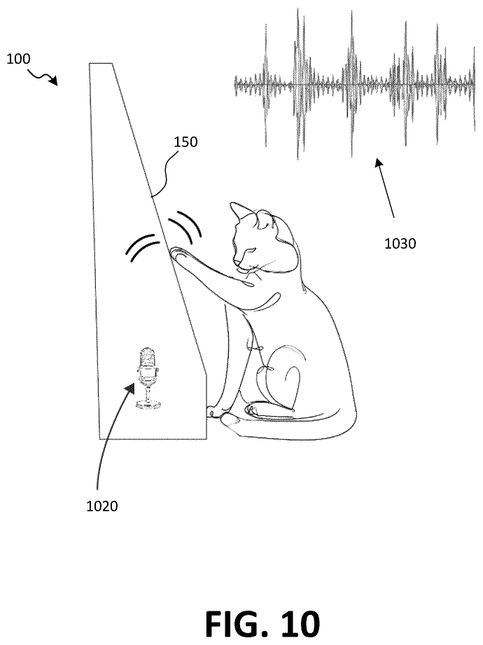

FIG. 10 illustrates an exemplary embodiment of a smart cat scratcher 100 configured with a sound-based interaction detection system in accordance with embodiments of the present disclosure. In embodiments, the sound-based interaction detection system may be configured to detect, identify, and/or characterize interactions between a cat and the scratching surface 150 by capturing, processing, and/or analyzing acoustic signals generated during scratching activity. In embodiments, one or more sound sensors 1020 (e.g., microphones, piezoelectric acoustic transducers, and/or other audio transducers) may be positioned within, on, or adjacent to the housing of the smart cat scratcher 100 and oriented to capture sound waves generated in connection with the scratching surface 150. The one or more sound sensors 1020 may be configured to convert detected sound waves into corresponding electrical signals that may be processed by the scratcher controller 110.

In embodiments, the sound waves generated by a cat interacting with the scratching surface 150 may include a wide range of acoustic characteristics, including, without limitation, variations in amplitude, frequency, duration, repetition, and/or waveform shape. The one or more sound sensors 1020 may be configured to capture these acoustic characteristics and generate corresponding audio signal data 1030 representative of the interaction. For example, in embodiments, the one or more sound sensors 1020 may include one or more microphones, microphone arrays, etc., configured to capture the acoustic characteristics of the interaction sound.

In embodiments, the audio signal data 1030 may be transmitted to the interaction detector 220, which may analyze the data to determine whether the detected acoustic activity corresponds to an interaction event. In embodiments, the audio signal data 1030 may be provided to the interaction analyzer 221, which may process and interpret the signal to determine one or more characteristics of the interaction, such as peak amplitude (e.g., correlating to scratching intensity), dominant frequency components (e.g., correlating to scratching speed or surface contact rate), signal duration (e.g., correlating to engagement time), and/or waveform periodicity (e.g., correlating to rhythmic behavior).

In embodiments, the scratcher controller 110 may be configured to apply pattern recognition algorithms, spectral analysis techniques, and/or AI/ML models to characterize the detected acoustic signal. For example, the scratcher controller 110 may compare the detected audio waveform to one or more predefined or dynamically generated audio templates stored in memory 112 to determine whether the signal corresponds to a rewardable interaction. These templates may represent known scratching patterns, such as continuous downward claw drags, rapid tapping sequences, and/or oscillatory pawing behaviors. In some embodiments, an AI/ML inference engine (e.g., AI/ML inference engine 912) may augment or implement the functionality of the interaction detector 220, the interaction analyzer 221, and/or the rewards controller 222 by classifying the nature of the detected sound event.

In embodiments, the rewards controller 222 may use the results of the audio analysis to determine whether a reward is to be dispensed. For example, the rewards controller 222 may require that the audio signal exceed a minimum amplitude threshold (e.g., indicating sufficient scratching force), match a predefined frequency signature or pattern (e.g., indicating a repetitive scratching behavior), and/or persist for a minimum duration (e.g., indicating sustained engagement). In embodiments, the rewards controller 222 may also incorporate contextual data derived from other sensing modalities, such as load cell data, accelerometer data, optical interruption data, vibration data, etc. to refine the decision-making. If the interaction meets the rewardable criteria based on the configured operational mode (e.g., no-protocol mode or automated reward protocol), the rewards controller 222 may generate a control signal to cause the reward dispenser 115 to dispense a reward.

In embodiments, the sound-based interaction detection system may include additional processing modules designed to improve detection accuracy and reduce false positives. For example, the one or more sound sensors 1020 may be configured with noise suppression and band-pass filtering circuitry to exclude ambient noise sources such as human speech, HVAC systems, incidental environmental sounds, etc. In embodiments, the scratcher controller 110 may apply signal segmentation and feature extraction techniques to isolate scratching-related acoustic events from background noise.

The sound-based detection approach may provide several technical advantages. For example, because acoustic detection is non-contact, the scratching surface 150 may be manufactured from a wide range of materials without affecting sensor performance. Additionally, sound sensing may enable detection of interactions that occur near, but not directly on, the scratching surface 150, such as preparatory motions, exploratory touches, subtle pre-scratching behaviors, etc. The sound-based detection approach may also enable the smart cat scratcher 100 to detect characteristic differences in scratching sounds produced by different cats, enabling individualized behavioral profiling and personalized reward schedules in multi-cat households.

In some embodiments, the sound-based interaction detection system may operate in conjunction with other sensing modalities described herein. For example, acoustic data indicating scratching intensity and rhythm may be correlated with load cell data indicating force, accelerometer data indicating motion dynamics, optical data indicating position, etc.

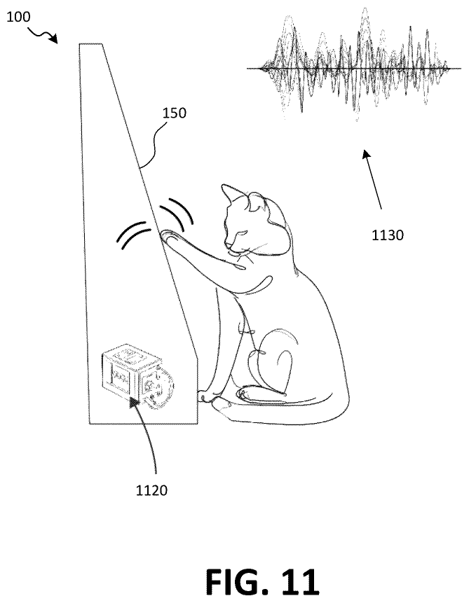

FIG. 11 illustrates an exemplary embodiment of a smart cat scratcher 100 configured with a vibration-based interaction detection system in accordance with embodiments of the present disclosure. In embodiments, the vibration-based interaction detection system may enable the smart cat scratcher 100 to detect, identify, and/or characterize interactions between a cat and the scratching surface 150 based on vibrational energy generated during such interactions. In embodiments, the smart cat scratcher 100 may include one or more vibration sensors 1120 configured to detect mechanical vibrations generated when a cat paws, scratches, drags, presses, and/or otherwise engages with the scratching surface 150. The one or more vibration sensors 1120 may be disposed on, within, beneath, or adjacent to the scratching surface 150, or at another location within the housing of the smart cat scratcher 100 that allows for effective detection of vibrational energy resulting from scratching activity. In embodiments, the one or more vibration sensors 1120 may be configured to convert the detected mechanical vibrations into one or more electrical signals that may be processed by the scratcher controller 110 or other processing circuitry.

In embodiments, the one or more vibration sensors 1120 may be configured to detect one or more vibration characteristics, including, without limitation, changes in vibration frequency, amplitude, waveform shape, phase, and/or temporal pattern caused by the interaction of a cat's paws with the scratching surface 150. For example, when the cat's claws strike, drag, or scrape across the scratching surface 150, the resulting mechanical energy may propagate through the scratching surface 150 as vibrational waves, which may then be sensed by the one or more vibration sensors 1120. The one or more vibration sensors 1120 may capture these vibrational signals 1130 and transmit the corresponding data to the interaction detector 220 of the scratcher controller 110. The interaction detector 220 may process the vibrational signal data 1130 to determine whether an interaction has occurred. In embodiments, the vibrational signal data 1130 may be provided to the interaction analyzer 221, which may analyze the vibrational signal data 1130 to determine one or more characteristics of the interaction, such as total vibrational energy, vibration amplitude envelope, spectral frequency distribution, and/or duration of the vibrational event.

In embodiments, the interaction analyzer 221 may use these vibration characteristics to differentiate scratching activity from other types of interactions, such as incidental contact, leaning, and/or environmental vibrations. For example, a high-amplitude, high-frequency vibration signal may correspond to vigorous scratching behavior, while a lower-amplitude, short-duration vibration may correspond to a brief touch or bump. The interaction analyzer 221 may correlate the detected vibration frequency with paw movement speed or repetition rate, and/or the duration of the vibrational event with the length of time the cat remains engaged with the scratching surface 150. These characteristics may be provided to the rewards controller 222, which may evaluate the interaction in view of the configured operational mode (e.g., no-protocol configuration or automated reward protocol) and determine whether the detected interaction meets one or more criteria for a rewardable interaction. If the criteria are satisfied, the rewards controller 222 may send a control signal to the reward dispenser 115 to initiate dispensing of a reward.

In embodiments, the one or more vibration sensors 1120 may include one or more signal-conditioning, amplification, or filtering modules to improve detection accuracy and reduce false positives. For example, the one or more vibration sensors 1120 may include low-pass or band-pass filters configured to eliminate background vibrational noise from environmental sources such as HVAC systems, nearby footsteps, or external impacts. In some embodiments, the scratcher controller 110 may use digital signal processing algorithms to extract distinctive vibration patterns and compare them against one or more stored vibration signatures corresponding to known scratching behaviors. By matching the detected vibration signature against these profiles, the scratcher controller 110 may increase detection reliability and more accurately classify interactions as scratching or non-scratching events.

In embodiments, vibration-based interaction detection may provide several advantages for the smart cat scratcher 100. Because vibration sensing does not require optical, acoustic, or visual input, the smart cat scratcher 100 may reliably detect interactions under a wide range of environmental conditions, including low-light or high-noise environments. Additionally, because the one or more vibration sensors 1120 do not require direct exposure to the cat or the surrounding environment, the sensors may be enclosed within the housing of the smart cat scratcher 100, which may enhance durability. The use of vibration sensing may also enable the detection of subtle, low-force interactions that may not generate significant sound or visible motion but nevertheless produce measurable vibrational energy.

In some embodiments, the vibration sensing configuration may be used in conjunction with other sensing modalities described herein. For example, vibrational data indicating the intensity or force of scratching behavior may be combined with optical sensor data indicating paw location or with sound sensor data indicating scratching frequency to generate a multi-dimensional interaction profile.

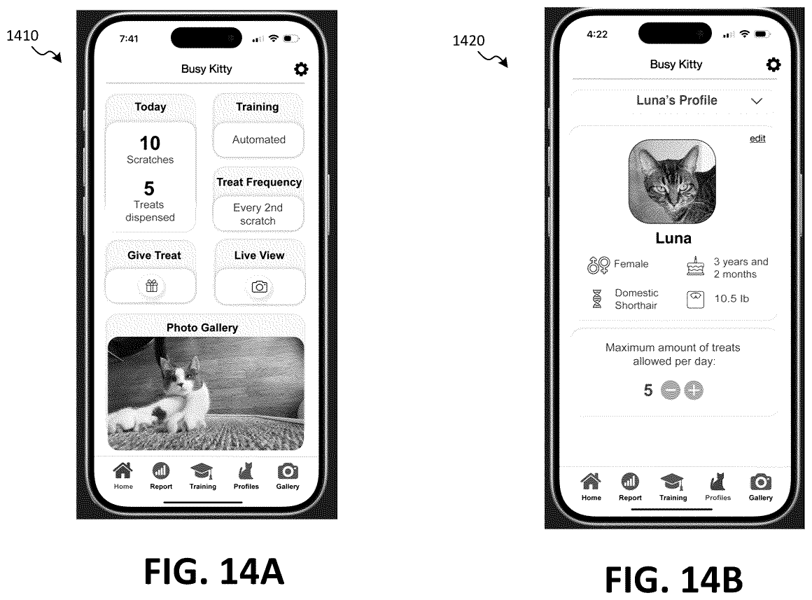

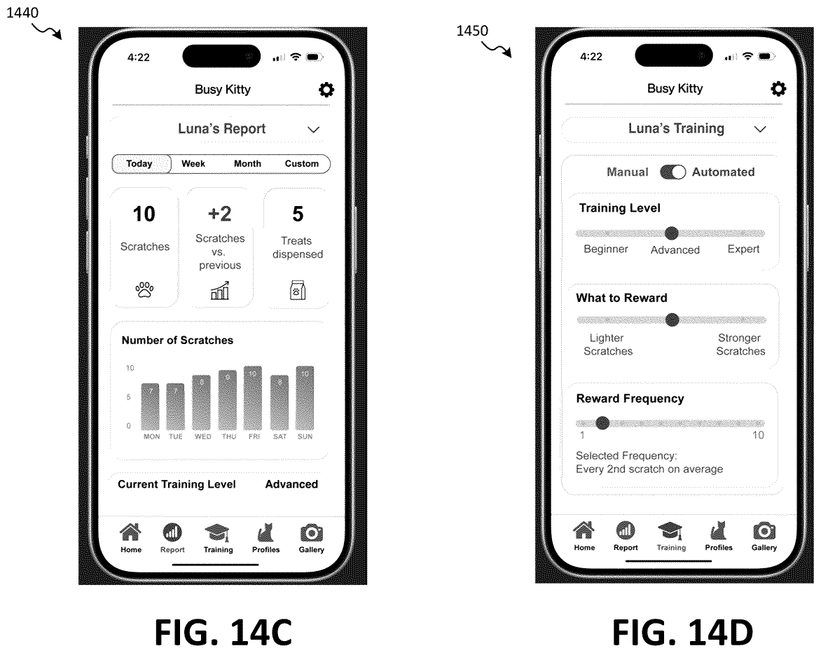

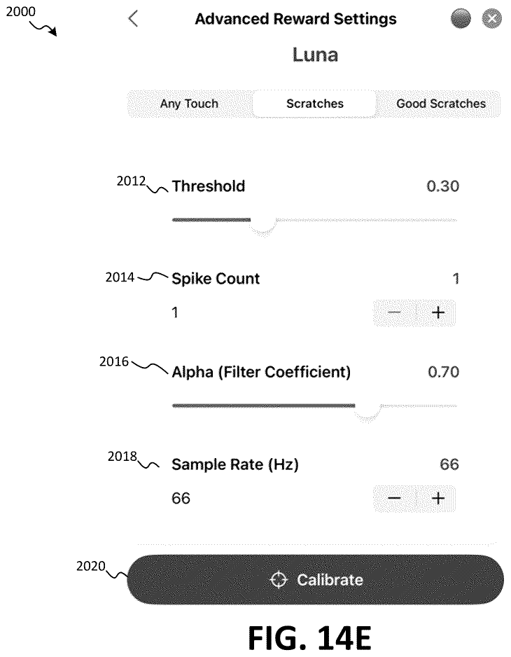

With reference back to FIG. 2, the application manager 228 may be configured to provide and manage the functionality of a connected app, which may be presented and accessible via the user terminal 130. In embodiments, the connected app may operate as an interface for the user to leverage and manage the functionality of the smart cat scratcher 100. Through the app, the user may specify various settings for the operation of the smart cat scratcher, and may view and receive various information regarding the operations of the smart cat scratcher 100 and/or progress of the cat(s). The functionality of the application manager 228 and the connected app will be discussed with further reference to FIGS. 14A-14D. FIGS. 14A-14D show various views of exemplary interface windows of a connected app illustrating the functionalities and settings available to the user for managing and accessing the functionality of the smart cat scratcher 100 in accordance with embodiments of the present disclosure.

As shown in FIGS. 14A-14D, the connected app may be configured to collect, track, manage, analyze, and/or display a wide range of information related to the operation and functionality of the smart cat scratcher 100. The application, which may be executed on a user terminal (e.g., user terminal 130), may be configured to communicate with one or more smart scratcher devices over a wired or wireless network and serves as the primary user interface for monitoring, configuring, and controlling the system.

In embodiments, the connected app may be configured to provide a user-friendly and visually intuitive interface that presents real-time data and historical information. The connected app may collect and store data from one or more sensors within the smart scratcher system, including information related to the frequency, duration, intensity, and/or quality of scratching events, as well as reward dispensing activity and engagement trends over time. This data may be processed and analyzed by the scratch controller 110 or a cloud-based analytics platform and presented to the user in a structured, graphical format.

In some embodiments, the connected app may provide configuration and control capabilities, allowing users to customize the configuration of the smart cat scratcher 100 directly from their user device. Through the connected app, users may be able to adjust reward protocols (e.g., automated, intermittent, or threshold-based), set treat frequency or maximum reward limits, modify detection sensitivity or threshold levels, etc. The connected app may enable users to define training levels, specify the quality of interactions that should trigger a reward, choose between different interaction detection modes, etc.

In embodiments, the connected app may support remote interaction and manual operation features. For example, users may be able to manually dispense a treat, initiate a live camera feed to observe their cat in real time, or review photos and videos captured by the system's camera. Historical data and reports may be available for review over various timeframes, such as daily, weekly, or monthly, allowing owners to track long-term behavioral patterns, measure training effectiveness, and/or compare current activity levels against previous periods.

In embodiments, the connected app may support multi-cat households by allowing the creation and management of individual profiles for each cat. These profiles may include details such as name, age, breed, weight, reward preferences, etc. and may help the system tailor training protocols and analytics to the specific needs of each cat. In embodiments, the connected app may be configured to provide recommendations or automated adjustments based on observed behavior.

FIG. 14A illustrates an exemplary graphical user interface (GUI) 1410 of the smart cat scratcher application in accordance with embodiments of the present disclosure. In embodiments, the GUI 1410 may function as a centralized dashboard that provides an overview of one or more cats' interactions with the smart cat scratcher 100 and provides the user a location to monitor behavioral data, configure operational parameters, and/or directly control functions of the smart cat scratcher. In embodiments, the GUI 1410 may be displayed on a user device such as a smartphone, tablet, or dedicated controller, and may be communicatively linked to the smart cat scratcher 100 through one or more wired or wireless communication protocols (e.g., Wi-Fi, Bluetooth, or cellular). In embodiments, the GUI 1410 may provide both real-time data and historical summaries in an intuitive, organized layout, allowing the user to quickly assess system activity, understand the cat's behavioral trends, and make adjustments to reward protocols or training parameters as needed.

In embodiments, the GUI 1410 may include an activity summary section configured to display data associated with the cat's interactions for a defined period of time, such as the current day. For example, the GUI 1410 may indicate that ten (10) interactions have been detected by the interaction detector 220 and that five (5) rewards have been dispensed by the reward dispenser 115 during the same period. The activity summary may be updated in real time as new interactions are detected, allowing the user to monitor the cat's engagement level throughout the day. In some embodiments, the reporting window may be configurable by the user (e.g., to display data for the past hour, day, week, or month), providing flexible tracking and analysis of behavioral progress over time.

In embodiments, the GUI 1410 may provide information about the training protocol currently configured for the smart cat scratcher 100. This portion of the interface may indicate the operational mode (e.g., automated reward protocol, continuous reward protocol, intermittent reward protocol, threshold-based protocol, or no-protocol mode) and may provide a contextual summary of how interactions are being processed by the rewards controller 222. For example, the GUI 1410 may display that the device is operating under an automated reward protocol with an intermittent schedule in which treats are dispensed for every second scratch.

In embodiments, the GUI 1410 may include a treat frequency configuration panel that enables the user to define how often rewards are dispensed relative to detected rewardable interactions. The user may configure the system to dispense a treat for every interaction, every second interaction, every third interaction, or according to a randomized schedule. In some embodiments, the treat frequency configuration may also include advanced options, such as limiting treats based on daily maximum thresholds, time-of-day restrictions, or behavioral metrics (e.g., only rewarding interactions above a certain intensity).

In embodiments, the GUI 1410 may include one or more user-interactive controls that enable direct manual operation of the smart cat scratcher 100. For example, a “Give Treat” button may allow the user to manually trigger the reward dispenser 115 to deliver a treat independently of any detected interaction. This manual control may be useful for reinforcing desirable behaviors in real time, introducing the cat to the device, or building a positive association between the cat and the smart cat scratcher 100. In embodiments, the GUI 1410 may also include a “Live View” button that, when activated, initiates a real-time video feed from an onboard or network-connected camera (e.g., the camera 920 described above). This functionality may allow the user to observe the cat's behavior remotely, verify system operation, and/or monitor the cat's engagement with the scratching surface 150 even when not physically present.

In embodiments, the GUI 1410 may also include a photo gallery or media viewer component. This component may display a thumbnail image of the most recent interaction captured by the camera and provide options to browse through previous images or video clips associated with historical interactions. In some embodiments, the gallery may allow the user to review chronological records of interactions, view behavioral patterns over time, and/or capture notable events for sharing or analysis. Additionally, the photo gallery may be integrated with the live view feature, allowing the user to switch between historical media and real-time observation.

It is noted that the dashboard design of the GUI 1410 may provide several technical advantages. For example, by consolidating real-time behavioral metrics, training configuration information, treat frequency controls, manual override options, live monitoring capabilities, and media review tools into a single interface, the GUI 1410 may provide an improved GUI that enables the user to actively manage and personalize the training process. This level of interactivity may enhance the effectiveness of the reward protocols, support adaptive behavioral modification strategies, and improve the overall engagement experience for both the cat and the owner, as well as reassuring that the cat is engaging with the device.

FIG. 14B illustrates an exemplary graphical user interface (GUI) 1420 of the smart cat scratcher application in accordance with embodiments of the present disclosure. In embodiments, the GUI 1420 may be configured to display, manage, and customize information associated with an individual cat's profile, allowing the smart cat scratcher to tailor operations, reward scheduling, and behavioral analysis according to the specific characteristics, needs, and preferences of the particular cat.

In embodiments, the GUI 1420 may include a profile display section that presents identifying information about the individual cat being monitored. This section may include, without limitation, the cat's name, sex, breed, age, and weight, as well as any additional data fields that may be relevant to behavioral tracking or training optimization. The user may input this information during initial setup or edit and update it over time as the cat's characteristics evolve. Presenting this identifying data directly within the user interface may provide contextual insights that can inform training decisions. For example, in embodiments, the cat's age may influence reward frequency and session duration, the weight may inform treat portion control or caloric management, and the breed may help predict scratching intensity, frequency, or preferred scratching styles, all of which may be used by the scratch controller 110 and its associated subsystems (e.g., the interaction detector 220, interaction analyzer 221, and rewards controller 222) to dynamically adjust operation.

In some embodiments, the profile section may also include a profile image of the cat to serve as a visual reference within the application. The inclusion of a profile image may be particularly useful in environments with multiple cats, as it allows the user to quickly confirm which cat's data is being displayed or configured. When multiple cat profiles are present, the application may provide a drop-down selector or swipe-based interface for switching between profiles. In some embodiments, the system may further automate this process by associating interaction data with the correct profile using AI-driven identification techniques, such as image-based recognition from the one or more cameras 920 or motion signature matching based on unique behavioral patterns detected by the interaction analyzer 221.

In embodiments, the GUI 1420 may further include one or more controls for defining individualized reward and treat dispensing parameters for the cat. For example, the GUI 1420 may include a user-selectable setting that allows the owner to specify the maximum number of treats the cat may receive during a given time period, such as per day, per training session, or per week. Once the specified limit is reached, the rewards controller 222 may automatically suspend treat dispensing until the next reset interval while continuing to detect and record behavioral data for analysis. Such functionality may be used to manage caloric intake, ensure dietary compliance, and maintain a healthy weight for the cat while still utilizing treats as positive reinforcement.

In some embodiments, the profile configuration interface may extend beyond treat limits to include other individualized parameters and behavioral constraints. For example, the user may specify preferred treat types (e.g., standard kibble, soft treats, catnip, veterinary-prescribed snacks, etc.), may define time-of-day reward windows, may set customized detection thresholds that adjust the sensitivity of the sensors (e.g., vibration sensors 1120, sound sensors 1020, or light arrays 820) based on the cat's physical characteristics or scratching style, etc.

In embodiments, the GUI 1420 may display a summary of historical interaction data associated with the selected profile. This summary may include metrics such as the total number of scratching events recorded, the total number of treats dispensed, the average daily engagement rate, or time-based trends showing changes in scratching behavior over weeks or months.

FIG. 14C illustrates an exemplary graphical user interface (GUI) 1440 of the smart cat scratcher application in accordance with embodiments of the present disclosure. In embodiments, the GUI 1440 may be configured to provide a reporting and analytics view configured to present detailed behavioral data, historical activity metrics, training progress indicators associated with one or more cats interacting with the smart cat scratcher 100, etc. In embodiments, the reporting functionality provided through the GUI 1440 may enable users to review and interpret behavioral data over various time intervals, assess the effectiveness of configured training protocols, make informed decisions about how to adjust reward strategies, treat dispensing schedules, or sensor sensitivity parameters based on observed trends, among others. In embodiments, the GUI 1440 may display the information either by individual cat, by all cats in the home, or by smart scratcher device, or by other data layouts.

In embodiments, the GUI 1440 may include a time period selection interface that allows the user to view reward dispensing activity and scratching activity data over selectable time intervals, including, without limitation, daily, weekly, monthly, or user-defined custom date ranges. This configurability may enable the user to focus on recent activity trends (e.g., the number of scratches recorded in the past 24 hours) or to evaluate longer-term behavioral patterns (e.g., changes in engagement frequency over several months). Once a time period is selected, the GUI 1440 may dynamically update the displayed metrics and visualizations to reflect data corresponding to the chosen interval.

In embodiments, the primary metrics section of the GUI 1440 may present one or more key performance indicators (KPIs) summarizing scratching activity and reward events for the selected period. These KPIs may include, without limitation, the total number of scratching interactions detected by the system, the total number of treats dispensed in response to rewardable interactions, and a comparison metric indicating the difference in scratching activity relative to a previous equivalent time period. For example, the GUI 1440 may display that the cat performed 10 scratching interactions during the current day, representing a +2 increase compared to the previous day, and that a total of 5 treats were dispensed in that time. This comparative data may enable users to quickly identify positive behavioral trends (e.g., increased interaction with the scratching surface 150) or to recognize potential issues (e.g., a decline in scratching activity that may indicate reduced engagement or a health-related change).

In some embodiments, the GUI 1440 may include a visual data representation module that displays behavioral data graphically. This visualization may take the form of a bar chart, histogram, line graph, scatter plot, or timeline, and may illustrate one or more behavioral metrics (e.g., such as the number of scratching events, the number of treats dispensed, or the ratio of rewardable to non-rewardable interactions) across discrete time intervals within the selected reporting period. For example, a weekly view may display a bar chart showing daily scratching counts from Monday through Sunday, while a monthly view may aggregate data into weekly totals. In some embodiments, trend lines, moving averages, or behavioral baselines may be overlaid on the chart to assist in interpreting long-term patterns and evaluating training efficacy.

In embodiments, the GUI 1440 may present a training level indicator or behavioral progress gauge that reflects the cat's current stage within a defined training protocol. This indicator may be determined by the scratch controller 110 and its associated subsystems (e.g., the interaction detector 220, interaction analyzer 221, and rewards controller 222) based on behavioral metrics such as scratching frequency, interaction consistency, reward response patterns, and/or longitudinal engagement data. For example, the GUI 1440 may display that the cat is currently operating within an “Advanced” training level, indicating that the cat has consistently met or exceeded target interaction thresholds and may be ready for more complex reinforcement schedules (e.g., variable-ratio or variable-interval reward protocols).

In some embodiments, the GUI 1440 may provide contextual insights, recommendations, and milestone notifications based on the analyzed data. For example, the GUI 1440 may provide suggestions such as “Consider increasing reward frequency to maintain engagement” or “Activity decreased by 25% compared to last month, check for changes in environment or scratching surface condition.” Additionally, the GUI 1440 may highlight notable achievements, such as “100 total scratches reached” or “First week of daily interaction achieved,” which may serve as motivational feedback for both the cat and the owner.

In embodiments, the reporting functionality presented through the GUI 1440 may support aggregation of behavioral data across multiple networked smart cat scratcher devices deployed within a single environment or across multiple locations. For example, when two or more smart cat scratchers 100 are communicatively coupled through a local network or cloud-based infrastructure, the scratch controller 110 of each smart cat scratcher may transmit interaction data, sensor outputs, reward event records, etc. to a centralized data management module within the smart scratcher application. The aggregated data may then be compiled and presented as a unified activity report within the GUI 1440, allowing the user to view combined scratching metrics, reward statistics, and behavioral trends across all connected smart cat scratchers. This feature may be particularly advantageous in multi-cat households or multi-room environments where cats may interact with different scratchers at different times.

FIG. 14D illustrates an exemplary graphical user interface (GUI) 1450 of the smart scratcher application in accordance with embodiments of the present disclosure. In embodiments, the GUI 1450 may be configured to allow the user to define, customize, and manage the training protocol for one or more cats.

In embodiments, the GUI 1450 may include a configuration control for enabling or disabling an automated training mode. When the automated training mode is active, the scratch controller 110, in combination with the interaction detector 220, the interaction analyzer 221, and the rewards controller 222, may dynamically adjust the training parameters based on real-time behavioral data collected from the cat's interactions with the scratching surface 150. For example, the smart cat scratcher 100 may automatically transition from a beginner-level reinforcement schedule, in which every scratching interaction may result in a reward, to a more advanced schedule that may use intermittent or threshold-based reinforcement once the system determines that the cat's engagement meets a certain threshold of consistency. In some embodiments, when automation is disabled, the GUI 1450 may provide manual configuration options for users who prefer to directly manage every aspect of the training process.

In some embodiments, the GUI 1450 may allow the user to specify the current training level associated with the cat. The training level may correspond to predefined reinforcement stages, ranging from introductory protocols (e.g., rewarding every detected scratch) to intermediate or advanced protocols (e.g., rewarding only certain types of scratching events or applying variable or intermittent reinforcement schedules). Adjusting the training level may allow the user to align the training program with the cat's current stage of learning and to gradually increase the behavioral expectations over time.

The GUI 1450 may also include controls for configuring the quality level or intensity of scratching behavior that qualifies for a reward. In embodiments, the user may define reward criteria based on one or more measurable parameters, such as scratching force, duration, frequency, or motion profile. For example, the system may be configured to reward only scratching events that exceed a predefined force threshold, last beyond a set duration (e.g., two or five seconds), or exhibit rhythmic scratching patterns indicative of active engagement.

In embodiments, the GUI 1450 may enable users to set reward frequency parameters. In embodiments, the user may choose from several reinforcement options, including rewarding every scratching event, rewarding every second, third, fourth, fifth, sixth, eighth, ninth, tenth, etc. (up to fiftieth in some embodiments) event, rewarding every second, third, etc. event on average, or using a custom numerical ratio and/or interval. The GUI 1450 may support intermittent or randomized schedules, in which treats are dispensed unpredictably within a defined range (e.g., every 2-5 scratching events), or in solving for an average number of events where the reward is dispensed unpredictably (e.g., every fifth event on average).

In some embodiments, the GUI 1450 may include advanced configuration options, recommendations, and/or adaptive suggestions generated by the smart cat scratcher. For example, the scratch controller 110 may recommend increasing the reward threshold if the cat is consistently achieving reinforcement with minimal effort, or it may suggest switching to an intermittent schedule once the system detects a stable scratching pattern.

FIG. 14E shows an exemplary GUI 2000 of the connected application configured to enable a user to configure advanced interaction detection parameters and reward-related sensitivity settings for a selected cat profile in accordance with embodiments of the present disclosure. In embodiments, the GUI 2000 may be provided by the application manager (e.g., application manager 228) and presented via a user terminal (e.g., user terminal 130), and may be configured to communicate configuration data to a scratcher controller (e.g., scratcher controller 110) for use in detecting, classifying, and rewarding interactions with the smart cat scratcher (e.g., smart cat scratcher 100).

In embodiments, the GUI 2000 may include a category selector configured to allow the user to tune detection parameters for different interaction classifications, such as “Any Touch,” “Scratches,” and “Good Scratches.” In these embodiments, selection of a category may enable the user to define different sensitivity profiles for different interaction types, such that a first set of parameters is used for detecting any contact or proximity-based interaction, a second set of parameters is used for detecting scratching interactions, and a third set of parameters is used for detecting higher-quality scratching interactions (e.g., interactions meeting a rewardable threshold based on intensity, pattern, duration, stroke count, and/or other characteristics). In embodiments, these category-specific settings may be stored per cat profile and applied by the scratcher controller during reward criteria determinations and rewardable event classification.

In embodiments, the GUI 2000 may include one or more user-adjustable parameters configured to control how accelerometer data, vibration data, and/or motion-profile data are processed by one or more of the sensors (e.g., accelerometers, capacitive sensors, load cells, vibration sensors, optical emitters and receivers, acoustic transducers, imaging systems, etc.) to determine whether a detected interaction qualifies as a scratch and or a rewardable scratch. For example, a threshold parameter 2012 may be adjusted (e.g., via a control element such as a slider) to define a minimum motion magnitude, acceleration magnitude, and/or other signal level required to classify an event as a qualifying interaction for the selected category. A spike count parameter 2014 may be adjusted (e.g., via a control element such as increment and decrement controls) to define a minimum number of signal excursions, motion spikes, oscillatory cycles, and/or detected strokes required to classify a scratch event as occurring. In embodiments, an alpha parameter 2016 may be adjusted to control one or more filtering operations (e.g., smoothing, low-pass filtering, exponential moving average filtering, and/or other signal conditioning) applied to sensor data to reduce false positives and improve classification. In embodiments, a sample rate parameter 2018 may be adjusted to define a sampling frequency at which sensor data is processed (and/or acquired) by the scratcher controller when detecting and analyzing an interaction. In embodiments, the adjustment of these parameters may allow users to “dial in” or calibrate sensitivity for a particular cat, scratching style, environment, etc., such that light incidental contact can be separated from deliberate scratching behavior, and such that “good scratches” can be distinguished from weaker scratches based on configured thresholds and signal patterns.

In embodiments, the GUI 2000 may include a calibrate control 2020 configured to cause the system to configure and/or reconfigure one or more sensor setting (e.g., accelerometer-related settings) based on the user-selected parameters in the GUI 2000. In embodiments, the user may first adjust one or more parameters (such as the threshold value, the spike count value, the alpha (filter coefficient) value, and/or the sample rate value), and may then actuate the calibration control 2020 to apply the selected parameters as an active accelerometer configuration for use in subsequent interaction detection and classification operations. In embodiments, activation of the calibration control 2020 may transmit, write, store, and/or otherwise persist the selected parameters to an accelerometer configuration data structure, and may cause the scratcher controller to program the accelerometer and/or an associated signal-processing pipeline in accordance with the selected parameters. For example, in embodiments, actuation of the calibration control 2020 may configure the accelerometer sampling frequency to match the selected sample rate, may configure one or more filtering operations (for example, exponential smoothing and or low-pass filtering) according to the selected alpha value, and/or may configure one or more detection criteria, thresholds, and or count-based requirements (for example, a minimum motion threshold and a minimum spike count) for classifying accelerometer output data as an interaction event for a selected category (for example, Any Touch, Scratches, or Good Scratches). In embodiments, calibrate control 2020 may operate to calibrate the smart scratcher (e.g., the smart scratcher 100) to a baseline, in which case the user may actuate the calibrate control 2020 when the scratcher is positioned in a desired location and is unengaged (e.g., is not being interacted with) to get a baseline of the smart scratcher. The user may perform such calibration before any parameters are dialed in, to set the device to baseline and ready it for the subsequent parameter adjustments. In embodiments, the advanced settings may include functionality for the user to calibrate or reset other settings (not explicitly shown), such as the ability to manually reset the smart scratcher's reward count (e.g., including treat count) to zero for a chosen time period (e.g., for the current day).

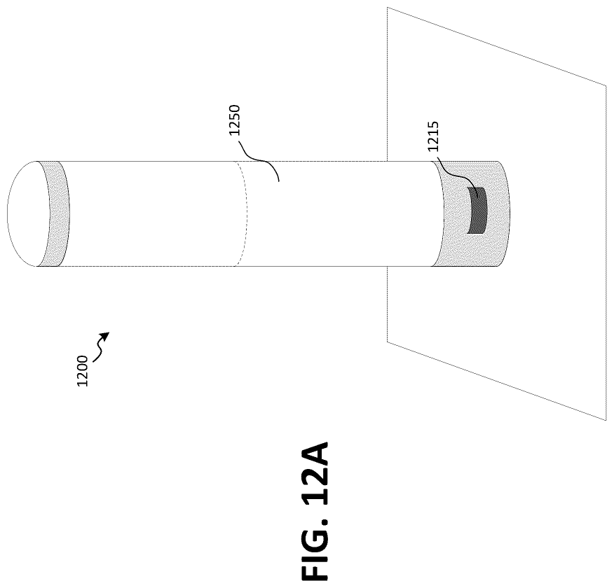

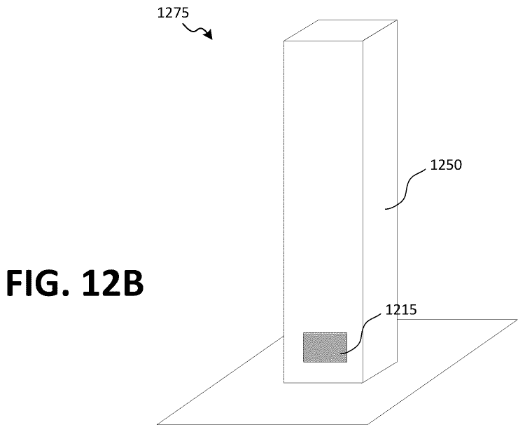

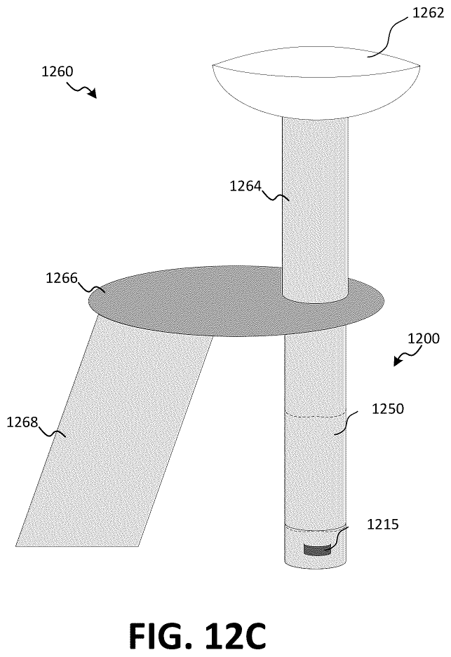

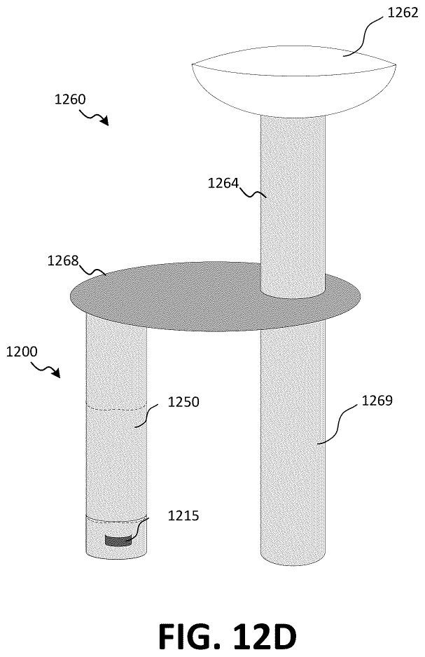

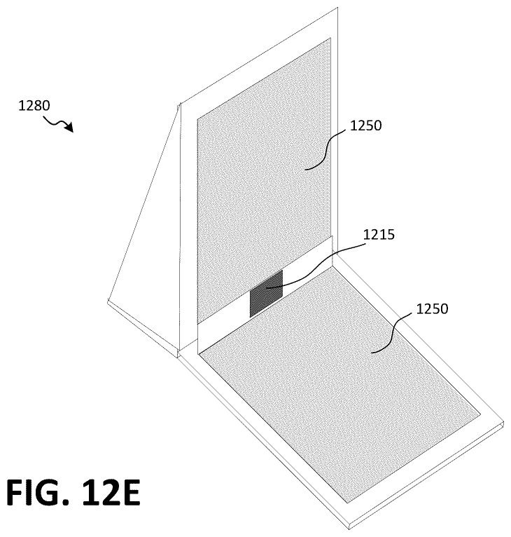

FIGS. 12A-12C illustrate various exemplary embodiments of a modular smart cat scratcher system in accordance with embodiments of the present disclosure. In embodiments, the modular smart scratcher system may be configured to include a plurality of interoperable, interchangeable, and reconfigurable components that may be selectively combined, arranged, configured, and/or assembled to create customized environments and multifunctional playground structures for one or more cats.

In embodiments, the modular system may include individual smart scratcher units, each incorporating one or more of the sensing, detection, analysis, and/or reward-dispensing technologies described herein (e.g., accelerometer-based detection, capacitive sensing, emitter/receiver interruption, AI-based motion analysis, or vibration detection). These units may be operable as standalone devices or may be configured to communicate and interoperate with one another as part of an integrated multi-module network. In some implementations, multiple smart scratcher modules may share data, synchronize behavioral tracking, and coordinate reward dispensing based on aggregated interaction data.

The modular approach may allow the smart scratcher system to be assembled and configured into a variety of layouts and configurations. For example, in embodiments, multiple vertical scratcher modules may be arranged in series to encourage climbing and vertical scratching behaviors, or a horizontal scratching module may be combined with ramps, tunnels, lounging platforms, etc. to promote exploratory play and physical activity. In other embodiments, a scratching module may be positioned adjacent to a feeding station or reward dispenser to create a combined enrichment and reward zone, or multiple sensor-equipped modules may be distributed throughout a room to form an interactive training course that encourages movement and exploration.

In embodiments, the modular functionality of the system may provide significant flexibility and scalability over time. Individual components may be added, removed, replaced, or upgraded without requiring changes to the overall system architecture. This may allow the system to be adapted to a cat's behavior, age, physical abilities, etc., or to be expanded to accommodate additional cats. For example, new sensor modules, reward units, or interactive accessories may be introduced into the system to increase complexity and engagement.

In embodiments, the modular design may also allow aesthetic customization and integration into a variety of home environments. Components may be offered in different sizes, materials, textures, and finishes to complement existing furniture or decor, while still providing the functional benefits of automatic interaction detection and behavioral reinforcement.

The following sections describe exemplary configurations of the modular smart scratcher system as illustrated in FIGS. 12A-12C, each demonstrating how different combinations of components, layouts, and sensor modalities may be implemented to create unique and engaging scratching environments. These examples are intended to be illustrative and non-limiting, and in embodiments, a wide range of alternative configurations, component types, and functional integrations may be employed without departing from the scope of the present disclosure.

FIG. 12A illustrates an exemplary embodiment of a smart cat scratcher 1200 implemented as a vertically oriented cylindrical post in accordance with embodiments of the present disclosure. In embodiments, the smart scratcher 1200 may be configured with functionality similar to the functionality of smart cat scratcher 100 as illustrated in FIG. 1. In embodiments, the smart scratcher 1200 may be configured as a standalone enrichment and behavioral training device or as one module within a larger modular smart scratcher system. In embodiments, the cylindrical configuration may provide a natural and instinctively appealing scratching structure for cats, as its shape, orientation, and tactile feedback may mimic that of tree trunks or other vertical objects cats encounter and scratch in natural environments. The vertical and rounded geometry may further encourage stretching, climbing, and gripping behaviors.

In embodiments, the smart scratcher 1200 may include a scratching surface 1250 disposed circumferentially around the exterior of the cylindrical body, and with similar functionality as scratching surface 150 as illustrated in FIG. 1. In embodiments, the scratching surface 1250 may be formed from one or more materials suitable for feline scratching, including, without limitation, sisal fiber, woven fabric, carpet, corrugated cardboard, composite textured surfaces, etc. In some embodiments, the scratching surface 1250 may be removably attached or replaceable, enabling the user to easily replace worn sections or customize the scratching texture, pattern, or color to meet individual feline preferences or to align with specific training objectives. The continuous cylindrical arrangement of the scratching surface 1250 may allow cats to engage with the device from any angle, supporting a variety of scratching styles, including vertical scratching, hugging, climbing, and rotational scratching behaviors.

In embodiments, the smart scratcher 1200 may further include a reward dispenser 1215 integrated into the cylindrical structure. The reward dispenser 1215 may be configured with functionality similar to the functionality of reward dispenser 115 as illustrated in FIG. 1, and may be operatively coupled to the scratch controller 110 and configured to selectively dispense treats, kibble, or other types of rewards in response to detected interactions. In embodiments, one or more sensors (e.g., one or more sensors 120) may be integrated within the smart scratcher 1200 and may be configured to detect an interaction (e.g., scratching activity) based on various detection modalities described herein (such as vibration sensing, load measurement, or accelerometer-based motion detection), and the scratch controller 110 may determine, based on interaction data and reward protocol parameters, whether the scratching event qualifies as a rewardable interaction. The reward dispenser 1215 may dispense rewards according to user-defined settings (e.g., continuously every scratching event, or intermittently predictably every second scratching event, or intermittently unpredictably every second scratching event on average) or according to an automated reward protocol managed by the scratch controller 110.

In some embodiments, the smart scratcher 1200 may include one or more sensors beneath or within the scratching surface 1250 to detect and analyze interaction data. These sensors may capture a range of interaction characteristics, including interaction intensity, duration, frequency, direction of motion, pattern etc. The sensor data may be processed by the interaction detector 220, characterized by the interaction analyzer 221, and used by the rewards controller 222 to determine whether a reward should be dispensed. Additionally, the data may be used to monitor behavioral trends over time, evaluate training progress, and refine reward strategies automatically.

The cylindrical design of the smart scratcher 1200 may provide multiple functional advantages. For example, the 360-degree accessible scratching surface may accommodate simultaneous use by multiple cats, while the vertical orientation may encourage stretching and muscle engagement. The rounded geometry may also promote more dynamic and full-body interactions, such as climbing or gripping, which may enhance both physical stimulation and environmental enrichment. Furthermore, the aesthetically minimal and furniture-like design of the cylindrical structure may allow the device to integrate seamlessly into domestic environments without detracting from home decor.

In embodiments, the cylindrical smart scratcher 1200 may function as a standalone unit or as part of a larger modular system. For example, it may be combined with ramps, platforms, tunnels, or other modular accessories to create multi-level structures or training stations in a twist and snap attachment system. This modular expandability may allow the device to evolve alongside the cat's behavioral development and changing enrichment needs.

FIG. 12B illustrates another exemplary embodiment of a smart cat scratcher 1275 implemented as a generally vertically oriented rectangular post in accordance with embodiments of the present disclosure. In embodiments, the smart scratcher 1275 may share many of the functional features and operational capabilities described above with respect to the cylindrical smart scratcher 1200 of FIG. 12A, including, without limitation, an interactive scratching surface 1250 configured to receive and withstand repeated feline scratching activity, an integrated reward dispenser 1215 operatively coupled to the scratch controller 110, and one or more sensors configured to detect, analyze, and/or characterize scratching interactions. However, the smart scratcher 1275 of FIG. 12B is implemented with a rectangular or polygonal cross-sectional geometry.

In embodiments, the smart scratcher 1275 may include a scratching surface 1250 disposed along one or more faces of the rectangular post. In some embodiments, the rectangular geometry may enable the scratching surface 1250 to be segmented into multiple zones with different textures or materials on different faces, allowing for varied tactile feedback and promoting more diverse scratching behaviors. This multi-surface approach may encourage exploratory engagement, as cats may rotate around the post to scratch on different faces or experiment with different surfaces based on preference or behavioral cues.

In embodiments, one advantage of the rectangular configuration of the smart scratcher 1275 is that it may provide increased surface area on each face. This may allow for the integration of additional sensor arrays, such as distributed load cells, capacitive panels, optical interruption grids, etc. on one or more faces to capture a richer and more spatially resolved dataset regarding scratching behavior. Additionally, the flat planar surfaces of the rectangular configuration may facilitate the inclusion of secondary enrichment features, such as attachable toys, climbing platforms, embedded visual indicators (e.g., LED progress lights or activity indicators), etc. that respond dynamically to scratching activity. It is noted that any of the smart scratcher configurations described herein may include these additional (e.g., non-food) interactive rewards/engagement features.

FIG. 12C illustrates another exemplary embodiment of a modular smart cat scratcher system 1260 configured as an interactive playground environment in accordance with embodiments of the present disclosure. In embodiments, the modular system 1260 may include a plurality of distinct structural and functional components, including a smart scratching post 1200 configured with intelligent sensing and reward functionalities as described above with reference to FIG. 12A. By combining multiple complementary elements into a single structure, the system 1260 may transform the smart scratching post into a multi-functional activity center that supports a wide range of feline behaviors, including scratching, climbing, perching, lounging, and exploration.

In embodiments, the modular playground 1260 may include a lounge bowl 1262 disposed at or near the upper end of a vertical support column 1264. In embodiments, the lounge bowl 1262 may be configured as a concave resting platform or bed designed to provide a comfortable elevated resting space for a cat after a play or scratching session. The elevated positioning of the lounge bowl 1262 may appeal to cats' natural preference for high vantage points. The support column 1264 may itself function as a secondary scratching post, optionally wrapped in a textured material to provide additional scratching surfaces and behavioral enrichment opportunities.

In embodiments, the modular playground 1260 may include an intermediate platform or surface 1266 extending laterally from the structure. The surface 1266 may serve as a transition point between different vertical levels, allowing cats to jump, climb, or stretch between the base level and the elevated lounge bowl 1262. The intermediate surface 1266 may also function as a play or observation platform, encouraging active exploration and varied physical movement patterns. Additionally, the platform 1266 may serve as a mounting or attachment point for additional accessories, such as hanging toys, feeders, and/or secondary scratching panels.

In embodiments, a ramp 1268 may extend from the intermediate surface 1266 to the ground or base level, providing an inclined access path for cats of varying ages, sizes, and mobility levels. The ramp 1268 may encourage climbing and exploration behaviors while also supporting senior cats, kittens, or cats with limited mobility who may have difficulty jumping directly to elevated platforms. In some embodiments, the ramp 1268 may be textured or covered with a scratching material.

In embodiments, the modular playground 1260 may include the smart scratching post 1200 described above, including a scratching surface 1250 and a reward dispenser 1215. The smart scratching post 1200 may operate with the same sensor-based detection, interaction analysis, and reward-dispensing functionality previously described, including capabilities such as detecting scratching interactions, classifying behavioral characteristics, and dispensing treats based on configurable training protocols.

FIG. 12D illustrates another exemplary embodiment of the modular smart cat scratcher system 1260 configured as an interactive playground environment in accordance with embodiments of the present disclosure. In the example illustrated in FIG. 12D, the ramp 1268 is removed, and the smart scratching post 1200 is moved to function as a support post to the surface 1266. A new support column 1269 is added to provide support to the smart cat scratcher system 1260.

FIG. 12E illustrates another exemplary embodiment of a modular smart cat scratcher 1280 in accordance with embodiments of the present disclosure. In embodiments, the smart scratcher 1280 may include functional components and capabilities similar to the functional components and capabilities described herein with respect to the smart scratcher 100, including one or more scratching surfaces 1250, one or more sensors configured to detect scratching interactions, and a reward dispenser 1215 configured to dispense treats, kibble, or other rewards in response to detected rewardable interactions. In the embodiment illustrated in FIG. 12E, the smart cat scratcher 1280 includes a dual-surface configuration and foldable L-shaped form factor, which may provide additional behavioral engagement options and improved flexibility in installation and storage.

In embodiments, the smart scratcher 1280 may include a first scratching surface 1250 disposed in a generally vertical orientation and a second scratching surface 1250 disposed in a generally horizontal orientation. These two surfaces may meet at an angle to form an L-shaped cradle-like structure that supports a range of natural scratching behaviors. The vertical surface may support traditional upright scratching motions and stretching behaviors, while the horizontal surface may support pawing, digging, and other ground-level interaction patterns. The presence of two scratching surfaces 1250 may allow a cat to engage in multiple scratching positions without requiring multiple devices, thereby enhancing enrichment and promoting varied muscle use and activity.

In some embodiments, the smart scratcher 1280 may be configured to transition between a deployed position and a folded storage position. In the deployed position, the vertical and horizontal surfaces may form a stable, angled structure that invites active engagement and scratching from different approaches. In the folded position, the two surfaces may collapse together into a more compact form, which may facilitate convenient storage or transport when the device is not in use. This folding capability may also allow owners to reposition or relocate the scratcher easily within the home environment.

The reward dispenser 1215 may be disposed near the junction of the two scratching surfaces 1250, positioning the reward dispenser 1215 to dispense rewards in a location that reinforces both vertical and horizontal scratching behaviors. In some embodiments, sensors may be embedded within or beneath either or both surfaces to detect interactions, allowing the scratch controller 110, interaction detector 220, interaction analyzer 221, and rewards controller 222 to operate as described herein with respect to the smart cat scratcher 100.

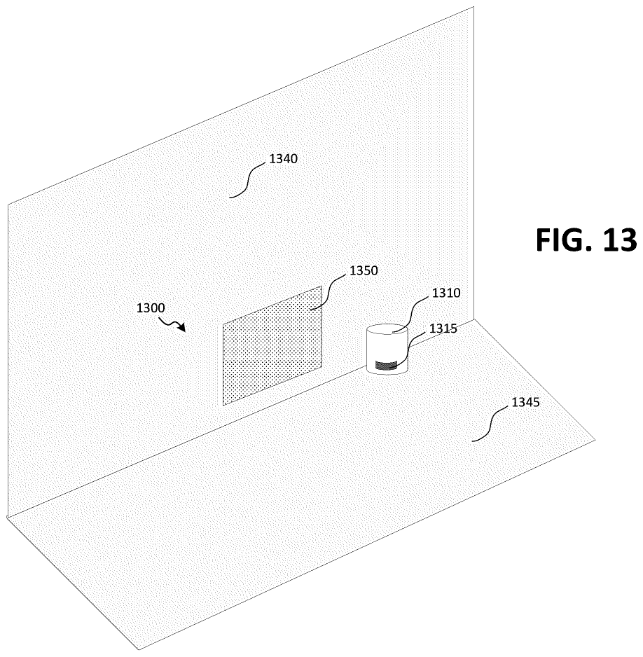

FIG. 13 illustrates another exemplary embodiment of a smart cat scratcher 1300 in accordance with embodiments of the present disclosure. In embodiments, the smart scratcher 1300 may be configured with functionality similar to the functionality of smart cat scratcher 100 as illustrated in FIG. 1. In embodiments, the smart scratcher 1300 may be configured such that the scratching surface 1350 and the reward system 1310 are implemented as separate, independent components rather than integrated into a single housing or unit. This decoupled configuration may provide significant flexibility in terms of system design, installation options, and aesthetic integration within a home environment, while still preserving the full range of interactive training and reward-dispensing functionalities. By separating the core functional elements, the smart scratcher 1300 may be configured not only as a pet training tool but also as a decorative and unobtrusive element of interior design.

In embodiments, the scratching surface 1350 may be implemented as a stand-alone interaction component designed to provide satisfying tactile engagement for feline scratching behavior and to ensure placement where redirection to appropriate scratching behavior is needed most around the home. The scratching surface 1350 may be constructed from a variety of suitable materials, including but not limited to sisal, woven fabric, carpet, cork, natural fibers, or other textured materials that promote natural scratching motions and claw maintenance. The scratching surface 1350 may be mounted to a vertical surface 1340 such as a wall, a door, or furniture, and may include a mounting base or bracket that can be permanently or semi-permanently affixed to the vertical surface 1340. In embodiments, the scratching surface 1350 itself may be removably attached to the base, such as by snapping into place, sliding into a track, attaching magnetically, etc., allowing the scratching surface 1350 to be easily removed. In embodiments, the scratching surface 1350 may be very bendable and flexible, and may be mounted on furniture such as the back of a couch or a barrel accent chair. This modular attachment functionality may enable users to replace worn scratching surfaces without reinstalling the entire device.

In some embodiments, the scratching surface 1350 may be designed with aesthetic considerations in mind, allowing the scratching surface 1350 to blend seamlessly into a room's décor. For example, the scratching surface 1350 may incorporate decorative materials, patterns, printed designs, artwork, and/or imagery, allowing the scratching surface 1350 to function not only as a scratching surface but also as a visually appealing design element. In some embodiments, the scratching surface 1350 may be configured to match wall finishes, wallpaper patterns, and/or interior design themes. This aesthetic customization may enable the smart scratcher 1300 to remain unobtrusive in living spaces while still serving its behavioral function.

In embodiments, the reward system 1310 may be implemented as a separate unit, positioned independently from the scratching surface 1350 but configured to work in conjunction with the scratching surface 1350. In embodiments, the reward system 1310 may include a reward dispenser 1315 configured with functionality similar to the functionality of the reward dispenser 115 of the smart cat scratcher 100 as described herein with respect to FIG. 1. In embodiments, the reward system 1310 may communicate wirelessly or via a wired connection with one or more sensors associated with the scratching surface 1350 or with a centralized scratch controller 110. In embodiments, the scratch controller 110 may be part of the reward system 110 or may be a separate component, such as a separate system and/or a cloud-based system.

In embodiments, the reward system 1310 may be positioned on a floor surface 1345 near the scratching surface, mounted on a wall, and/or integrated into other furniture or household structures. In some embodiments, the reward system 130 may be configured to appear as a decorative object, such as a planter, lamp base, or sculpture, enabling the reward system 1310 to blend into the home environment while still providing automated reward dispensing.

In some embodiments, the decoupled configuration of the smart cat scratcher 1300 may support distributed or multi-zone installations. For example, multiple scratching surfaces 1350 may be placed throughout a living space, all linked to one or more centralized reward systems 1310. This distributed architecture may encourage cats to use specific designated scratching zones while reducing undesirable scratching on furniture or walls. Because the scratching surface can be easily replaced or reconfigured independently of the reward system, maintenance and upgrades may be simpler and more cost-effective.

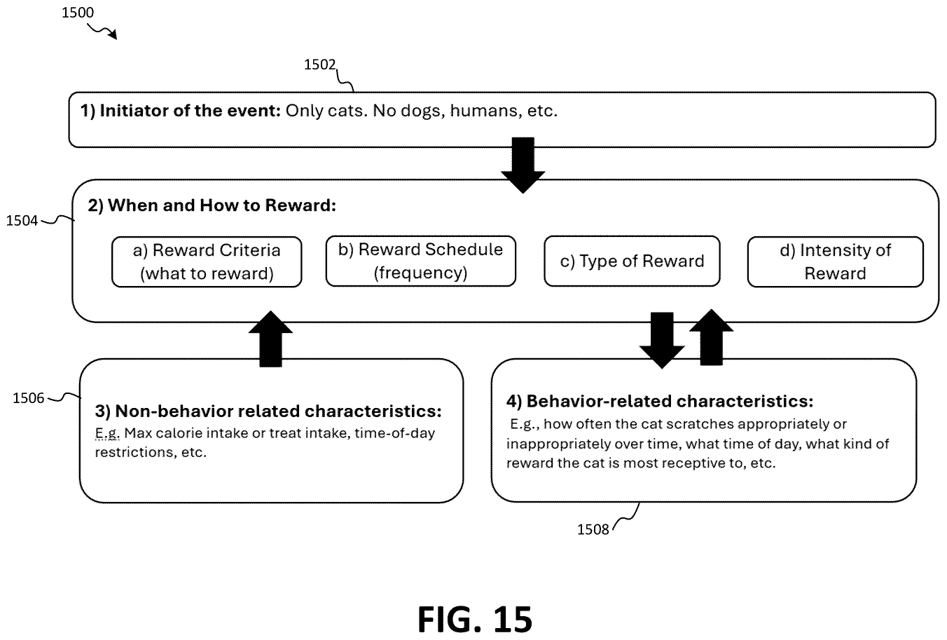

FIG. 15 illustrates a specific example of a reward protocol 1500 implemented by the scratcher controller 110 in accordance with embodiments of the present disclosure. In embodiments, the automated reward protocol 1500 may define a structured and multi-stage logical framework used by the scratcher controller 110 to determine and/or manage whether, when, how, and in what manner a reward is to be dispensed in response to an interaction detected between a cat and the smart cat scratcher. In embodiments, the reward protocol 1500 may be executed automatically by the scratcher controller 110 based on detected interaction data, stored configuration parameters, dynamically updated behavioral characteristics, or any combination thereof.

As illustrated in FIG. 15, the reward protocol 1500 may begin with an initiator determination step 1502. In embodiments, the initiator determination step 1502 may be configured to determine whether a detected event or interaction was initiated by a qualifying animal. In specific embodiments, the qualifying animal may include cats only, excluding non-target animals or entities such as dogs, humans, objects, and/or environmental artifacts. In embodiments, the scratcher controller 110 may be configured to differentiate between cats and non-cats using one or more sensing modalities described herein, including but not limited to image analysis, AI or ML classification, biometric recognition, motion patterns, weight profiles, sound signatures, or combinations thereof. In embodiments, the initiator determination step 1502 may further include distinguishing between different individual cats in a multi-cat environment. In some embodiments, the qualifying animal may include any type of pet, including a dog and/or other types of pets.

Upon determining that the initiator of the detected event is a qualifying animal, the scratcher controller 110 may proceed to a reward determination stage 1504, in which a determination as to when and how to reward is made. In embodiments, the reward determination stage 1504 may include multiple sub-determinations that may collectively define the logical decision space for reward dispensing at step 1504. As shown in FIG. 15, the reward determination stage 1504 may include, without limitation, a reward criteria determination 1504(a), a reward schedule determination 1504(b), a reward type determination 1504(c), and a reward intensity determination 1504(d). In embodiments, these sub-determinations may be evaluated sequentially, concurrently, iteratively, or in any other logical order.

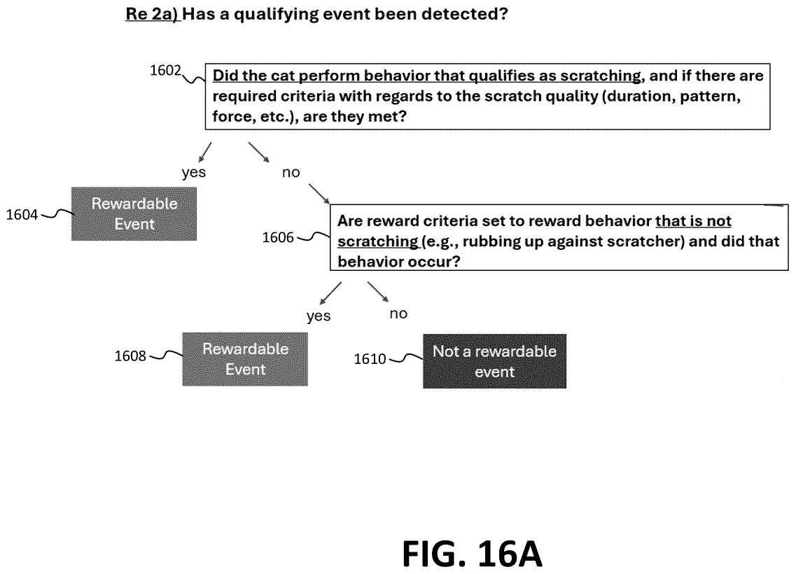

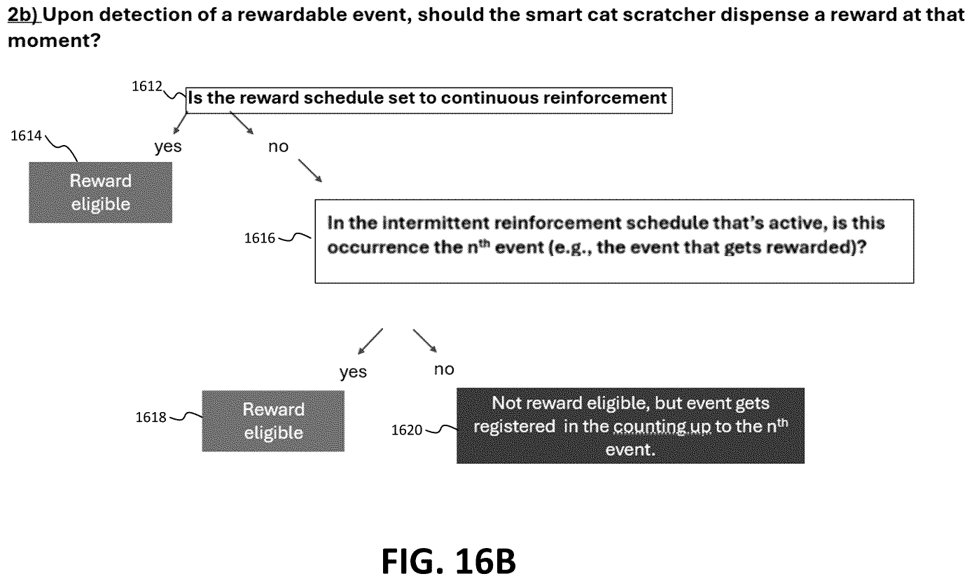

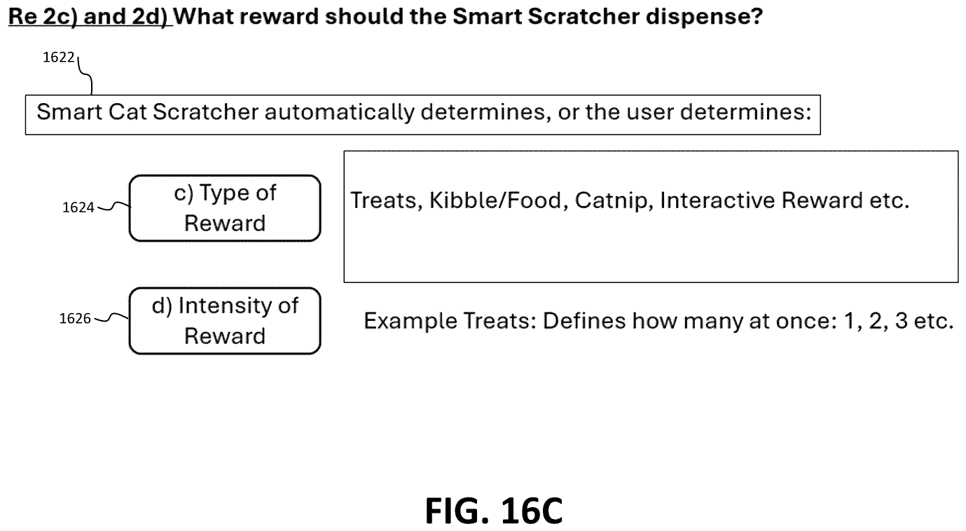

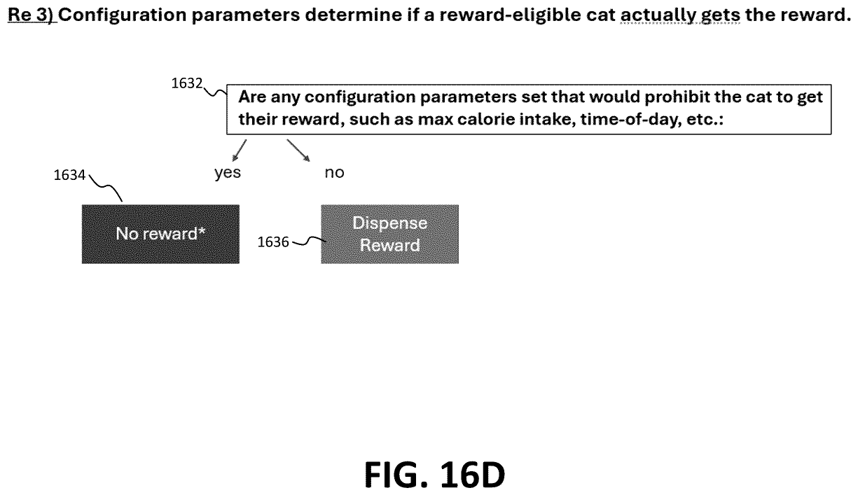

With respect to reward criteria determination 1504(a), the scratcher controller 110 may be configured to determine what type of interaction qualifies as a rewardable interaction. In embodiments, the reward criteria may specify whether the rewardable interaction includes any interaction by the cat, only scratching interactions, only scratching interactions meeting one or more quality thresholds, or other defined behaviors. In embodiments, the reward criteria determination 1504(a) may reference whether the detected interaction constitutes scratching behavior, rubbing behavior, pawing behavior, proximity behavior, and/or other defined interaction classes. In embodiments, the reward criteria determination 1504(a) may be determined by one or more configurable thresholds related to interaction duration, force, pattern, frequency, direction, and/or other measurable characteristics. Further details regarding reward criteria determination 1504(a) are illustrated and described with reference to FIG. 16A.

FIG. 16A illustrates an exemplary process for implementing a reward criteria determination step of a reward protocol 1500 implemented by the scratcher controller 110 in accordance with embodiments of the present disclosure. In embodiments, the reward criteria determination step 1504(a) may be configured to determine whether a detected interaction by a cat qualifies as a rewardable event. In embodiments, this determination may be performed prior to, and independently from, any determination regarding reward frequency, reward type, reward intensity, and/or parameter-based limitations.

As shown in FIG. 16A, the reward criteria determination process may begin at step 1602, where the scratcher controller 110 determines whether the cat has performed a behavior that qualifies as scratching. In embodiments, qualifying scratching behavior may include contact between the cat and the scratching surface that exhibits one or more scratching characteristics, including but not limited to claw engagement, repetitive paw motion, dragging or raking motions, force application consistent with scratching, and/or characteristic scratching patterns detected by one or more sensors. In embodiments, the scratcher controller 110 may determine whether any required criteria associated with scratching quality are satisfied, such as minimum duration, minimum force, minimum number of strokes, minimum frequency, directional motion, a particular pattern of the interaction, and/or other defined scratching characteristics.

In embodiments, the determination at step 1602 may include evaluating sensor data generated by one or more sensing modalities described herein, including but not limited to load cells, accelerometers, vibration sensors, capacitive sensors, optical sensors, acoustic sensors, cameras, or combinations thereof. In embodiments, the scratcher controller 110 may analyze the sensor data to determine whether the detected interaction meets one or more predefined or dynamically adjusted thresholds associated with scratching behavior. In embodiments, these thresholds may be fixed, user-defined, protocol-defined, learned over time, and/or adjusted automatically based on behavioral trends.

If the scratcher controller 110 determines at step 1602 that the cat performed a behavior that qualifies as scratching and that any applicable quality criteria are met, the interaction may be classified as a rewardable event 1604. In embodiments, classification of an interaction as a rewardable event at this stage indicates that the interaction satisfies the “what to reward” requirement of the automated reward protocol, subject to subsequent determinations regarding reward frequency and parameter-based constraints.

If the scratcher controller 110 determines at step 1602 that the detected interaction does not qualify as scratching behavior, or does not satisfy one or more required scratching quality criteria, the process may proceed to step 1606. At step 1606, the scratcher controller 110 may determine whether the reward criteria are configured to reward behaviors that are not scratching behaviors. In embodiments, non-scratching behaviors may include, without limitation, rubbing against the scratching surface, paw placement without scratching, exploratory touching, sniffing, proximity-based engagement, and/or other interaction behaviors that do not rise to the level of scratching.

In embodiments, configuration of the reward criteria to include non-scratching behaviors as rewardable may be the exception rather than the rule. For example, in embodiments, non-scratching behaviors may be classified as rewardable only during an onboarding phase in which the cat is being introduced to the smart cat scratcher, and/or during a re-onboarding phase triggered by detected regression, disuse, or behavioral disruption. In embodiments, such configurations may be time-limited, condition-limited, and/or automatically revoked once the cat demonstrates consistent scratching behavior.

If the scratcher controller 110 determines at step 1606 that the reward criteria are configured to reward non-scratching behavior and that the detected non-scratching behavior occurred, the interaction may be classified as a rewardable event 1608. In embodiments, this classification may enable early-stage reinforcement and/r gradual shaping of behavior toward desired scratching interactions.

If the scratcher controller 110 determines at step 1606 that the reward criteria are not configured to reward non-scratching behavior, or that the detected interaction does not meet the configured non-scratching criteria, the interaction may be classified as a non-rewardable event 1610. In embodiments, classification as a non-rewardable event at this stage may prevent the interaction from advancing to subsequent reward scheduling and reward dispensing steps, while still allowing the interaction to be logged, analyzed, and used to update behavior-related characteristics.

In embodiments, classification of an interaction as non-rewardable does not necessarily indicate that the interaction is ignored by the system. Rather, such interactions may be recorded by the scratcher controller 110 for analytics, behavioral modeling, training progress assessment, protocol adaptation, etc. In embodiments, repeated non-rewardable interactions may influence future adjustments to reward criteria, threshold levels, onboarding status, and/or training phase transitions.

With refence back to FIG. 15, and with respect to reward schedule determination 1504(b), the scratcher controller 110 may be configured to determine how frequently rewards are dispensed relative to detected rewardable interactions. For example, in some embodiments, the reward schedule may be configured as a continuous reinforcement schedule in which every rewardable interaction results in a reward. In some embodiments, the reward schedule may be configured as an intermittent reinforcement schedule in which only some rewardable interactions result in a reward. In embodiments, intermittent reinforcement may include fixed-ratio schedules, variable-ratio schedules, fixed-interval schedules, variable-interval schedules, or combinations thereof. Further details regarding reward schedule determination 1504(b) are illustrated and described with reference to FIG. 16B.

FIG. 16B illustrates an exemplary process for implementing a reward schedule determination step of a reward protocol 1500 implemented by the scratcher controller 110 in accordance with embodiments of the present disclosure. In embodiments, the reward schedule determination step 1504(b) may be performed after an interaction has been classified as a rewardable event in response to the reward criteria determination described with reference to FIG. 16A. In embodiments, the reward schedule determination step 1504(b) may be configured to determine whether a rewardable event should result in dispensing a reward at that moment in time.

As shown in FIG. 16B, the reward schedule determination process may begin at step 1612, where the scratcher controller 110 determines whether the reward schedule is configured as a continuous reinforcement schedule or not. In embodiments, a continuous reinforcement schedule may include a schedule in which every rewardable event results in a reward being dispensed, subject to any applicable parameter-based limitations described elsewhere herein. In embodiments, the continuous reinforcement schedule may be configured for onboarding phases, early training phases, and/or situations in which immediate and consistent reinforcement is desirable.

If the scratcher controller 110 determines at step 1612 that the reward schedule is configured as continuous reinforcement, the rewardable event may be classified as reward-eligible 1614. In embodiments, classification as reward-eligible at this stage may indicate that the interaction has satisfied both the reward criteria determination and the reward schedule determination, and may proceed to subsequent reward type, reward intensity, and/or parameter evaluation steps prior to dispensing the reward.

If the scratcher controller 110 determines at step 1612 that the reward schedule is not configured as continuous reinforcement, the process may proceed to step 1616. At step 1616, the scratcher controller 110 may determine whether the active reward schedule is an intermittent reinforcement schedule and, if so, whether the current rewardable event corresponds to an event that is designated to receive a reward under the intermittent schedule.

In embodiments, an intermittent reinforcement schedule may be defined by n^{th} event rule, where a reward is dispensed only upon occurrence of a specified rewardable event number (e.g., upon occurrence of the n^{th} event). For example, in embodiments, the reward schedule may be configured to dispense a reward predictably after every second, third, fourth, fifth, or other specified number of rewardable events (e.g., the reward may be dispensed after the n^{th} rewardable events), or dispense a reward unpredictably after every second, third, fourth, fifth, or other specified number of rewardable events on average (e.g., the reward may be dispensed after the n^{th} rewardable event on average, although not always exactly after the n^{th} rewardable event). In embodiments, the scratcher controller 110 may maintain an internal count of rewardable events that have occurred since the last reward was dispensed, and may compare the count to the configured target value.

In embodiments, the intermittent reinforcement schedule may be fixed or variable. In a fixed intermittent schedule, the reward may be dispensed upon occurrence of a predetermined event count, such as predictably after every fifth rewardable event. In a variable intermittent schedule, the reward may be dispensed unpredictably according to a probabilistic or randomized distribution, where the n^{th} event may describe an average number rather than a fixed number of events (e.g., the reward is set to dispense after an average of five events, but may occur after two, three, or eight events).

In embodiments, a reward may be dispensed based upon a time interval. For example, in embodiments, a time interval may be configured, and during operation, a reward may be dispensed upon expiration of the time interval, regardless of whether or not a scratch has occurred. The time interval may be any time interval between 3 seconds and 24 hours. In embodiments, the time interval (and in some embodiments the events for rewarding) may be a time interval between rewards (e.g., from treat to treat). For example, similar to event-based rewards (e.g., where a treat is dispensed predictably after a fixed number of scratching events, such as predictably after 5 scratching events, or dispensed unpredictably after a variable number of scratching events, such as unpredictably after a variable number of events around 5 scratching events, which may mean that a treat is dispensed after less or more than 5 events but after 5 events on average), in a time interval-based rewards a treat may be dispensed predictably after a fixed time interval, such as predictably after 5 hours, or dispensed unpredictably after a variable time interval, such as unpredictably after a variable interval around 5 hours, which may mean that a treat is dispensed after less or more than 5 hours but after 5 hours on average. In some embodiments, a reward may be dispensed upon expiration of the time interval, but only in response to detection of a scratch (e.g., after the expiration of the time interval).

In embodiments, a reinforcement schedule may include a combination of event-based reward and time interval-based reward. For example, in embodiments, a reward schedule may be configured to dispense a reward based on an event-based schedule (e.g., after a particular number of events (predictably or unpredictably)) but also may be configured to dispense a reward after a particular time interval has elapsed or expired (predictably or unpredictably, such that a time interval may be a predictable time interval or an unpredictable time interval). The combination can be concurrent, or may be sequential (e.g., the time-interval based schedule may be activated or enabled after the event-based schedule has triggered a reward dispensing, or vice-versa).

If the scratcher controller 110 determines at step 1616 that the current rewardable event corresponds to the event designated to receive a reward under the active intermittent reinforcement schedule (e.g., when the current rewardable event is determined to be the n^{th} event), the event may be classified as reward-eligible 1618. In embodiments, this determination may include resetting or updating the internal n^{th} event counter in preparation for subsequent rewardable events.

If the scratcher controller 110 determines at step 1616 that the current rewardable event does not correspond to the event designated to receive a reward under the active intermittent reinforcement schedule (e.g., when the current rewardable event is not determined to be the n^{th} event), the event may be classified as not reward-eligible 1620. In embodiments, classification as not reward-eligible at this stage may result in no reward being dispensed for the current event. However, in some embodiments, the event may still be registered, logged, and/or counted toward reaching the next reward-eligible event under the intermittent schedule.

In embodiments, rewardable events that are classified as not reward-eligible under the intermittent schedule may be used by the scratcher controller 110 for behavioral analytics, training progress assessment, and/or dynamic adjustment of reward schedules. In embodiments, the scratcher controller 110 may use historical data regarding how often rewardable events occur without reward to fine-tune reinforcement strategies, adjust reward frequency, and/or transition between training phases.

With refence back to FIG. 15, and with respect to reward type determination 1504(c), the scratcher controller 110 may be configured to determine what type of reward is to be dispensed in response to a reward-eligible interaction. In embodiments, the reward type may include food-based rewards such as treats or kibble, scent-based rewards such as catnip or silver vine, interactive rewards, audio or visual feedback, and/or other reward modalities described herein. In embodiments, the reward type determination 1504(c) may be automatically determined by the scratcher controller 110 based on configuration data, behavioral data, or learned preferences, and/or may be manually specified by a user via the companion application.

With respect to reward intensity determination 1504(d), the scratcher controller 110 may be configured to determine an intensity or magnitude of the selected reward. In embodiments, the reward intensity may define, for example, a number of treats dispensed, a duration of an interactive reward, and/or another quantitative or qualitative measure of reward strength. In embodiments, reward intensity may be dynamically adjusted based on training stage, historical engagement data, behavioral responsiveness of the cat, etc. Further details regarding reward type and reward intensity determinations are illustrated and described with reference to FIG. 16C.

FIG. 16C illustrates an exemplary process for implementing steps for determining a type of reward and an intensity of a reward to be dispensed of a reward protocol 1500 implemented by the scratcher controller 110 in accordance with embodiments of the present disclosure. In embodiments, the determinations illustrated in FIG. 16C may be performed after an interaction has been classified as rewardable (e.g., as illustrated in FIG. 16A) and has been determined to be reward-eligible (e.g., as illustrated in FIG. 16B). In embodiments, the determinations of reward type and reward intensity may define what reward is dispensed and in what quantity or magnitude.

As shown in FIG. 16C, the scratcher controller 110 may be configured to determine the reward type and reward intensity either automatically or based on user-defined configuration. In embodiments, the scratcher controller 110 may automatically determine the reward type and or reward intensity based on stored configuration data, historical behavioral data, training phase, observed responsiveness of the cat, or any combination thereof. In embodiments, the scratcher controller 110 may alternatively or additionally receive user-defined selections via a companion application or user interface.

With respect to reward type determination 1624, the scratcher controller 110 may be configured to select one or more reward modalities to be dispensed in response to a reward-eligible interaction. In embodiments, reward types may include, without limitation, edible rewards such as treats, kibble, food portions, and/or dietary supplements. In embodiments, reward types may additionally or alternatively include scent-based rewards such as catnip or silver vine, interactive rewards such as activation of toys, lights, sounds, or other engagement features, and/or communication-based rewards such as initiating audio or visual interaction with a user.

In embodiments, the reward type may be selected based on the cat's demonstrated preferences, training stage, behavioral trends, etc. For example, in embodiments, a higher-value food-based reward may be selected during onboarding or early training phases, while lower-value or non-food rewards may be selected during maintenance phases. In embodiments, the scratcher controller 110 may dynamically rotate or vary reward types to prevent habituation and maintain engagement, or even to align with health-related constraints.

With respect to reward intensity determination 1626, the scratcher controller 110 may be configured to determine an intensity, magnitude, and/or quantity associated with the selected reward type. In embodiments, reward intensity may define how many treats are dispensed at once, the size of a food portion, the duration of an interactive reward, and/or another quantitative parameter associated with reward delivery. For example, in embodiments involving treat-based rewards, the reward intensity may specify dispensing one treat, two treats, three treats, or another defined number of treats in a single reward event.

In embodiments, reward intensity may be statically defined by user configuration or may be dynamically adjusted by the scratcher controller 110. Dynamic adjustment of reward intensity may be based on one or more factors including training phase, recent interaction frequency, consistency of scratching behavior, responsiveness to prior rewards, and/or observed diminishing returns. In embodiments, reward intensity may be increased temporarily to reinforce desired behavior or reduced gradually to fade dependency on high-value rewards.

In embodiments, the determinations of reward type and reward intensity may be interdependent. For example, in embodiments, selection of a particular reward type may constrain or define allowable reward intensities, and vice versa. In embodiments, the scratcher controller 110 may enforce compatibility rules to ensure that selected reward types and intensities are physically achievable by the reward dispenser and consistent with system capabilities.

In some embodiments, although the reward type and reward intensity determinations define what reward is intended to be dispensed, the actual dispensing of the reward may be subject to evaluation of configuration parameters and limits, such as non-behavior-related characteristics described with reference to FIG. 16D. Accordingly, a reward-eligible event with a defined reward type and intensity may ultimately result in dispensing, modification, substitution, and/or withholding of the reward based on parameter-based constraints.

With refence back to FIG. 15, the reward determination stage 1504 may be influenced by non-behavior-related characteristics 1506 and behavior-related characteristics 1508. In embodiments, non-behavior-related characteristics 1506 may include parameters that are specified independently of detected interaction behavior and that may constrain or override reward dispensing decisions. In embodiments, such non-behavior-related characteristics 1506 may include, without limitation, maximum calorie intake limits, maximum treat counts within a defined time period, time-of-day restrictions, quiet hours, veterinary or dietary constraints, safety-related restrictions, and/or other user-defined or system-defined limitations. In embodiments, these parameters may be predefined and may not be modified automatically by the reward protocol during operation.

In embodiments, behavior-related characteristics 1508 may include parameters that are derived from, updated by, and/or otherwise responsive to detected interaction behavior over time. In embodiments, behavior-related characteristics 1508 may include how frequently the cat scratches appropriately or inappropriately, trends in scratching intensity or duration, time-of-day interaction patterns, responsiveness to different reward types, and/or progression through training stages. Behavior-related characteristics 1508 may be initially defined but may alternatively or additionally be dynamically updated by the scratcher controller 110 based on accumulated behavioral data, analytics, AI or ML inference, and/or other mechanisms. In embodiments, these characteristics may form a feedback loop that influences future reward criteria, reward schedules, reward types, and/or reward intensities.

In embodiments, the scratcher controller 110 may be configured to evaluate the outputs of the reward determination stage 1504 in view of the non-behavior-related characteristics 1506 and behavior-related characteristics 1508 to arrive at a final reward dispensing decision. In embodiments, even when an interaction is classified as rewardable and reward-eligible, the actual dispensing of a reward may be inhibited, delayed, modified, or substituted based on one or more applicable parameters.

FIG. 16D illustrates examples of non-behavior related characteristics to be used in a reward protocol implemented by the scratcher controller 110 in accordance with embodiments of the present disclosure. In embodiments, the configuration parameter evaluation illustrated in FIG. 16D may be performed after an interaction has been classified as rewardable (e.g., as illustrated in FIG. 16A), determined to be reward-eligible (e.g., as illustrated in FIG. 16B), and assigned a reward type and reward intensity (e.g., as illustrated in FIG. 16C).

As shown in FIG. 16D, the configuration parameter evaluation process may begin at step 1632, where the scratcher controller 110 determines whether any configuration parameters are set that would prohibit dispensing the reward for the current reward-eligible event. In embodiments, such configuration parameters may include non-behavior-related characteristics as described with reference to FIG. 15, including but not limited to maximum calorie intake limits, maximum treat counts within a defined time period, time-of-day restrictions, quiet hours, veterinary or dietary constraints, safety-related restrictions, and/or other user-defined or system-defined limitations.

In embodiments, the configuration parameters evaluated at step 1632 may be static, semi-static, or dynamically updated. For example, in embodiments, a maximum daily treat limit may be predefined by the user and reset on a daily basis, while time-of-day restrictions may be evaluated continuously based on a system clock. In embodiments, configuration parameters may be stored locally by the scratcher controller 110 and/or remotely in a connected application or cloud service.

If the scratcher controller 110 determines at step 1632 that one or more configuration parameters prohibit dispensing the reward, the process may proceed to step 1634, where the reward is not dispensed. In embodiments, this determination may occur even though the interaction was classified as rewardable and reward-eligible under the reward criteria and reward schedule determinations.

If the scratcher controller 110 determines at step 1632 that no configuration parameters prohibit dispensing the reward, the process may proceed to step 1636, where the reward is dispensed in accordance with the previously determined reward type and reward intensity. In embodiments, the scratcher controller 110 may transmit a control signal to the reward dispenser to physically dispense the reward, activate an interactive reward, and/or otherwise deliver the selected reward modality.

In embodiments, the scratcher controller 110 may further be configured to proactively adapt the automated reward protocol in response to configuration constraints. For example, in embodiments, when a daily treat limit is reached, the scratcher controller 110 may automatically transition to a protocol configuration that favors non-food rewards, interactive rewards, or reduced reward intensity, rather than continuing to classify events as reward-eligible without dispensing rewards.

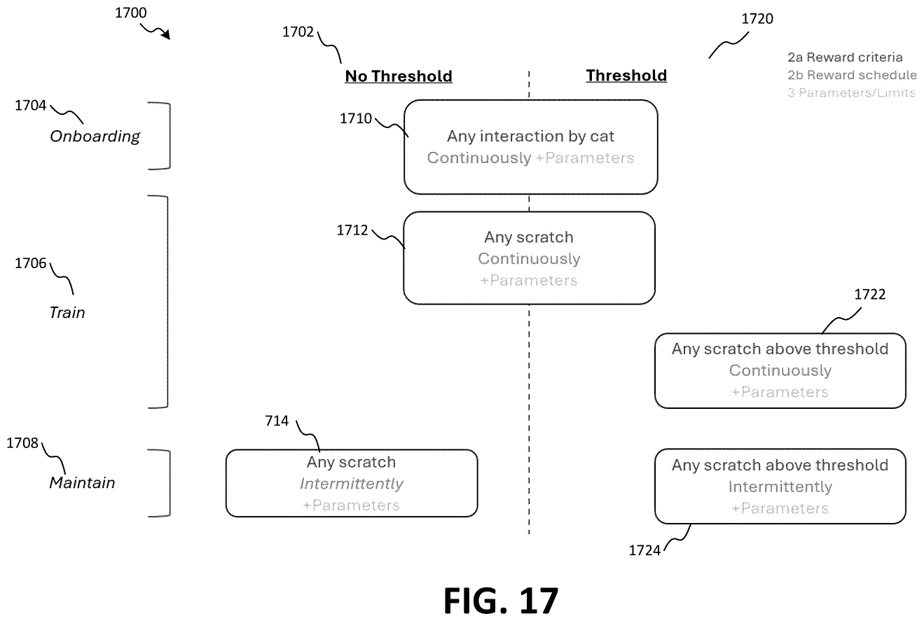

FIG. 17 illustrates a specific example implementation of a reward protocol 1700 implemented by the scratcher controller 110 in accordance with embodiments of the present disclosure. In embodiments, the automated reward protocol 1700 illustrated in FIG. 17 illustrates how a reward protocol may be applied differently across multiple phases of training and maintenance, and how the presence or absence of a reward threshold influences reward behavior within each phase.

In embodiments, the automated reward protocol 1700 may define one or more training phases including, without limitation, an onboarding phase 1704, a training phase 1706, and a maintenance phase 1708. Each phase may correspond to a different configuration or combination of reward criteria, reward schedule, and parameter application as described herein. In embodiments, transitions between phases may be manual or automatic.

During the onboarding phase 1704, the automated reward protocol 1700 may be configured to encourage initial engagement with the smart cat scratcher by minimizing behavioral requirements. In embodiments, during onboarding, the reward criteria determination (e.g., step 1504(a) as illustrated in FIG. 15) may be configured such that any interaction initiated by the cat qualifies as a rewardable interaction, regardless of interaction quality or whether the interaction constitutes scratching. In embodiments, the reward schedule determination (e.g., step 1504(b) as illustrated in FIG. 15) during onboarding may be configured as continuous reinforcement, such that every rewardable interaction results in a reward, subject to applicable configuration parameters.

In embodiments, onboarding behavior may be implemented with or without a defined reward threshold. In embodiments where no threshold is specified (e.g., at 1702), all interactions by the cat may be rewarded continuously. In embodiments where a threshold is specified (e.g., at 1720), the threshold may be set at a minimal level such that most interactions still qualify as rewardable. In embodiments, the onboarding phase may remain subject to behavior and non-behavior-related parameters and limits, which may override continuous reward dispensing when applicable.

During the training phase 1706, the automated reward protocol 1700 may be configured to reinforce specific desired behaviors, such as scratching behavior directed to the scratching surface or scratches with particular characteristics. In embodiments, during the training phase, the reward criteria determination may be configured such that only interactions classified as scratching qualify as rewardable interactions. In embodiments, non-scratching interactions may no longer qualify as rewardable except under exceptional circumstances such as re-onboarding due to regression.

In embodiments, during the training phase 1706, the reward schedule determination may remain configured as continuous reinforcement. Accordingly, every scratching interaction by the cat may be rewarded, regardless of scratching quality, provided that the interaction qualifies as rewardable scratching and that no configuration parameters prohibit dispensing.

In embodiments, the training phase 1706 may be implemented with or without a reward threshold. In embodiments where no threshold is specified, all scratching interactions may be treated equally. In embodiments where a threshold is specified, only scratching interactions that are above the reward threshold may be rewardable (e.g., subject to configuration parameters).

During the maintenance phase 1708, the automated reward protocol 1700 may be configured to sustain established scratching behavior while reducing reward dependency. In embodiments, during maintenance, the reward criteria determination may continue to require scratching behavior, but the reward schedule determination may be configured as intermittent reinforcement rather than continuous reinforcement. In embodiments, scratching interactions may still be logged and analyzed even when no reward is dispensed.

In embodiments, during the maintenance phase 1708 and where no reward threshold is specified, any scratching interaction may qualify as rewardable, but rewards may be dispensed intermittently according to a fixed or variable schedule, subject to configuration parameters. In embodiments where a reward threshold is specified, the automated reward protocol 1700 may refine reward behavior based on scratching quality. In these embodiments, only scratching interactions that meet or exceed the defined threshold may qualify as rewardable interactions.

In embodiments, all phases illustrated in FIG. 17 may remain subject to non-behavior-related configuration parameters and behavior-related characteristics as described with reference to FIG. 15. Accordingly, even where an interaction qualifies as rewardable and reward-eligible within a given phase, the dispensing of a reward may still be modified, deferred, or withheld based on applicable limits as specified in the configuration parameters.

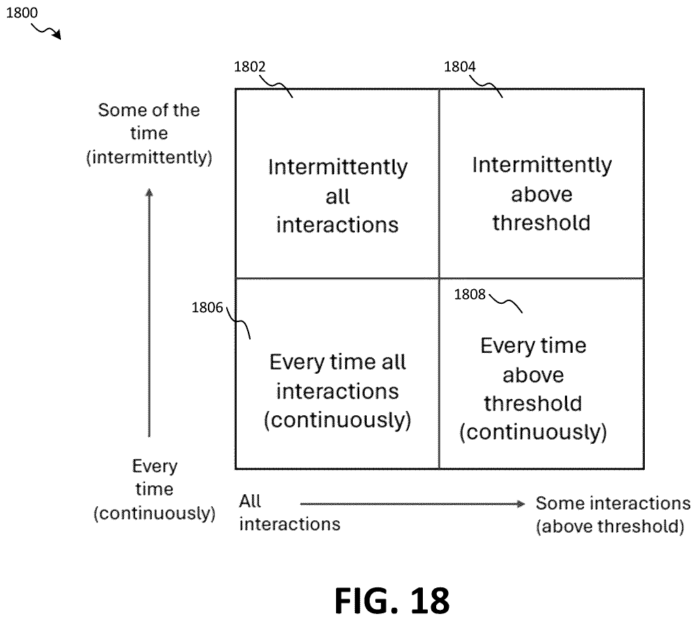

FIG. 18 shows an example of a graph 1800 illustrating the implementation of a reward protocol implemented by the scratcher controller 110 in accordance with embodiments of the present disclosure. The graph 1800 conceptually illustrates how reward dispensing behavior varies as a function of reward schedule configuration and reward criteria configuration, including whether a reward threshold is applied.

As shown in FIG. 18, the graph 1800 may define a plurality of operational regions corresponding to different combinations of reward schedule and reward criteria. In embodiments, one axis of the graph 1800 may represent reward schedule configuration, such as whether rewards are dispensed continuously (e.g., every rewardable event) or intermittently (e.g., only some rewardable events). In embodiments, another axis of the graph 1800 may represent reward criteria configuration, such as whether all interactions qualify as rewardable or only interactions that meet or exceed a defined reward threshold qualify as rewardable. As shown, each region within the graph 1800 may correspond to a unique combination of reward criteria, reward schedule, and threshold application, all subject to parameter constraints.

A first region of the graph 1800 may correspond to configurations in which rewards are dispensed intermittently and all interactions qualify as rewardable interactions. In embodiments, any interaction by the cat, regardless of quality or intensity, may qualify as rewardable, but rewards may be dispensed only some of the time based on an intermittent reward schedule. This configuration may be configured for maintenance phases in which continued engagement is desired without rewarding every interaction.

A second region of the graph 1800 may correspond to configurations in which rewards are dispensed intermittently and only interactions that meet or exceed a defined reward threshold qualify as rewardable interactions. In these embodiments, scratching interactions that do not meet the defined threshold may not qualify for reward at all, while threshold-qualifying interactions may be rewarded intermittently. This configuration may be configured for maintenance phases to reinforce higher-quality scratching behavior while further reducing reward frequency.

A third region of the graph 1800 may correspond to configurations in which rewards are dispensed continuously and all interactions qualify as rewardable interactions. In embodiments, every interaction initiated by the cat may result in a reward, subject to applicable configuration parameters. This configuration may be configured for onboarding phases or early training phases in which the goal is to establish a strong association between interaction and reward.

A fourth region of the graph 1800 may correspond to configurations in which rewards are dispensed continuously and only interactions that meet or exceed a defined reward threshold qualify as rewardable interactions. In embodiments, every threshold-qualifying interaction may result in a reward, while non-qualifying interactions may not. This configuration may be configured for early training phases to reinforce specific desired behaviors that meet defined quality criteria.

It is noted that, each region may remain subject to non-behavior-related configuration parameters and behavior-related characteristics as described with reference to FIG. 15. Accordingly, even where an interaction qualifies as rewardable and reward-eligible within a given region, the dispensing of a reward may still be modified, deferred, or withheld based on applicable limits as specified in the configuration parameters.

In embodiments, as illustrated in FIG. 18, the automated reward protocol of embodiments may support a continuum of configurations that may be selected or transitioned between over time. In embodiments, the scratcher controller 110 may move between different regions of the graph 1800 dynamically based on training phase, observed behavioral trends, user configuration, and/or system-defined adaptation logic. For example, transitions between different regions of the state space illustrated in FIG. 18 may occur automatically or manually to support onboarding, training, maintenance, re-training, or special behavioral scenarios.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A smart cat scratcher system, comprising:
a scratching surface;
one or more sensors configured to detect an interaction by a cat with the scratching surface and to generate data indicative of one or more characteristics of the interaction;
a reward dispenser configured to dispense one or more rewards;
a controller communicatively coupled to the one or more sensors and the reward dispenser, the controller configured to:
determine, based on the one or more characteristics of the interaction, whether the interaction meets a reward condition; and
automatically transmit, in response to determining that the interaction meets the reward condition, a control signal to the reward dispenser to cause dispensing of the one or more rewards.

2. The smart cat scratcher system of claim 1, wherein the one or more sensors include one or more of:
an accelerometer;
a capacitive touch sensor;
a load cell;
a vibration sensor;
an optical sensor;
an acoustic sensor; and
a camera configured to capture image data for interaction analysis.

3. The smart cat scratcher system of claim 1, wherein the controller is further configured to determine the one or more characteristics of the interaction, wherein the one or more characteristics include one or more of:
an intensity of the interaction;
a duration of the interaction;
a velocity or acceleration profile of the interaction;
a frequency or pattern of interaction;
a spatial distribution of force;
a motion profile of the interaction;
a sound associated with the interaction;
a vibration associated with the interaction;
a location of the interaction within the scratching surface;
a mood of the cat associated with the interaction; and
a directional vector of the interaction.

4. The smart cat scratcher system of claim 1, wherein the controller is further configured to classify the interaction as rewardable or non-rewardable based on the one or more characteristic of the interaction.

5. The smart cat scratcher system of claim 4, wherein an interaction is classified as rewardable when the one or more characteristics meet or exceed a rewardable threshold comprising one or more of a minimum intensity, a minimum duration, a predefined frequency, a predefined pattern, and a defined location on the scratching surface.

6. The smart cat scratcher system of claim 1, wherein the controller is further configured to implement an automated reward protocol comprising a plurality of configuration levels including one or more of:
a first configuration level configured to reward every interaction between the cat and the scratching surface;
a second configuration level configured to intermittently reward every interaction between the cat and the scratching surface; and
a third configuration level configured to intermittently reward every interaction between the cat and the scratching surface that exceeds a defined rewardable threshold.

7. The smart cat scratcher system of claim 6, wherein the automated reward protocol further comprises a fourth configuration level configured to intermittently reward every interaction between the cat and the scratching surface that exceeds a defined rewardable threshold based on one or more configuration parameters, wherein the reward behavior is adjusted based on the one or more configuration parameters.

8. The smart cat scratcher system of claim 6, wherein the controller is further configured to transition the cat between the plurality of configuration levels based on changes in detected interaction characteristics over time.

9. The smart cat scratcher system of claim 6, wherein the automated reward protocol is implemented concurrently for multiple cats, and wherein each cat of the multiple cats is assigned a configuration level independently of a configuration level of other cats of the multiple cats.

10. The smart cat scratcher system of claim 1, wherein the scratching surface is configured to be removable or replaceable to allow customization of one or more of texture, material, and orientation.

11. The smart cat scratcher system of claim 1, wherein the smart cat scratcher is modular and is configured to operate as part of a networked system comprising a plurality of smart cat scratchers communicatively coupled to one another to share interaction data and coordinate reward dispensing.

12. The smart cat scratcher system of claim 11, wherein the networked system is configured to synchronize reward schedules across the plurality of smart cat scratchers based on interaction data from any one of the devices.

13. The smart cat scratcher system of claim 1, further comprising:
a communications module configured to transmit interaction data to a user terminal executing a companion application, wherein the companion application is configured to one or more of:
display behavioral analytics, set reward criteria, receive notifications, display rewards dispensed, and set the reward protocol including one or more of reward criteria, reward schedules, type of reward, and intensity of the reward;
allow a user to review configuration of an automated reward protocol and manually set a reward protocol with parameters including one or more of: reward criteria, reward schedule, type of reward, and intensity of reward, for all cats, some cats, or individual cats;
display behavioral analysis and data, and rewards dispensed, for all cats, some cats, or individual cats;
allows additional user configurations to be configured, including maximum treats per day; and
includes a profile for each individual cat.

14. The smart cat scratcher system of claim 1, further comprising one or more volume detection sensors configured to detect a fill level of a reward storage compartment and to transmit a refill notification when the fill level falls below a threshold.

15. The smart cat scratcher system of claim 14, wherein the one or more volume detection sensors comprise at least one of an optical sensor, a capacitive sensor, a load cell, or an ultrasonic level detector

16. A method of automated positive reinforcement of a cat, comprising:
detecting, via one or more sensors of a smart cat scratcher, a scratching interaction by the cat;
determining one or more characteristics of the scratching interaction;
classifying the scratching interaction as rewardable or non-rewardable based on the one or more characteristics;
determining a current configuration level of an automated reward protocol; and
dispensing, via a reward dispenser, a reward in response to the scratching interaction when the scratching interaction satisfies a reward condition defined by the current configuration level of the automated reward protocol.

17. The method of claim 16, wherein the automated reward protocol includes a plurality of configuration levels including:
rewarding every scratching interaction;
intermittently rewarding every scratching interaction; and
intermittently rewarding every scratching interaction that exceeds a defined rewardable threshold.

18. The method of claim 16, further comprising:
dynamically adjusting the current configuration level of the automated reward protocol based on one or more behavioral trends including frequency of scratching interactions, changes in intensity, or time-of-day patterns.

19. The method of claim 16, further comprising:
dynamically adjusting the current configuration level of the automated reward protocol based on a maximum number of rewards dispensed or calories allowed within a defined time period.

20. The method of claim 16, further comprising:
transmitting interaction data to a companion application and presenting analytics related to scratching frequency, intensity, and behavioral changes over time.
